(19) United States
(12) Patent Application Publication
(10) Pub. No.: US 2023/0401449 A1
(43) Pub. Date: Dec. 14, 2023

(54) MEANS AND METHODS FOR CLASSIFYING MICROBES

(71) Applicant: UNIVERSITÉ DE LAUSANNE, Lausanne (CH)

(72) Inventor: Birge ÖZEL DUYGAN, Lausanne (CH)

(21) Appl. No.: 18/010,197

(22) PCT Filed: Jun. 24, 2021
(86) PCT No.: PCT/EP2021/067438

§ 371 Date: Dec. 13, 2022

(30) Foreign Application Priority Data
Jun. 24, 2020 (EP) 20181896.0

(51) Int. Cl. G06N 3/09; G01N 15/14

(52) U.S. Cl. CPC G06N 3/09; G01N 15/1429; G01N 15/1434; G01N 2015/1006

(57) ABSTRACT

The invention relates to the field of machine learning and comprises supervised learning. In particular, the invention relates to a computer-implemented method for generating a classifier for at least one target microbe by employing supervised machine learning, e.g., an artificial neural network, a classifier that is obtainable by said method, and applications of the inventive classifier. Thus, the invention further relates to a method for quantifying the abundance of at least one target microbe in a sample, and a method for analyzing the microbial composition in a sample. Further provided herein are diagnostic uses of the classifier, i.e. a method for diagnosing a microbial disease in a subject. In addition, the invention relates to a set of standards comprised in the classifier, a computer-readable storage medium, and/or a kit.

### RELATED APPLICATIONS

This application is a 35 U.S.C. § 371 filing of International Patent Application No. PCT/EP2021/067438, filed Jun. 24, 2021, which claims priority to European Patent Application No. 20181896.0, filed Jun. 24, 2020, the entire disclosures of which are hereby incorporated herein by reference.

The invention relates to the field of machine learning and comprises supervised learning. In particular, the invention relates to a computer-implemented method for generating a classifier for at least one target microbe by employing supervised machine learning, e.g., an artificial neural network, a classifier that is obtainable by said method, and applications of the inventive classifier. Thus, the invention further relates to a method for quantifying the abundance of at least one target microbe in a sample, and a method for analyzing the microbial composition in a sample. Further provided herein are diagnostic uses of the classifier, i.e. a method for diagnosing a microbial disease in a subject. In addition, the invention relates to a set of standards comprised in the classifier, a computer-readable storage medium, and/or a kit.

It is now widely recognized that microbiota colonize basically all environments on our planet and form integral parts of higher eukaryotic life forms. Most microbiota have highly diverse species compositions, which are not only very specific (unique) for local environmental niches or different body parts, but even distinguishable among individuals. Microbiota further are dynamic ecosystems, displaying natural succession and evolution, and in- and outflow of new species. The species composition of microbiota fluctuates in response to external influences such as food, but also pollution, xenobiotics, pharmaceuticals or antibiotics. The high species diversity complicates both the analysis of microbiota composition as well as of its (functional) importance for the ecosystem or niche where it is found. Hence, the analysis of the microbiota compositions is crucial for the proper assessment of microbiota functioning or restoration. Current methods are largely ‘omics’-based and emphasize taxonomic (Zuniga (2017) Microb Biotechnol 10; Langille (2013) Nat Biotechnol 31) or functional gene diversity (Ellegaard (2019), Nat Commun 10). However, omics-approaches are cumbersome and relatively slow and laborious, which is a disadvantage, especially in fields requiring rapid expert decisions, such as for clinical interventions. In addition, those methods frequently or inherently underestimate absolute population densities (Contijoch (2019), Elife 8; Rivett (2018), Nat Microbiol 3) within the microbiota (Vandeputte (2017), Nature 551). Growth of individual species within microbiota may be further inferred from cell mass measurements (Cermak (2016), Nat Biotechnol 34) or indirectly, from binned metagenomic sequence read coverage differences (Gao (2018), Nat Methods 15), but these approaches are neither simple nor rapid. There is thus a clear need for high-throughput single cell approaches to complement and expand current omics-dominated microbiota analyses.

Flow cytometry (FCM) is an established high-throughput method which is simple and sensitive. Moreover, FCM provides absolute counts of suspended cells, and enables real-time sample analysis and interpretation (Van Nevel (2017), Water Res 113). Cells are detected in FCM on the basis of optical properties (light scatter from cell shape and structures) (Rajwa (2008), Cytometry A 73), and can further be stained with a plethora of fluorescent dyes that target specific biomolecules (e.g., nucleic acids) (Gasol (1999), Appl Environ Microbiol 65) or indicate physiological activity (e.g., membrane permeability) (Czechowska (2011), Environ Sci Technol 45; Czechowska (2008), Curr Opin Microbiol 11; Muller (2010), FEMS Microbiol Rev 34). However, despite the ease with which a wide variety of FCM parameters can be recorded on large numbers of individual cells, there is no straightforward relation between the multidimensional FCM data and the identity of bacterial strains or cell properties, particularly within diverse microbiota.

Some success has been achieved in inferring microbiota compositional changes from FCM data using unsupervised clustering or cytometric fingerprinting (Koch (2014), Curr Opin Biotechnol 27; Dhoble (2018), J Biol Eng 12, 19), but without species recognition (Bombach (2011), Adv Biochem Eng Biotechnol 124, 151-181; Koch (2013), Nat Protoc 8). Species recognition from FCM data has proved possible so far only for freshwater and marine eukaryotic unicellular eukaryotes, likely because of their large size (Boddy (2000), Marine Ecology Progress Series 195). Recent multiparametric statistical studies further suggest that, in principle, bacterial strains can be differentiated from FCM data (Buysschaert (2018), Cytometry A 93). However, it is unclear whether flow cytometry data can be used for classifying bacteria in a microbiota sample. Machine learning has been used to extract a classification from complex data, but has so far not been applied to bacteria, except for synthetic mixtures of bacterial species (Rubbens (2017), PLoS One 12, e0169754), or as a support for diversity analysis by high-throughput amplicon sequencing (Props (2017), ISME J 11).

In the pioneering in silico study by Rubbens (Rubbens (2017), PloS One 12), any two strains randomly picked from all the data sets can be relatively well discriminated (80% accuracy) by using linear discriminatory analysis (or LDA) and random forest decision trees (RF) algorithms. However, the accuracy decreased to around an average of 40-50% when all strain data sets (n=20) were trained simultaneously, with RF giving overall better success than LDA. However, the cell-type picture obtained from a community was still ‘blurred’, which means that the different microbial strains could not be classified with a high accuracy.

Thus, there is still a need for improved means and methods for obtaining information about the microbial composition of a sample, in particular for identifying a target microbe in a sample, in particular a prokaryote.

Means and methods to address the technical problem above are provided in the claims and outlined herein below.

Accordingly, the invention relates to a computer-implemented method for generating a classifier for at least one target microbe, wherein said target microbe is a microbial species or strain or a subpopulation thereof, and wherein said method comprises the steps of
(a) obtaining a training data set, wherein said training data set comprises data of a plurality of objects, wherein said plurality of objects comprises cells of said at least one target microbe, and wherein said data comprises for each of said objects
   (i) a label which identifies the type of the object, and
   (ii) an input vector which comprises a plurality of cytometric parameters of said object,
(b) analyzing said training data set with a supervised machine learning algorithm, e.g., including an artificial neural network, and
(c) obtaining said classifier as output from said supervised machine learning algorithm, e.g., said artificial neural network.

The invention is, at least partly, based on the finding that a computer-implemented method comprising a supervised machine learning algorithm, e.g. an artificial neural network (ANN) or a random forest, for analyzing flow cytometry data as provided herein and as exemplified in the appended Examples (termed “CellCognize”), could be developed which provides a classifier that allows distinguishing specific (target) bacteria within a microbial community. In particular, the obtained exemplary classifiers showed a great performance in in silico experiments and recognized target microbes, inter alia, bacteria, amongst in total 15-16 microbe species or strains with a sensitivity (true positive rate) and precision of up to 97% or even more than 99% (exemplary 32-class ANN classifier or exemplary 29-class ANN or random forest classifiers for, e.g., Clostridioides difficile), or an overall accuracy of about 80% (exemplary 5-class ANN classifier or 32-class ANN classifiers) or even about 90% (exemplary 29-class ANN classifier; Table 6). Strikingly, the classifiers of the invention also accurately classified and differentiated closely related microbial species and different physiological states of the same microbial strain, e.g. different growth phases.

Moreover, the methods of the present invention are able to handle high-dimensional data of millions of objects and microbial cells which is an advantage over other computational methods such as Linear Discriminant Analysis (Abdelaal (2019), Cytometry A 95), earlier Random Forests (Rubbens (2017), PloS One 12) or Support Vector Machines (Rajwa (2008), Cytometry A 73).

Moreover, in the context of the present invention, the inventors preprocessed the multiparametric flow cytometric signatures and then deployed supervised machine learning algorithms such as artificial neural networks (ANN) to train class discrimination and for producing the classifiers, the formula that is finally used to predict class distributions and probabilities of unknown data. The inventors showed an overall accuracy of 80-90% for a combined set of 32 or 29 classes, which is better than the previous RF-/LDA-based study in Rubbens (2017), PloS One 12. In particular, the methods and classifiers of the present invention outperform the prior art approaches such as described in Rubbens (2017), because target bacteria are accurately detected and quantified in samples or data sets comprising more than two microbial species or strains, e.g. in complex microbial communities and microbiota. In other words, the classifiers of the present invention showed a repeatedly, reproducibly good performance in identifying target bacteria within complex microbial communities. For example, as demonstrated in Example 11 and FIG. 14, an exemplary 29-class ANN-classifier correctly identified Clostridioides difficile in exponential or stationary growth phases within a microbial background of a stool sample. Remarkably, the addition of the C. difficile data to the stool sample data set only increased the proportion of cells attributed to the two C. difficile classes which indicates that the C. difficile subpopulations were correctly detected and classified within a complex stool microbiome background. Thus, the methods and classifiers of the present invention are particularly suitable for quantifying the abundance of one or more target bacteria in environmental, animal or human samples such as, inter alia, stool samples, vaginal smears or water body samples, and are therefore very useful, e.g., for diagnosing diseases that are associated and/or caused by microbes, or detecting microbial contamination at natural sites. Importantly, in the context of the present invention, the inventors further demonstrated that the physiological state of target strains can be classified correctly, even within unknown communities. The inventors could also show cell type enrichments in unknown communities under stress. The classifiers of the invention showed a good performance in identifying cell groups within complex microbial communities, i.e., similar microbiota community structure is reflected in both FCM and 16S amplicon sequencing data. Even though the pure culture standards used to train and produce the classifiers were not known to be present in the unknown community sample, an exemplary classifier of the invention still enabled prediction of the probability of each cell in the mixture to belong to a predefined class.

The inventors further improved the overall accuracy of a classifier of the present invention up to about 90% using either an artificial neural network (ANN) or random forest (RF) by including further cell markers (i.e. in addition to a DNA stain, a stain for the cell membrane and a stain for cell wall polysaccharide). In particular, the corresponding additional cytometric parameters further improved the classification.

In addition, the high sensitivity of various classifiers was verified by biological experiments. In particular, experimentally regrown bacteria in a pure culture of one species were recognized with a sensitivity of 76 to 88% (exemplary 5-class ANN classifier). Strikingly, the obtained exemplary 32-class ANN classifiers comprising 15 microbial species differentiated two Escherichia coli strains grown to different growth phases (stationary or exponential) on two different media (represented by four standards among the 32 classes) with a sensitivity of 70-90% for the in silico mixed dataset, or of 58-78% for the experimental datasets, determined based on pure cultures of those standards (Escherichia coli strains and their subpopulations).

Moreover, as illustrated in the appended Examples, the performance of the ANN classifiers was also high for recognizing experimentally added target bacteria within diverse backgrounds of microbial communities, e.g aforementioned four E. coli standards within a background of natural lake water microbial community, or Clostridium Scindens within a background community of soil microbes. It is thus another striking finding that the classifiers, e.g. the ANN classifiers, allow recognizing and quantifying specific target microbes and their physiological signatures/states within complex microbiota mixtures while the presence of cells from unknown species does not hamper their recognition. It further appears that, in particular, the pre-processing of the cytometry data, i.e. the anchoring of the data sets, as described herein, in particular in combination with the supervised machine learning algorithm, e.g. the artificial neural network or the random forest algorithm, described herein, and as illustrated in the appended Examples, contributes much to generating well-performing classifiers according to the present invention and classifying target microbes with a high sensitivity and precision as provided herein, and thus appears to be highly beneficial. In particular, the anchoring allows to fix the multidimensional position of the data series for the subsequent machine-learning algorithm.

Moreover, the methods of the present invention have the advantage of being simple, user-friendly and fast, and incurring only low reagent costs.

Moreover, the inventive methods for generating a classifier provided herein, and the inventive classifiers obtainable by said methods can be used for classifying microbes in a sample, i.e. quantifying the abundance of at least one target microbe in a sample.

Hence, the invention further relates to a computer-implemented method for quantifying the abundance of at least one target microbe in a sample, wherein said target microbe is a microbial species or strain or a subpopulation thereof, and wherein said method comprises the steps of
(a) obtaining a classifier according to the invention and as provided herein,
(b) obtaining data of a plurality of objects from said sample, wherein said data comprises for each of said objects a vector comprising a plurality of cytometric parameters, and
(c) determining the number of objects in the sample that correspond to a certain target microbe (label) by applying said classifier to the sample data.

A microbe or microorganism, as used herein, refers to a microscopic organism, which is, in principle, unicellular, and may be present in its single-celled form, a two-celled form, i.e. during division, or in a colony of cells. A colony of microbial cells, as used herein, is considered as a unicellular organism, and not a multicellular organism. Thus, a unicellular organism, i.e. a microorganism, as used herein, refers to an organism that is able to live on its own as a single cell which carries out essentially all life processes, although a unicellular organism may or may not benefit from other cells or organisms in its environment. In contrast to a unicellular organism, the cells of a multicellular organism depend on each other to survive.

Thus, microbes, as used herein, include prokaryotes and microscopic, i.e. unicellular, eukaryotes such as protists and unicellular fungi.

Prokaryotes are unicellular organisms that lack a membrane-bound nucleus, mitochondria, or any other membrane-bound organelle. In particular, as used herein, prokaryotes include bacteria and archaea.

Protists include protozoa and protophyta, and fungus-like single-celled organisms, such as inter alia, Amoeba, Ciliates, Dinoflagellates, Foraminifera, Plasmodium, Phytophthora and Slime molds.

Unicellular fungi include inter alia Cryptococcus albidus, Candida albicans, Saccharomyces cerevisiae and Schizosaccharomyces pombe.

Preferably herein and in the context of the invention, a microbe is a prokaryote, preferably a bacterium.

A target microbe, as used herein, refers to a microbe that is comprised as output class (label) in the classifier of the invention and, i.e. may be recognized by using said classifier, i.e. distinguished from other microbes. In other words, the classifier of the invention is generated with a training data set that comprises information, i.e. parameter values and labels, of the target microbe. Moreover, since the classifier typically comprises information of other microbes which are, e.g., labeled in the training data set as non-target microbe or other target microbe, the classifier has learned to distinguish said target microbe from other microbes. In a particular sense, the target microbe is a microbe that is comprised in the classifier of the invention and sought to be recognized amidst other microbes, in particular with a high sensitivity, specificity and/or precision, wherein said other microbes may be included in said classifier as output classes or not. In other words, a target microbe is comprised in the classifier of the invention as output class (label), and thus may be distinguished from other microbes with a certain reliability by using said classifier, and a target microbe of particular interest is to be classified with a particularly high sensitivity, specificity and/or precision. Preferably, in the context the inventive method for quantifying the abundance of at least one target microbe in a sample provided herein, the target microbe is a target microbe of particular interest.

Thus, preferably herein and in the context of the invention, a target microbe, in particular a target microbe of particular interest, is a prokaryote, more preferably a bacterium. In one embodiment, the target microbe is not a freshwater or marine eukaryotic unicellular eukaryote and/or a phytoplankton, such as a dinoflagellate, a flagellate, a prymnesiomonad, a cryptomonad, a cryptophyte and/or a diatom.

In particular, the target microbe according to the invention is a microbial species or strain or a subpopulation thereof as described herein. Thus, preferably, in the context of the present invention, the microbial species or strain is a prokaryotic species or strain, more preferably a bacterial species or strain. As regards the classification of prokaryotes and bacteria, state-of-the art taxonomic systems should be used, e.g. Bergey's Manual of Systematic Bacteriology (Whitman (2012), 2nd ed., vol. 5, parts A and B, Springer, NY). The terms “species” and “strain”, as used herein, are not strictly separated from each other, and refer to a microbial, i.e. prokaryotic or bacterial, entity which reproduces itself while being distinguishable from another species or strain. In some cases, microbial species and strains of the same species are well characterized. In particular in such situations, a strain may be considered as a subcategory of a species. A species is typically considered as a subcategory of a genus. In some cases, species and strains may be at the same taxonomic level, i.e. refer to a subcategory of a genus. However, since prokaryotic taxonomy is rather flexible and conflicting, exceptions to those rules are possible. In any case, based on common knowledge and state-of-the art taxonomic systems, the person skilled in the art is able to clearly understand the taxonomic terms used herein. Moreover, with help of state-of-the art taxonomic systems and common general knowledge regarding genotypic and phenotypic similarities, i.e. genotypic similarities, the person skilled in the art can readily judge whether two microbial species or strains are related, i.e. closely related, or not. In particular, two species or strains may be considered to be related, when they share at least 1%, 2%, 5%, 10%, 20%, 30%, 40%, 50%, 60%, 70%, 80%, or 90%, e.g. at least 97%, of their genome, and closely related when they share at least 10%, 20%, 30%, 40%, 50%, 60%, 70%, 80%, 90%, 95%, 96%, 97%, 98% or 99%, preferably at least 97%, of their genome. Furthermore, two subpopulations of a microbial species or strain are also considered closely related. The percentage of sharing two genomes refers, in particular, to the sequence similarity between said two genomes. For example, the sequence similarity in the context of two nucleic acid or sequences can refer to the residues in the two sequences which are the same when aligned by methods known in the art, and can take into consideration additions, deletions and substitutions. Moreover, the sequence similarity between microbial species or strains may be also judged as described in Patel (2001), Molecular Diagnosis 6(4) and Nguyen (2016), npj Biofilms and Microbiomes 2.

A subpopulation of a microbial species or strain, as used herein, refers to a cell population of said microbial species or strain that is distinguishable from another cell population of said microbial species or strain. Two subpopulations may be different and distinguishable for various non-mutually exclusive reasons.

Two cell populations of one microbial species or strain may be obtained from different sources, locations and/or cultures, and may thus be considered a priori as subpopulations of said species or strain. Thus, said two cell populations may have distinct characteristics, which may be phenotypic, epigenetic and/or genetic. Phenotypic differences refer, for example, inter alia, to a physiological state, e.g. a metabolic state and/or activity state, and/or morphological characteristics of the microbes. The metabolic state may refer, for example, to the consumption of a certain energy source and/or the presence of a certain metabolite. The activity state may refer, for example, to cell growth and/or proliferation of the microbes, e.g. the growth rate and/or the presence in a certain state/phase, i.e. a growth phase such as the stationary phase, the exponential (log) phase, the lag phase or the death phase, or a state such as an endospore or an exospore, or a virulent or non-virulent state. Morphological characteristics may refer, for example, to a certain state of the cell cycle, e.g cell division, or the presence of a certain subcellular structure such as certain granules and/or nanoscopic or microscopic bodies. Different sources and/or locations may refer to certain environments wherein a microbial species or strain resides or is obtained from such as, inter alia, certain human or animal subjects, soil, water, water pipes, toilets, kitchens, showers, garbage, animals, plants, humans, organs, tissues etc. Furthermore, different microbial cultures may be established by culturing a certain microbial species or strain (from the same or different source, or from the same colony) in a different environment, i.e. in or on distinct culture media.

Furthermore, two subpopulations of one microbial species or strain may be identified by analyzing a cell population of said microbial species or strain as described herein, i.e. by cytometry, preferably flow cytometry, and/or unsupervised clustering, e.g., based on k-means algorithm. For example, several parameters of a microbial population of a pure culture may be measured by flow cytometry. Local cell densities, e.g. bimodal or multimodal distributions may indicate subpopulations that can be gated, and isolated or purified in silico and/or in the laboratory, e.g. by fluorescence-activated cell sorting (FACS). Furthermore, an unsupervised clustering algorithm, e.g. k-means, may be used for identifying subpopulations, e.g further subpopulations, in the data set (e.g. obtained by flow cytometry) of a certain microbial species, strain or subpopulation thereof. Subpopulations that are detected by such an approach may be present within the same sample comprising said microbial species or strain and/or a pure culture of said microbial species or strain.

Thus, subpopulations, as used herein, may be, in particular, (i) populations of a microbial species or strain that are obtained from different sources, locations and/or cultures, as described herein, and/or (ii) detected and/or isolated by analyzing, gating, clustering, and/or purifying a cell population of said microbial species or strain as described herein.

Thus, a target microbe according to the invention may be a subpopulation of a microbial species or strain as described herein.

A computer-implemented method, as used herein, refers to a method which involves a computer, computer network and/or other programmable apparatus. The computer and/or programmable apparatus is not particularly limited and may be, for example, inter alia a desktop PC, notebook, smartphone and/or a programmable laboratory device. Furthermore, other methods of the invention, even when not explicitly called “computer-implemented method” may involve a computer, computer network and/or other programmable apparatus, and/or may comprise a computer-implemented method of the invention, or at least one step thereof, as provided herein.

In particular in the context of a computer-implemented method of the invention, an inventive training data set provided herein, an inventive supervised machine learning algorithm, e.g. an artificial network, provided herein and/or an inventive classifier provided herein may be saved on a computer-readable storage medium. Thus, the invention further relates to a data processing device comprising means for carrying out a computer-implemented method of the invention. Furthermore, the invention relates to a computer program comprising instructions which, when the program is executed by a computer, cause the computer to carry out a computer-implemented method of the invention. In addition, the invention relates to a computer-readable storage medium comprising instructions which, when executed by a computer, cause the computer to carry out a computer-implemented method of the invention.

The inventive computer-implemented method for generating a classifier for at least one target microbe provided herein relates to the field of machine learning and comprises supervised learning. Supervised learning is the machine learning task of learning a function (classifier) that maps an input to an output based on example input-output pairs. Supervised learning infers a function (classifier) from labeled training data consisting of a set of training examples. Each example may comprise a pair consisting of an input vector and a desired output class. Herein, and in the context of the method for generating a classifier according to the invention, the training data (training data set) comprises data of a plurality of objects (training examples), wherein said plurality of objects comprises cells of at least one target microbe, and wherein said data comprises for each of said objects (i) (training examples) a label (desired output class) which identifies the type of the object, and (ii) an input vector which comprises a plurality of cytometric parameters of said object. Thus, a data set comprising data of individual cells of target microbes, e.g. target bacteria, and possibly of other microbes, can be used for training a supervised learning model, e.g. an artificial neural network or a random forest. Suitable supervised machine learning algorithms that can be used in the present invention, may include, inter alia, an artificial neural network (ANN), a random forest (RF), k Nearest Neighbor (kNN), Naive Bayes, Decision Trees, Gradient Boosting algorithms (e.g. GBM, XGBoost, LightGBM, or CatBoost), and Support Vector Machines (SVM). Preferably herein, the supervised machine learning algorithm includes an artificial neural network or a random forest, as described herein, preferably an artificial neural network. As illustrated in the appended Examples, an artificial neural network or a random forest are particularly powerful for classifying microbes. Hence, the supervised learning algorithm, i.e. the supervised machine learning algorithm, of the invention may comprise an artificial neural network or a random forest which is used for analyzing the training data set, wherein said learning algorithm, e.g. the artificial neural network or random forest, produces as output the classifier (inferred function/classifier function) of the invention. Said classifier may be used for mapping objects from a new (unseen) sample as described herein, i.e. in the context of the methods of the present invention, i.e. for quantifying the abundance of at least one target microbe in the sample, analyzing the microbial composition in the sample and/or diagnosing a microbial disease in a subject. Thus, the methods and/or classifier of the present invention allow determining the class labels for unseen instances (i.e. microbes in a sample, in particular target microbes as described herein) with a sufficiently high sensitivity, specificity and/or precision.

A classifier, as used herein, further refers to a discrete-value function, which may be used to assign given data values (input vector) to pre-defined categorical classes (labels, desired output classes). A discrete-value function is a discrete function which allows the x-values to be only certain points in the interval. Moreover, a classifier, as used herein, refers to a learned linear equation produced by the training, validation and testing of a supervised machine learning algorithm, e.g. including an artificial neural network or random forest, and is used to calculate the probability of each cell or event in a dataset to be attributed to each of the output classes. In other words, the classifier (classifier function) describes the correlations between the input parameters (input vector) and the categorical output classes (labels).

The output classes (or simply “classes”), as used herein, also refer to the used output attributions from the training and classifications of the supervised machine learning algorithm, e.g. the artificial neural network, and are typically the same number and names as the used standards. Thus, there terms “output classes”, “classes” and “labels” may be used interchangeably herein, and may also refer to the standards used for generating a classifier.

An object (or information thereof) comprised in data, an input vector, a training data set and/or a sample, as used herein in the context of the present invention, may refer to any microscopic object, in particular a microbe as described herein, or a bead, as described herein. Further relevant objects may be, for example, microscopic particles of anorganic, organic or biological material, such as inter alia cell debris or microplastic.

The term “microscopic”, as used herein refers to an object with a length or diameter of 100 nm to 500 μm, in particular 200 nm to 100 μm, in particular 200 nm to 15 μm. The term “nanoscopic”, as used herein, refers to an object with a length or diameter of 1 to 100 nm.

A plurality of objects, as used herein, refers to at least two, preferably many, objects (e.g. microbial cells, beads, particles) of the same type. The type of an object may be also considered as a label/class/category/output class of a classifier of the invention, whereas the object as such rather refers to an individual microbial cell, bead, or particle. Thus, a plurality of microbial cells refers to at least two, preferably many, microbial cells. A microbe, i.e a target microbe, may be also considered as a label/class/category/output class of a classifier of the invention, whereas a microbial cell rather refers to an individual microbial cell.

A label of an object (type of an object) and/or microbe, as used herein, refers, in particular, to an output class of the classifier of the present invention. An input vector, as used herein, refers, in particular, to the parameters of an object and/or microbial cell based on which said object and/or microbial cell is assigned (mapped) to an output class of the classifier.

In particular herein, the parameters comprised in an input vector according to the invention, are cytometric parameters. Thus, in some embodiments, the input vector may exclusively include cytometric parameters, e.g. as determined by flow cytometry. Thus, the generation of the classifier of the invention and the classification of microbes may, optionally, only depend on cytometric parameters as input. Cytometric parameters, as used herein, are parameters than can be determined by a cytometer. A cytometer, as used herein, may be a flow cytometer or a mass cytometer, preferably a flow cytometer. In particular, flow cytometers are able to analyze many thousand particles per second, in “real time,” and, if configured as cell sorters, can actively separate and isolate particles with specified optical properties at similar rates.

Flow cytometry offers high-throughput, automated quantification of specified optical parameters on a cell-by-cell basis. Typically, flow cytometers require as input a single-cell suspension. Usually, a flow cytometer has five main components: a flow cell, a measuring system, a detector, an amplification system, and a computer for analysis of the signals. The flow cell has a liquid stream (sheath fluid), which carries and aligns the cells so that they pass single file through the light beam for sensing. The measuring system often comprises optical systems, e.g. lasers at different wavelengths spanning the color spectrum from UV light to infrared light, i.e. in the visible range. The detector and analog-to-digital conversion (ADC) system converts analog measurements of forward-scattered light (FSC) and side-scattered light (SSC) as well as dye-specific fluorescence signals into digital signals that can be processed by a computer. The amplification system can be linear or logarithmic.

Mass cytometry is a mass spectrometry technique based on inductively coupled plasma mass spectrometry and time of flight mass spectrometry used for the determination of the properties of cells. Mass cytometry overcomes limitations of spectral overlap in flow cytometry by utilizing discrete isotopes as a reporter system instead of traditional fluorophores which have broad emission spectra. Mass cytometers are available in the art, for example, but not limited to CyTOF (cytometry by time of flight).

Thus, cytometric parameters, as used herein, may comprise, in particular, FSC-A, FSC-H, SSC-A, SSC-H, Width and the fluorescence intensities measured in flow cytometry channels. FSC intensity is proportional to the diameter of the cell. Side scatter measurement (SSC) provides information about the internal complexity (i.e. granularity) of a cell. The specifications “−A” and “—H” and “Width” refer to shape of the electronic pulse of the flow cytometer's detector, wherein “−A” refers to the integral or area of the signal, “—H” refers to the height of the signal (peak), and “Width” (time of flight) to the width of the signal. The fluorescence intensity of an object may be determined in different channels, wherein each channel refers to exciting an object with light of a certain wavelength and measuring the resulting fluorescent light. The fluorescence intensity is particularly relevant, when a specific part of a microbe (e.g. the DNA, membrane or a certain protein), has been stained with a fluorescent dye and/or binding molecule such as an antibody, as described herein.

Thus, the training data set, as used herein, comprises data of a plurality of objects, as described herein, wherein said plurality of objects comprises cells of said at least one target microbe, as described herein, and wherein said data comprises for each of said objects (i) a label (output class) which identifies the type of the object, as described herein, and (ii) an input vector which comprises a plurality of cytometric parameters of said object, as described herein.

In the context of the present invention, the training data set is analyzed with a supervised machine learning algorithm, e.g., an artificial neural network, as described herein, in particular, wherein a classifier according to the invention is obtained.

Artificial neural networks (ANN) are systems that “learn” to perform tasks by considering examples, generally without being programmed with task-specific rules. An ANN is based on a collection of connected units or nodes called artificial neurons. Each connection can transmit a signal to other artificial neurons. An artificial neuron that receives a signal then processes it and can signal artificial neurons connected to it. In ANN implementations, the “signal” at a connection is a real number, and the output of each neuron is computed by some non-linear function of the sum of its inputs. The connections are called edges. Artificial neurons (nodes) and edges typically have a weight that adjusts as learning proceeds. The weight increases or decreases the strength of the signal at a connection. Artificial neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly via hidden intermediate layers, and possibly after traversing the layers multiple times.

In the context of the present invention, the nodes of the input layer correspond, in particular, to the cytometric parameters comprised in the input vector, as described herein. Moreover, the nodes of the output layer correspond, in particular, to the labels (output classes/standards) comprised in the classifier of the invention, as described herein.

Random Forest is a classification algorithm that contains a number of decision trees on various subsets of the given dataset and takes the average to improve the predictive accuracy of that dataset. It uses bagging and feature randomness methods when building each individual tree to try to create an uncorrelated forest of trees whose prediction by committee is more accurate than that of any individual tree. Instead of relying on one decision tree, the random forest takes the prediction from each tree and based on the majority votes of predictions, it predicts the final output. A greater number of trees in the forest leads to higher accuracy and prevents the problem of overfitting. Further reference is made to Tony Yiu, Jun. 12, 2019 (https://towardsdatascience.com/understanding-random-forest-58381e0602d2), and https://www.javatpoint.com/machine-learning-random-forest-algorithm (downloaded on Jun. 22, 2021).

In a further aspect, the invention relates to a computer-implemented method for classifying at least one target microbe in a sample, wherein said target microbe is a microbial species or strain or a subpopulation thereof, and wherein said method comprises the steps of
(a) obtaining a classifier according to the invention and as provided herein,
(b) obtaining data of a plurality of objects from said sample, wherein said data comprises for each of said objects a vector comprising a plurality of cytometric parameters, and
(c) assigning the objects in the sample to the labels by applying said classifier to the sample data, in particular, evaluating the number of assignments to the label (output class) of the at least one target microbe to be classified.

In the context of the present invention, e.g. with respect to the method for quantifying the abundance of at least one target microbe in a sample, the method for classifying at least one target microbe in a sample and/or the method for analyzing the microbial composition in a sample, the sample does not have to be physically available as such but may be also available as a data set comprising data of the microbes comprised in said sample, i.e. a data set that has been generated by analyzing the microbes in said sample with a cytometric method as described herein.

Furthermore, in the context of the inventive methods comprising a step of obtaining the classifier of the present invention, said classifier may be obtained by first carrying out the steps of the computer-implemented method for generating a classifier for at least one target microbe as provided herein, and/or by directly obtaining a classifier that can be generated by said inventive method for generating a classifier, e.g. a classifier that is saved on a computer-readable storage medium.

Thus, in the context of the present invention, the at least one target microbe is classified in a sample and/or the abundance of at least one target microbe in a sample is quantified by applying a classifier according to the present invention to data of a plurality of objects from said sample (sample data set), wherein said data comprises for each of said objects a vector comprising a plurality of cytometric parameters (sample object vectors). Preferably, said cytometric parameters are the same as the cytometric parameters comprised in the input vector(s) that has/have been used for generating said classifier. As described herein, the classifier assigns/maps an object from the sample to a label (output class), and thus provides an estimate of the relative abundance of an object type (i.e. a target microbe) in the sample, thereby quantifying or determining the abundance of said object or target microbe in said sample. Furthermore, the absolute abundance of said object type/target microbe may be inferred, i.e. by estimating the total number of objects in the sample, e.g. by flow cytometry, as described herein, or by manually counting the microscopic objects in a representative subsample. The reliability of this estimation depends on the performance of the classifier, e.g. its sensitivity, specificity, precision and/or accuracy as described herein. As demonstrated in the appended Examples, the classifier of the invention can well distinguish between objects of different classes (labels).

In particular, the sensitivity (true positive rate/recall) of the inventive classifier provided herein is high, which means that the classifier recognizes at least 20%, 30%, 40%, 50%, 60%, 70%, 80% or 90%, preferably at least 50%, 60%, 70%, 80% or 90%, preferably at least 80%, 85%, 90%, or 95%, preferably at least 90%, 92%, 94%, 95%, 96%, 98%, or 99% of the objects (i.e. cells of a certain target microbe) that should be recognized in a sample (true positives), i.e. a sample data set. In other words, the term “recognizing” in this context means that the classifier assigns an object or microbe to the correct output class (label).

Furthermore, in particular, the precision (positive predictive value) of the inventive classifier provided herein is high, which means that at least 20%, 30%, 40%, 50%, 60%, 70%, 80% or 90%, preferably at least 50%, 60%, 70%, 80% or 90%, preferably at least 80%, 85%, 90%, or 95%, preferably at least 90%, 92%, 94%, 95%, 96%, 98%, or 99% of the objects (i.e. cells of a certain target microbe) that have been assigned to a certain output class (label) truly belong to this output class, i.e. are true positives.

Since the classifier of the present invention assigns many of the cells of a certain target microbe in a sample to the correct output class (label) and/or many of the cells assigned to said output class (label) are correctly assigned to this output class, the classifier of the present invention has a high sensitivity and/or precision, as described herein, i.e. for classifying a certain target microbe as described herein. The term “many cells” as used herein in this context, refers to at least 20%, 30%, 40%, 50%, 60%, 70%, 80% or 90%, preferably at least 50%, 60%, 70%, 80% or 90%, preferably at least 80%, 85%, 90%, or 95%, preferably at least 90%, 92%, 94%, 95%, 96%, 98%, or 99% of the cells.

Furthermore, since most or all classifications (of the various target objects/microbes) made by a classifier may be characterized by a high true positive rate and a high precision, i.e. are characterized by many true positives and few false negatives, the specificity (true negative rate) and/or accuracy of the classifier for a certain classification may be also high, which means at least 20%, 30%, 40%, 50%, 60%, 70%, 80% or 90%, preferably at least 50%, 60%, 70%, 80% or 90%, preferably at least 80%, 85%, 90%, or 95%, preferably at least 90%, 92%, 94%, 95%, 96%, 98%, or 99%.

Moreover, the classifications may be characterized by 80-99% true positive identification at <20% false positives, as illustrated in the appended Examples.

The classification of a target microbe can be characterized by statistical measures such as the sensitivity, precision, specificity and/or accuracy. Furthermore, the classification of objects or microbial cells in a data set or sample may refer to the attribution or assignment of said objects/microbial cells to the output classes.

Thus, in a broad sense, the term “classification” may refer to the attribution or assignment of cells, objects or events in a dataset to each of the output classes, for example, based on their maximum probability or similarity score.

In the context of evaluating the performance of the classifier for recognizing and/or differentiating a target microbe or cells of a target microbe, the term “classification” rather refers to the recognition and/or distinction/differentiation of a target microbe, e.g. to evaluating how many cells of the target microbe are recognized (true positive rate) and how many of the objects assigned to the target microbe class are correct (precision).

Thus, the classifier of the present invention reliably differentiates or distinguishes objects in an unseen sample data set from each other, i.e. with a high sensitivity, precision, specificity and/or accuracy.

The terms sensitivity, precision, specificity and accuracy are used herein as commonly understood in the art, i.e. in the context of machine learning.

In particular, the terms “sensitivity”, “true positive rate”, “recall” and “TPR” are used interchangeably herein, and refer to TP/(TP+FN).

In particular, the terms “precision”, “positive predictive value” and “PPV” are used interchangeably herein, and refer to TP/(TP+FP).

In particular, the terms “specificity”, “true negative rate” and “TRN” are used interchangeably herein, and refer to TN/(TN+FP).

In particular, the term “accuracy” refers to (TP+TN)/(TP+TN+FP+FN).

In the context of these statistical terms, “TP” refers to the true positives, “TN” refers to the true negatives, “FP” refers to the false positives, and “FN” refers to the false negatives.

In other words, true positives are objects/microbial cells which should be assigned to a certain output class and are assigned to said output class. The true negatives are objects/microbial cells which should not be assigned to a certain output class and are not assigned to said output class. False positives are objects/microbial cells which should not be assigned to a certain output class but are assigned to said output class. And false negatives are objects/microbial cells which should be assigned to a certain output class but are not assigned to said output class.

Furthermore, the false positive rate (FPR) is 1-TNR; the false discovery rate (FDR) is 1-PPV; and the miss rate (or false negative rate) is 1-TPR. Evidently, the miss rate and the false discovery rate of a classification are as low as the sensitivity and the precision of the classification by using the classifier of the invention are high, respectively. Furthermore, the negative predictive value (NPV) is TN/(TN+FN). The positive predictive value and the negative predictive value may be used, in particular, for describing the performance of a diagnostic test.

Furthermore, as used herein, the term “correct predicted classification” refers to the number of cells in a dataset with “known composition” attributed (assigned) to their actual output class(es) based on their maximum individual probability score, i.e. to (TP+FP)/(TP+FN). It can be expressed as percentage of the intended number of added cells. However, when no false positives can be present, i.e. in the case of pure cultures, the term also refers to the sensitivity (true positive rate, recall). The term “correct predicted classification” may also be considered as an estimate of the sensitivity when the number of attributed cells has been corrected for false positives, e.g. when the typical assignment of the “background” microbial community is taken into consideration (background subtraction).

As used herein, the term “Predicted classification” refers to the number of cells in a dataset with ‘unknown composition’ attributed (assigned) to one or more of the defined output classes based on their highest individual probability score. It can be expressed as percentage of all attributed cells.

A data set with “unknown composition”, as used herein, refers to a data set that has been generated from a microbial culture with unknown composition, e.g. a natural sample, or a regrown natural sample, e.g. a lake water microbial community.

A data set with “known composition”, as used herein, refers to a data set that has been generated from a mixed microbial culture which has been experimentally assembled (in vitro). Thus, in such a data set, the percentage of cells of a certain standard microbe is known but the true identity of a certain microbial cell is typically unknown.

For determining the sensitivity, specificity, precision and/or accuracy of a classifier, e.g. for the classification of a certain target microbe, an silico assembled unseen test data set may be used, e.g. as illustrated in the appended Examples, because in such a data set, the true identity of the objects/microbial cells is known, and TP, TN, FP and FN are readily available.

The performance of the classifier on such a test data set may be visualized, e.g., as illustrated in the appended Examples, by a confusion matrix (confusion plot/confusion matrix plot). Typically, on the confusion matrix plot, the rows correspond to the predicted class (Output Class) and the columns correspond to the true class (Target Class). Moreover, the diagonal cells (squares) typically correspond to observations that are correctly classified and the off-diagonal cells (squares) correspond to incorrectly classified observations. In some cases, the number of observations and the percentage of the total number of observations may shown in each cell (square). Furthermore, the proportion of objects of a certain class (TP+FN; “column”) assigned to a certain output class, or, i.e., the proportion of objects assigned to an output class (TP+FP; “row”) belonging to a certain class may be shown in each cell (square), e.g. by a color scale, e.g. as illustrated in the appended Examples as “proportion assigned”. In addition, there may be a column on the far right of the plot which shows the percentages of all the examples predicted to belong to each class that are correctly and incorrectly classified (precision/positive predictive value, and false discovery rate, respectively). Furthermore, there may be a row at the bottom of the plot showing the percentages of all the examples belonging to each class that are correctly and incorrectly classified (recall/true positive rate/sensitivity, and false negative rate, respectively). Furthermore, there may be an extra cell (square) in the bottom right of the plot which shows the overall accuracy.

An in silico assembled test data set and/or a data set generated from a mixed microbial culture of “known composition” may be further used for determining the “correct predicted classification” of a target microbe, as described herein. Furthermore, a data set generated from a microbial culture of “unknown composition” may be used for determining the “predicted classification” of a microbe which is not necessarily a target microbe.

Furthermore, the sensitivity (true positive rate) of the classification of a certain target microbe may be also determined by classifying (assigning to the output classes) microbial cells of a pure culture of said target microbe with the classifier of the invention, e.g. as illustrated in the appended Examples. A pure culture, as used herein, comprises essentially only cells of the target microbe, and may be, e.g., a clonal culture. Evidently, in such a setup, essentially no other microbial cells can be assigned to the output class of the target microbe, and thus there are essentially no type I errors (false positives), but only type II errors (false negatives) possible for this classification.

Furthermore, a pure culture of another microbe may be also used to determine the specificity of the classification of a certain target microbe over said pure culture microbe. In particular, the cells of the pure culture of the other microbe that are assigned to the output class of the target microbe must be false positives, and the cells which are not assigned to the output class of the target microbe must be true negatives. This approach may be expanded to a mixed culture of microbes which does not contain the target microbe. Therefore, the specificity for classifying the target microbe amidst said mixed culture may be calculated. For example, as illustrated in the appended Examples, a sample such as a lake water microbial community or a soil microbial community may be used as a mixed culture and the specificity for classifying a target microbe amidst such a microbial community may be calculated. Another suitable microbial community as mixed culture may be a composition of representative gut microbiota species, i.e. as described herein.

The abundance of a target microbe may be quantified/determined/estimated/inferred by summing up the objects (i.e. microbial cells) in a sample, i.e. a sample data set, that have been assigned to the output class corresponding to said target microbe, and thus correspond to said target microbe. Thus, the number of objects in the sample that correspond to a certain target microbe (label) may be determined by applying said classifier to the sample data.

The abundance may be preferably represented as relative abundance (% of all objects in the sample or sample data set assigned to an output class), or further as absolute abundance, as described herein, i.e. by taking into account the total amount of objects present in the sample.

Furthermore, it may be considered that a target microbe is present in the sample if at least 80%, 70%, 60%, 50%, 40%, 30%, 20% or 10%, preferably 50%, 40%, 30%, 20% or 10%, preferably, 20%, 15%, 10% or 5%, preferably 10%, 8%, 6%, 5%, 4%, 2% or 1%, preferably 5%, 4%, 3%, 2%, 1%, 0.5%, 0.2% or 0.1% of the cells in the sample data set are assigned to the output class (label) corresponding to said target microbe. In particular, the lower the required minimum frequency of objects assigned to the corresponding output class is, the easier and more reliably the classifier identifies or recognizes a target microbe in the sample. Since a target microbe in the sample is recognized with a high probability (i.e. at a high true positive rate) and its identity is verified with a high probably (i.e. with a high precision), as described herein, said required minimum frequency can be rather low.

Therefore, the presence of a target microbe in a sample may be verified, and/or a target microbe may be identified or recognized in a sample by applying the classifier of the sample data as described herein, in particular if said target microbe has been found to be present in the sample at at least a certain frequency, as described herein.

In particular, in the context of the inventive methods provided herein, an object is assigned (mapped) to an output class (label) based on a probability value. In particular, the object may be assigned to a certain output class when the probability for assignment to the other output classes is lower, i.e. to any particular one, or in other words, the object may be assigned to the output class with the highest probability value. Furthermore, a predetermined probability threshold may be applied such that an object is only mapped to an output class (label) when the probability of assignment is above said threshold. If said probability of assignment is below said threshold, an extra output may be generated, e.g. such as inter alia “non-identifiable” or “n/a”.

Thus, in particular herein, determining the number of objects in the sample that correspond to a certain target microbe (label) may comprise the steps of
(a) using the classifier of the invention for determining for each of the objects in the sample the probability that the object corresponds to a certain target microbe (label),
(b) determining that the object corresponds to said certain target microbe, if said probability is above a predetermined threshold and/or, the probability that said object corresponds to any particular one of the other label(s) comprised in the classifier is lower than the probability that said object corresponds to said certain target microbe (label), and
(c) counting the objects which have been determined to correspond to said certain target microbe, thereby determining the abundance of said certain target microbe in said sample.

The classifier of the invention is capable of distinguishing at least one target microbe from at least one other object, in particular at least one other microbe.

Furthermore, the classifier may be capable of distinguishing at least two related target microbes, i.e. two closely related target microbes, as described herein.

Thus, in certain embodiments, the plurality of objects comprised in the training data set that is used for obtaining the classifier comprises cells of at least two related target microbes and the classifier is capable of distinguishing said at least two related target microbes, as described herein.

In the context of the present invention, e.g. with respect to the method for quantifying the abundance of at least one target microbe in a sample, the method for classifying at least one target microbe in a sample and/or the method for analyzing the microbial composition in a sample, the sample comprises, in particular, a plurality of different microbes, e.g. at least 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, or 10000 different microbial species or strains, in particular a microbiome or microbial community, as described herein. A microbial community or microbiome, as used herein, is mix of a plurality of different microbes as defined herein, e.g. just above.

A microbial community, or, in particular, a microbiome or microbiota may further refer to an ecological community of commensal, symbiotic and pathogenic microorganisms which may be found in or on a multicellular organism, and may comprise bacteria, archaea, protists, and fungi, as described herein.

Thus, the objects in a sample, e.g. in the context of the inventive method for quantifying the abundance of at least one target microbe in a sample, may belong to a plurality of different microbes, e.g. from at least 2 to at least 10000 different microbial species or strains, and/or a microbiome, as described herein.

Furthermore, a sample used in the context of the present invention may further comprise at least two related target microbes as described herein, in particular wherein the abundance of at least one of the at least two related target microbes in said sample is determined. In particular, the at least two related target microbes are (i) at least two related microbial species, (ii) at least two microbial strains of the same species, and/or (iii) at least two subpopulations of the same microbial species or strain, as described herein. The related microbial species in option (i) may be microbial species or strains of the same family, preferably subfamily, preferably genus. Furthermore, one of the two subpopulations in option (iii) may be in one growth phase, i.e. the exponential phase, and the other one in another growth phase, i.e. the stationary phase. In particular, the subpopulation of a certain microbial species or strain may be a physiologically distinct subpopulation, i.e. be in a physiological distinct state, as described herein. For example, the physiologically distinct subpopulation may have a distinct growth rate, wherein said growth rate may depend on the growth phase and/or the environment of the microbe, e.g. the culture medium. In particular, the growth rate is a measure of the number of divisions per cell per unit time. In particular, the physiologically distinct subpopulation may be in the exponential phase or the stationary phase. Furthermore, one subpopulation, may be in a vegetative phase, i.e. the lag phase, the exponential phase, the stationary phase or the death phase, i.e. the exponential phase or the stationary phase, and another subpopulation may be in a dormant state, i.e. a spore state such as an endospore state, as described herein.

Thus, in certain embodiments, the classifier is capable of distinguishing at least two subpopulations of the same microbial species or strain, wherein one of said at least two subpopulations is in the exponential phase, and another one is in the stationary phase.

In one embodiment, the classifier of the invention is used for determining the abundance of at least one of at least two related target microbes comprised in a sample, wherein said classifier comprises output classes (labels) of said at least two related target microbes, and is capable of distinguishing said at least two related target microbes, in particular, wherein said classifier has been generated by using a training data set comprising data of said at least two related target microbes.

The growth of microbes such as bacteria can be modeled, i.e. in batch culture, with four different phases: lag phase (A), log phase or exponential phase (B), stationary phase (C), and death phase (D).

During lag phase, microbes adapt themselves to growth conditions. It is the period where the individual microbial cells are maturing and typically not yet able to divide.

During the lag phase, typically synthesis of RNA, enzymes and other molecules occurs.

During the lag phase cells change very little because the cells do not immediately reproduce in a new environment, e.g. a new medium. This period of little to no cell division is called the lag phase and may last for 1 hour to several days. However, during this phase cells are not dormant.

The exponential phase (log phase or logarithmic phase) is a period characterized by cell doubling. The number of new microbial cells appearing per unit time is proportional to the present population. If growth is not limited, doubling will continue at a constant rate so both the number of cells and the rate of population increase doubles with each consecutive time period. For this type of exponential growth, plotting the natural logarithm of cell number against time produces a straight line. The slope of this line further refers to the growth rate of the microbe in the exponential phase, which is a measure of the number of divisions per cell per unit time. The actual rate of this growth (i.e. the slope of the line in the figure) may depend upon the growth conditions, which affect the frequency of cell division events and the probability of both daughter cells surviving. Exponential growth cannot continue indefinitely, however, because the microbial environment, i.e. the medium, gets depleted of nutrients and enriched with wastes.

The stationary phase is often due to a growth-limiting factor such as the depletion of an essential nutrient, and/or the formation of an inhibitory product such as an organic acid. Stationary phase results from a situation in which growth rate and death rate are equal, or in other words, the net growth ratio of the microbial cell population is about 0 in the stationary phase.

At death phase (decline phase), the microbial cells die. This could be caused by lack of nutrients, environmental temperature above or below the tolerance band for the species, or other injurious conditions.

An endospore is a dormant, i.e. tough and non-reproductive structure, produced by some bacteria and archaea in the phylum Firmicutes which is not a spore in an ordinary sense (i.e., not an offspring). Endospore formation is usually triggered by a lack of nutrients, and usually occurs in gram-positive bacteria. In endospore formation, the bacterium divides within its cell wall, and one side then engulfs the other. Endospores enable bacteria to lie dormant for extended periods, even centuries. When the environment becomes more favorable, the endospore can reactivate itself to the vegetative state. Examples of bacterial species that can form endospores include, inter alia, Bacillus cereus, Bacillus anthracis, Bacillus thuringiensis, Clostridium botulinum, and Clostridium tetani.

Some classes of bacteria can turn into exospores, also known as microbial cysts, instead of endospores. Exospores and endospores are two kinds of “hibernating” or dormant stages seen in some classes of microorganisms.

In the context of the present invention, the values of the cytometric parameters of an object, i.e. comprised in an input vector, a training data set and/or a sample data set, as described herein, have been determined by flow cytometry.

A parameter, as used herein, refers, in particular, to a characteristic of an object, i.e. a microbial cell that is used for defining or classifying said object or microbial cell. Furthermore, a parameter may be a formal parameter as known in the field of programming and refer to a variable as found in the function definition.

The value of a parameter, as used herein, refers to the concrete value of said parameter for a certain object, i.e. microbial cell, and may be further known as actual parameter or argument in the field of programming.

For example, the forward scattered light (FSC), e.g. the height of the FSC signal (FSC-H) of a microbial cell in a flow cytometry measurement helps characterizing said microbial cell and may be called a “parameter” or “cytometric parameter”, as used herein. For example, the FSC-H value of the microbial measured in an experiment may be 1000, and the FSC-H value of another microbial cell in an experiment, i.e. the same experiment or experimental run, may be 5000.

Although the parameter for characterizing the two microbial cells is the same, the value of the parameter may be different for each cell. In other words, in the context of the present invention, the parameters measured for an object, i.e. a microbial cell in a sample, as described herein, preferably correspond to the parameters that have been used for generating the classifier of the invention, i.e. the cytometric parameters comprised in the input vector and the training data set. Moreover, the values of the parameters of the objects from the sample are preferably determined the same way or in a similar way as the values of the parameters that have been used for generating the classifier, in particular by using the same type of instrument (i.e. flow cytometer) with preferably the same settings (e.g. the same lasers, the same detectors, and the same voltage/amplification of the signals). In particular, different instruments and/or data sets obtained on different instruments or on different days and/or different laboratories may be further calibrated by using standard beads, i.e. commercially available standard beads that are sold for calibration of flow cytometers. As illustrated in the appended Examples, such beads may be used as further standards in addition to microbes and be comprised in the training data set and the classifier of the invention. This approach makes, in particular, the classifiers of the invention applicable on other sample data sets, e.g. generated on different instruments, on different days and/or in different laboratories. In other words, the beads (bead standards) described herein in the context of the present invention may be used to align the position of a data set if needed.

Thus, the values of the parameters measured for the sample object may be used by the classifier for assigning the sample object to an output class (label) based on similarity with the values of the parameters of the labeled objects (i.e. the example objects in the training data set) that were used for generating the classifier.

In the context of the present invention, the plurality of parameters of an object, i.e. a microbial cell, may comprise at least one, preferably at least 2, preferably at least 4, preferably at least 6, e.g. 7 or 11, parameters selected from the group consisting of FSC-A, FSC-H, SSC-A, SSC-H, Width and the fluorescence intensity in at least one flow cytometry channel, preferably at least 2, 3, 4, 5, 6, 7, 8, 9, 10, 12, 14, 16, 18 or 20 channels. Preferably, the fluorescence intensity is from a fluorescent stain for DNA, membrane, dead cells, cell wall polysaccharide, and/or metabolism.

For example, the plurality of parameters of an object may comprise the fluorescence intensity of a fluorescent stain for DNA (e.g. SYBR Green I), membrane (e.g. FM4-64) and/or cell wall polysaccharide (e.g. WGA-Alexa Fluor 555).

In particular, a DNA stain may be, for example, inter alia, a SYBR Green or a Hoechst stain such as Hoechst 33258 and Hoechst 33342 or SYTO stains such as SYTO 9, preferably SYBR Green I; a membrane stain may be, for example, inter alia, Nile red, FM4-64 or DiOC2(3); a dead stain may be, for example, inter alia, propidium iodide (e.g. PI-red); a cell wall polysaccharide stain may be, for example, inter alia, a fluorescently labeled lectin stain (e.g. lectin-FITC, or lectin-Alexa555), or fluorescent D-amino acids (e.g. HADA, TADA); and the metabolic stain may be, for example, inter alia, 5-cyano-2,3-ditolyl tetrazolium chloride (CTC), preferably in combination with propidium iodide.

In the context of the present invention, the plurality of parameters of the object may comprise at least 2, preferably at least 4, preferably at least 7 parameters, e.g. at least 11 parameters, and/or at most 200, preferably at most 100, preferably at most 50, preferably at most 20, preferably at most 10, preferably at most 7 or 11 parameters. In particular, if the parameters are cytometric parameters determined by flow cytometry, the plurality of parameters may comprise at least 2, preferably at least 4, preferably at least 7 or 11 parameters and/or at most 36, preferably at most 24, preferably at most 14, preferably at most 10, preferably at most 7 or 11 parameters. Evidently, the very minimum of a plurality of parameters is 2.

In the context of the present invention, the data, i.e. the values of the cytometric parameters may be pre-processed. In particular, the pre-processing may comprise selecting and/or scaling the data of at least one cytometric parameter between a minimum and a maximum value. The data of a cytometric parameter refers to the plurality of values of said parameter for a plurality of objects. Said plurality of values may be also considered as a distribution of values, and may be visualized or plotted, e.g. as a histogram or a density plot.

The value distributions of two parameters may be visualized or plotted, e.g., as a scatter plot or a two-dimensional density plot. The distribution of values of a cytometric parameter, e.g. FSC-H or another flow cytometric parameter as described herein, may be trimmed between a lower and upper boundary. Said boundaries may be set in a way to remove outliers and/or focus on the major population within the corresponding plurality of objects. In particular, the lower and upper boundaries are positive numbers (e.g. 10⁵, 10⁷, 1, 10000, 5.35234, 0.000001 or +6).

Said boundary values further refer to the anchors of a cytometric parameter, as used herein (in contrast to the boundaries/gates used for defining subpopulations as described herein). Preferably, many or all of the cytometric parameters may be trimmed in such a way. To maintain the same parameters and parameter range for all objects, the data of an object with a parameter value outside of the boundaries (anchors), is preferably disregarded or removed from the data set. In other words, the data set of the objects or microbial cells may be filtered between the chosen minimum and maximum thresholds (boundaries/anchors). It is particularly preferred that the anchor values (anchors) are added to the data set, i.e. to a training data set and a sample data set, preferably for each cytometric parameter used. In particular, the anchors define the parameter range such that the parameter range is the same between data sets, e.g. between the training data set and a sample data set, and/or between different sample data sets. Moreover, anchoring the data set, as described herein, avoids distorting the distributions, i.e. relative to another data set, when the different parameters are scaled to the same range, as described herein.

Thus, the pre-processing, i.e. the anchoring leads, in particular, to a positioned/anchored data set with defined parameter ranges, and which is, preferably, void of outlier values. Furthermore, the scales of the different parameters/parameter ranges may be further standardized to a certain range, e.g. between −1 and 1. Of note, a range such as −1 and 1 does not refer to the upper and lower boundaries chosen for anchoring/filtering the data set but is established/imposed after the data set has been anchored. Thus, a training data set and/or a sample data as, as described herein in the context of the present invention, may be a filtered, anchored and/or scaled data set as described herein, and as illustrated in the appended Examples.

In particular, the pre-processing of the data of a cytometric parameter according to the invention comprises the steps of
(a) determining a lower and an upper boundary of said cytometric parameter,
(b) adding the lower and upper boundaries of said cytometric parameter as two data points to the data of said cytometric parameter, and
(c) assigning to the lower boundary a minimum value and assigning to the upper boundary a maximum value, thereby scaling the data.

In particular, the difference of said minimum value to the mean of said minimum and maximum values has the same absolute value as the difference of said maximum value to said mean. Preferably, the minimum and maximum values are −1 and 1, respectively. Moreover, the data of the at least one cytometric parameter may be log transformed, e.g. log₁₀ transformed, before the scaling.

In some embodiments, selecting and/or scaling the data comprises (a) determining a lower and an upper boundary of at least one cytometric parameter and (a′) removing the data of the objects whereof any of the cytometric parameters is outside of the determined boundaries.

In the context of the present invention, subpopulations of a microbial species or strain, i.e. of a target microbe, may be identified, detected defined and/or isolated in a data set comprising cytometric data, as described herein. In particular, the subpopulations are identified in a data set comprising only data of a certain type of object or microbe, e.g. a pure culture, as described herein.

As explained herein, a data set used in the context of the invention typically comprises a plurality of cytometric parameters of a plurality of objects including microbial cells. The distributions of the parameter values determined for a plurality of objects may be regarded as probability distributions and/or plotted in different dimensions, e.g. one, two, three or multiple dimensions. Such a distribution may have one, two or multiple modes which appear as distinct peaks (local maxima) in the probability density function. In other words, there are more objects in the data set with a parameter value similar to a (local) maximum in the corresponding probability distribution than objects with a value similar to a (local) minimum in said distribution. In particular, two local maxima separated by a local minimum in a probability distribution indicate the presence of two discernible subpopulations, in particular wherein the two subpopulations may be split by a value near the local minimum, or two values adjacent to the local minimum. Evidently, if there are multiple local maxima, multiple subpopulations may be identified, and separated/split. Furthermore, a subpopulation may be split into further subpopulations, if the mother subpopulation has a bi- or multimodal distribution of another parameter. Furthermore, the probability distributions of two parameter may be plotted in two or three dimensions, e.g. as a scatter plot or corresponding density plot, and local densities may be evaluated, e.g. visually, in two or three dimensions. An area of a high density in the plot that is separated by a low density area may considered as a subpopulation. It is also, e.g. possible to identify and separate a subpopulation based on two dimensions and identify further subpopulations when plotting the mother subpopulation in two other dimensions and so forth.

In particular, a dense area may be considered as a subpopulation, if the objects comprised in said dense area constitute at least 50%, 30%, 10% or 5%, preferably at least 5% of all objects of the data set, i.e. the objects comprised in the plot.

The described process is generally referred to as gating, and may be performed, e.g. by flow cytometry software such as FlowJo or any other software which can load the flow cytometry data.

In particular, when using a FACS instrument, the subpopulations may be gated while performing the experiment, and the gated subpopulations may be sorted, i.e. purified. This further allows to prepare a standard from that subpopulation, e.g. a pure microbial culture or stock thereof, which may be comprised in a kit, as described herein. Such a standard subpopulation may be further used as reference for defining the subpopulation in another instrument and/or for preparing further classifiers.

Furthermore, clustering techniques, e.g. unsupervised approaches, e.g. k-means algorithm, or T-distributed Stochastic Neighbor Embedding (t-SNE), are readily available to identify subpopulations within a data set, and may be used in the context of the present invention.

Evidently, the data sets of individual target microbes (standards/labels/output classes), and/or the data sets of the identified subpopulations, may be combined into one data set that is used for generating a classifier, as described herein. It is just important, that in the data set that is used for generating the classifier, each object or microbial cells comprises a label, i.e. corresponding to the microbial species or strain or a subpopulation thereof.

In particular, the identification and definition of subpopulations within a pure culture of a microbial strain or species may be beneficial for reducing the heterogeneity of microbial cells with the same label. Thus, increasing the homogeneity of a standard/label/output class in the training data set may enhance the performance of the resulting classifier, i.e. increase the specificity and/or precision.

Thus, the methods of the present invention, i.e. the method for generating a classifier as described herein, may further comprise a step of determining subpopulations of a target microbe, as described herein, i.e. before combining the data sets of the target microbes (i.e. the standard microbe species or strains) into a training data set.

In certain embodiments, determining subpopulations of a target microbe comprises the steps of
(a) plotting a plurality of objects of the target microbe based on at least one cytometric parameter, preferably in two dimensions, preferably after log transformation, and
(b) evaluating whether at least two dense areas are discernible in a plot, and
(c) determining that a dense area is a subpopulation, in particular, if said dense area comprises between 5% and 95% of the total data (objects) in said plot.

In particular, subpopulations of a microbial species or strain may be identified by gating the data set in three dimensions, i.e. based on FSC-H, SSC-H and FITC-H. FITC refers to a fluorescent light channel which is used to detect Fluorescein isothiocyanate (FITC). In particular, upper and lower boundary values may be determined for each of three dimensions (channels), and a subpopulation be defined as a population of objects/cells which are within those boundaries. Thus, an object with a parameter value outside of the boundaries of said subpopulation may be disregarded or deleted from the data set or assigned to another subpopulation if it is within all the boundaries of said other subpopulation. Of note, the boundary values used for defining subpopulations in a plot or data set may not correspond to the boundary values which define the anchors (anchor values), as described herein in the context of the present invention. In particular, there are two anchors per parameter defining the parameter range, wherein there may be multiple boundaries per parameter defining multiple subpopulations. It is possible that a boundary of a subpopulation has the same value as an anchor. However, a subpopulation identified/defined in a data set of a pure microbial species or strain, i.e. defined by gating, has usually at least one different boundary value than the corresponding anchors, because otherwise the entire data set of said pure microbial species or strain may be considered as one population. Evidently, if a subpopulation is defined a priori as a subpopulation, as described herein, e.g. because it is obtained from a certain sample, e.g. a culture in a certain medium, said subpopulation may be considered as one population. However, further subpopulations within such an a priori defined subpopulation may be identified/gated as described herein.

Thus, in certain embodiments, subpopulations are gated, i.e. by gating a data set of a pure microbial species or strain or an a priori defined subpopulation of a microbial species or strain, preferably wherein the gating comprises determining an upper and lower boundary of at least one, at least two or at least three cytometric parameters, preferably wherein said cytometric parameters are selected from FSC, SSC and FITC, i.e. FSC-H, SSC-H and FITC-H.

In certain embodiments, the training data set comprises at least one gated subpopulation.

In certain embodiments, determining subpopulations of a target microbe comprises unsupervised clustering of the data of a plurality of objects comprising a plurality of cytometric parameters, e.g. by k-means.

Moreover, in the context of the invention, a subpopulation usually has a distinct label in the training data set and/or the classifier. Furthermore, said subpopulation may be considered as a target microbe, as described herein.

The artificial neural network used in the context of the present invention comprises, at least, an input layer receiving input from the input vector and/or corresponding to the input vector and an output layer, i.e. corresponding to the output classes, as described herein. In particular, the number of nodes of the input layer corresponds to the number of parameters in said input vector, and the number of nodes of the output layer corresponds to the number of classes (output classes/labels) of the classifier. Preferably, the artificial neural network is a feedforward neural network and/or comprises one or two hidden layers, preferably one hidden layer. Preferably, the nodes of the input layer are connected to the nodes of a hidden layer by the sigmoid function, and/or the nodes of a hidden layer are connected to the nodes of the output layer by the softmax transfer function. As described herein, the inventive method for generating a classifier provided herein may be considered supervised learning. Thus, analyzing said training data set with the artificial neural network comprises, in particular, supervised learning. Moreover, analyzing said training data set with the artificial neural network comprises preferably backpropagation.

A feedforward neural network is an artificial neural network wherein connections between the nodes do not form a cycle, and thus is, in particular, different from recurrent neural networks. In a feedforward neural network, the information moves in only one direction, forward, from the input nodes, through the hidden nodes (if any) and to the output nodes. In particular, there are no cycles or loops in the network.

Backpropagation (backprop) is a method to adjust the connection weights to compensate for each error found during learning. The error amount is effectively divided among the connections. Technically, backprop calculates the gradient (the derivative) of the cost function associated with a given state with respect to the weights. The weight updates can be done via stochastic gradient descent or other methods, such as, inter alia, Extreme Learning Machines, “No-prop” networks, training without backtracking, “weightless” networks, and non-connectionist neural networks (see e.g. Huang (2006), Neurocomputing. 70 (1): 489-501; Widrow (2013), Neural Networks. 37: 182-188; Ollivier (2015), arXiv:1507.07680; or Hinton (2010), Tech. Rep. UTML TR 2010-003).

Backpropagation is an algorithm that may be used, in particular, in training feedforward neural networks for supervised learning. Furthermore, in fitting a neural network, backpropagation computes the gradient of the loss function with respect to the weights of the network for a single input-output example efficiently. This efficiency makes it feasible to use gradient methods for training multilayer networks, updating weights to minimize loss, e.g. gradient descent, or variants such as stochastic gradient descent, may be used. In particular, the backpropagation algorithm works by computing the gradient of the loss function with respect to each weight by the chain rule, computing the gradient one layer at a time, and iterating backward from the last layer to avoid redundant calculations of intermediate terms in the chain rule.

In particular, the “sigmoid function” and the “softmax transfer function”, as used herein, refer to the respective functions as defined in Matlab v. 2017a.

In a particular embodiment, the artificial neural network architecture comprises a feedforward backpropagation algorithm with one input, one hidden and one output layer, wherein the input nodes are connected to the hidden layer by the sigmoid function (Matlab v. 2017a), and wherein the hidden layer nodes are connected to the output by the softmax transfer function. In particular, the artificial neural network may trained by applying the trainscg function to the input matrix (as defined in Matlab v. 2017a), e.g. 1000 cycles of training, validation and test, and the performance may be evaluated by crossentropy. The term “crossentropy” is well known in the fields of information theory and machine learning.

In certain embodiments, the method for generating a classifier according to the invention further comprises a step of validating the classifier comprising obtaining a validation data set comprising data of a plurality of different objects than the objects used for the training data set, wherein said plurality of objects is drawn from the same population of objects as the objects used for the training data set, and wherein the parameters and labels of said data correspond to the parameters and labels of said training data set. In particular, the validation data set may be used for tuning the parameters (e.g. weights) of the classifier.

In the context of the present invention, the classifier and/or the training data set may comprise data of at least 2, preferably at least 3, preferably at least 5, preferably at least 10, preferably at least 15, preferably at least 20, preferably at least 24, preferably at least 32, preferably at least 50 target microbes, i.e. microbial species or strains. Moreover, since a microbial species or strain may be split into two or multiple subpopulations, the classifier and/or training data set may comprise more output classes than microbial species or strains, in particular at least 2, preferably at least 3, preferably at least 5, preferably at least 10, preferably at least 15, preferably at least 20, preferably at least 24, preferably at least 32, preferably at least 50, preferably at least 58 output classes (labels). Thus, the classifier of the present invention may be used in a computer-implemented method for quantifying the abundance of at least one target microbe in a sample according to the invention, wherein the abundance of at least 2, preferably at least 3, preferably at least 5, preferably at least 10, preferably at least 15 target, preferably at least 20, preferably at least 24, preferably at least 32, preferably at least 50 microbes, i.e target microbes, or at least 2, preferably at least 3, preferably at least 5, preferably at least 10, preferably at least 15, preferably at least 20, preferably at least 24, preferably at least 32, preferably at least 50, preferably at least 58 target microbes, i.e. microbial species or strains or subpopulations thereof, in a sample is quantified.

Furthermore, the plurality of objects according to the invention may comprise cells of at least one further non-bacterial microorganism, e.g. a unicellular fungus as described herein, and/or particles of at least one certain type, wherein said type is a particle with a size between 0.1 μm and 10 μm, preferably wherein said type is a bead with a diameter between 0.1 μm and 10 μm, preferably wherein said bead has a diameter of 0.2 μm, 0.5 μm, 1 μm, 2 μm, 4 μm, 6 μm, 10 μm or 15 μm, and preferably wherein said beads may be used for calibrating flow cytometry instruments and/or flow cytometric data. Thus, the training data set of the invention may further comprise data of said at least one further non-bacterial microorganism and/or said particles of at least one certain type, and/or the classifier may further comprise at least one output class (label) corresponding to said at least one further non-bacterial microorganism and/or said particles of at least one certain type.

In one embodiment of the invention, the target microbe is selected from the group consisting of Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof, wherein said subpopulations may correspond, in particular, to the subpopulations described in the appended Examples herein.

As illustrated in the appended Examples with Pseudomonas azotoformans, further microbes may be added to the training data set and/or the classifier as target microbes, i.e. to reliably classify said target microbes in a sample.

In one embodiment of the invention, the at least one target microbe comprises a bacterium of the gut, preferably the human gut, preferably the colon, in particular a bacterium which may be found in said gut. For example, said at least one target microbe may comprise a common bacterium from the human gut microbiota, i.e. the colon microbiota, a pathogen of the gut such Clostridioides difficile, and/or a bacteria from the Enterobacteriaceae family such as, inter alia, Escherichia coli, Klebsiella sp. or Salmonella sp. In particular, the target microbe according to the invention may be selected from the group consisting of the following (i) and/or (ii): (i) Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof; (ii) Bacteroides fragilis, Bacteroides vulgatus, Bifidobacterium adolescentis, Clostridioides difficile, Enterococcus faecalis, Lactobacillus plantarum, Enterobacter cloacae, Escherichia coli, Helicobacter pylori, Salmonella enterica subsp. Enterica, Yersinia enterocolitica, Fusobacterium nucleatum, Bifidobacterium longum, and any subpopulation thereof; preferably at least Clostridioides difficile, Clostridium scindens, Escherichia coli, Klebsiella sp., and/or Salmonella sp., preferably at least Clostridioides difficile and/or Clostridium scindens; preferably at least Clostridioides difficile.

In a further embodiment, the target microbe(s) may be selected from the group consisting of: Fusobacterium nucleatum, Enterobacter cloacae, Bacteroides fragilis, Bacteroides vulgatus, Kocuria rhizophila, Paenibacillus polymyxa, Enterococcus faecalis, Clostridioides difficile, Clostridium scindens, and Bifidobacterium longum.

In a further embodiment, the target microbe(s) may be selected from the group consisting of Enterobacter cloacae, Stenotrophomonas rhizophila, Bacteroides fragilis, Fusobacterium nucleatum, Kocuria rhizophila, Paenibacillus polymyxa, Escherichia coli, Enterococcus faecalis, Bacteroides vulgatus, Clostridioides difficile, Clostridium scindens, and Bifidobacterium longum.

Furthermore, the classifier, the training data set, the plurality of objects and/or the at least one target microbe according to the invention may comprise an inventive set of standards provided herein.

In the context of the present invention, e.g. with respect to the method for quantifying the abundance of at least one target microbe in a sample, the method for classifying at least one target microbe in a sample and/or the method for analyzing the microbial composition in a sample, the sample is a sample from a multicellular organism as described herein, a body of water, food, a biotope, an agricultural field or a certain part thereof, a water system, and/or a place under hygienic control.

In particular, said sample according to the invention may comprise a plurality of different microbes, i.e. microbial community and/or microbiome, as described herein.

In a particular embodiment, said sample is a sample from a multicellular organism, preferably an animal, preferably a human. Preferably said sample from an animal or human is a stool sample, a vaginal smear or discharge, a blood sample, a lung sputum or a skin swab, preferably a stool sample or a vaginal smear, preferably a stool sample. In particular, the stool sample may comprise at least one a bacterium of the gut as provided herein.

In a particular embodiment, i.e. with respect to the method for quantifying the abundance of at least one target microbe in a sample, the abundance of at least Clostridioides difficile, Clostridium scindens, Escherichia coli, Klebsiella sp., and/or Salmonella sp., e.g. Salmonella enterica or Salmonella typhimurium, preferably Clostridioides difficile and/or Clostridium scindens, is quantified in a stool sample, preferably a stool sample from a human, preferably a human patient suffering from a microbial gut disease, as provided herein, and/or a human patient that is suspected from suffering from such a gut disease, e.g. Clostridioides difficile infection.

Furthermore, a stool sample may contain at least one, e.g. at least 2, 5, 10 or all, gut bacteria selected from the group consisting of: Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., Salmonella enterica, Salmonella typhimurium, Bacteroides fragilis, Bifidobacterium adolescentis, Enterococcus faecalis, Lactobacillus plantarum, Lactobacillus sp., Enterobacter cloacae, Escherichia coli, Helicobacter pylor, Yersinia enterocolitica, Fusobacterium nucleatum, Bifidobacterium longum, Akkermansia spp., and any subpopulation thereof.

Accordingly, the set of standards, kit, computer-readable storage medium, target microbes and/or classifier of the invention may comprise at least one, e.g. at least 2, 5, 10 or all, of said gut bacteria. Furthermore, the classifier of the invention may be used for detecting or quantifying the abundance of a pathogenic bacterium, e.g. Clostridioides difficile, in such a stool sample.

The vaginal microbiome is dominated by Lactobacillus. When the microbiome shifts towards strict anaerobic organisms such as Gardnerella vaginalis, a series of health issues appears such as preterm birth, pelvic inflammatory disease, and/or sexually transmitted infections.

Thus, in a further embodiment of the invention, i.e. with respect to the method for quantifying the abundance of at least one target microbe in a sample, the abundance of at least Gardnerella spp., preferably Gardnerella vaginalis, and/or Mobiluncus spp., is quantified in a vaginal smear or discharge, preferably a vaginal smear or discharge from a human, preferably a human patient suffering from vaginal dysbiosis or bacterial vaginitis, as provided herein, and/or a human patient that is suspected from suffering from vaginal dysbiosis or bacterial vaginitis.

Furthermore, a vaginal smear or discharge may contain at least one, e.g. at least 2 or all, vaginal bacteria selected from the group consisting of: Lactobacillus spp., Gardnerella spp., e.g. Gardnerella vaginalis, Atopobium vaginae, and Megasphaera, and any subpopulation thereof.

Accordingly, the set of standards, kit, computer-readable storage medium, target microbes and/or classifier of the invention may comprise at least one, e.g. at least 2, or all, of said vaginal bacteria. Furthermore, the classifier of the invention may be used for detecting or quantifying the abundance of a pathogenic bacterium, e.g. Gardnerella spp. such as Gardnerella vaginalis in such a vaginal smear or discharge.

Dysbiosis (also called dysbacteriosis) is characterized as a disruption to a microbiome, e.g. of the gut or vagina. For example, a human microbiome can become deranged, with normally dominating species underrepresented and normally outcompeted or contained species at increased numbers. Hence, the methods of the invention, i.e. the method for quantifying the abundance of at least one target microbe in a sample, are particularly suitable for detecting and/or diagnosing a dysbiosis, and/or determining the extent of a dysbiosis.

Accordingly, the methods and classifiers of the invention may be used for detecting, and/or diagnosing a dysbiosis and/or determining the extent of a dysbiosis, in particular a dysbiosis of the human gut or vagina. In particular, a dysbiosis of the human gut may be determined by quantifying the abundance of Clostridioides difficile and/or Clostridium scindens in a stool sample, and/or a dysbiosis of the human vagina may be determined by quantifying the abundance of Gardnerella spp. such as Gardnerella vaginalis and/or Lactobacillus spp. in a vaginal smear or discharge.

In one embodiment, the sample is from a body of water, preferably a body of freshwater such as a lake, a river or a pond, preferably a lake. In particular, the water sample may comprise a microbial community as described herein and illustrated in the appended Examples and is further suspected to comprise a gut bacterium and/or a coliform bacterium, as described herein, i.e. Escherichia coli. Thus, in a particular embodiment, i.e. with respect to the method for quantifying the abundance of at least one target microbe in a sample, the abundance of Escherichia coli and/or a subpopulation thereof is quantified in a freshwater sample as described herein.

Coliform bacteria are defined as Rod shaped Gram-negative non-spore forming and motile or non-motile bacteria which can ferment lactose with the production of acid and gas when incubated at 35-37° C. and/or contain the enzyme β-galactosidase. A particular example of a coliform bacterium is Escherichia coli. Coliform bacteria are a commonly used indicator of sanitary quality of foods and water. Coliforms can be found in the aquatic environment, in soil and on vegetation and they are universally present in large numbers in the feces of warm-blooded animals. While coliforms themselves do not cause serious illness in many (but not all) cases, their presence may further indicate the presence of other pathogenic organisms of fecal origin.

Thus, in one embodiment, the sample is a food sample. In particular, the food sample is suspected to comprise a gut bacterium and/or a coliform bacterium, as described herein, i.e. Escherichia coli. Thus, in a particular embodiment, i.e. with respect to the method for quantifying the abundance of at least one target microbe in a sample, the abundance of Escherichia coli and/or a subpopulation thereof is quantified in a food sample as described herein.

A body of water is, for example, inter alia, a lake, a river, an ocean or a pond, preferably a lake. Food is, for example, inter alia, an animal product such as meat, a dairy product or an egg product, a plant product such as a vegetable, a fruit, cereals or bread, a prepared dish from a restaurant, and/or a convenience food product such as a frozen ready-made dish, a ready-made salad or a muesli bar. A biotope or habitat is an area of uniform environmental conditions providing a living place for a specific assemblage of plants and animals, for example, inter alia, the shore of a body of water, a forest such as a rain forest or industrialized forest, a plantation, an agricultural field, grass land, a garden or an aquarium. An agricultural field is, for example, inter alia a field of vegetables, fruits, rice, potatoes, cereals or quinoa, a meadow, pasture or grazing land. A certain part of an agricultural field is, for example, inter alia, the soil or a body of water. A water system is, for example, inter alia, a water pipe, i.e. for drink water supply, or for wastewater, a canalization, a channel, or a drainage. A place under hygienic control is, for example, inter alia, a toilet, a water closet, a shower, a kitchen, a hospital, a surgery room, a surgery instrument, or a nursery home.

Thus, the present invention, i.e. the classifier of the invention, and/or the method for quantifying the abundance of at least one target microbe in a sample, the method for classifying at least one target microbe in a sample and/or the method for analyzing the microbial composition in a sample, may be used for analyzing microbial communities or microbiota in various fields, such as, inter alia, health, i.e diagnostics, hygiene, agriculture, farming, nature conservation, water purity, and water supply.

Moreover, the invention may be further used to analyze/classify a plurality of samples, e.g. for longitudinal and/or comparative studies, depending on how the different samples to be analyzed/classified are selected. For example, the plurality of samples to be analyzed/classified may have been sampled from a similar location or origin at different time-points (series of samples). In such a setup, the change of the abundance of said at least one target microbe may be determined over time in said location. The samples may be taken from a similar location, for example, at an interval of about one year, one month, one week, one day, one hour, one minute, 30 seconds, or 10 seconds, or the samples may be continuously taken and analyzed. Moreover, the method of the present invention may be used for analyzing one or more samples, e.g. a series of samples, in real-time or near real-time, and thus for quantifying the abundance of at least one target microbe in one or more samples, or analyzing the microbial composition in one or more samples in real-time or near-real time. For example, in flow cytometry, the duration of the analysis of one sample may be around 1.5 min (or, e.g., 30,000-50,000 events per second) which allows samples to be processed on a minute basis.

Furthermore, the plurality of samples to be analyzed/classified may have been sampled at different locations.

Thus, in certain embodiments, i.e in the context of the method for quantifying the abundance of at least one target microbe in a sample, the abundance of said at least one target microbe is determined in a series of samples, wherein said samples are at different time-points from a similar location/origin, thereby quantifying the change of the abundance of said at least one target microbe over time in said location.

As described herein, the classifier of the present invention and/or the method for quantifying the abundance of at least one target microbe in a sample may be further used for evaluating, identifying and/or detecting the presence of a target microbe in a sample from a subject, i.e. an animal or a human, preferably a human. As described herein, said target microbe may be a human or animal pathogen, i.e. a pathogenic bacterium. The presence of a pathogenic bacterium in a sample from a human subject, e.g. a stool sample, may indicate that said subject has a disease that is associated with and/or caused by said pathogenic bacterium. For example, a pathogenic bacterium may be present in the human gut and cause a gut disease. In particular, the classifier may be capable of distinguishing such a pathogenic microbe from other, e.g. related, non-pathogenic microbes. In particular, the pathogenic microbe may be distinguished from the other microbes present in the environment of said pathogenic microbe, i.e. in the same biological sample, with a high specificity and/or precision as described herein. In particular, if the pathogenic microbe (target microbe) is classified with a high specificity and/or precision, a sensitive and/or specific diagnostic test may be provided for diagnosing a disease that is associated with and/or caused by said pathogenic microbe.

Furthermore, as described herein, the classifier may be used for quantifying the abundance of a target microbe, i.e. a pathogen, in a sample. Thus, furthermore, a disease that is associated and/or caused with a certain amount and/or concentration of microbial cells in a sample from a human or an animal may be diagnosed.

Thus, the invention further relates to the use of the classifier of the present invention for diagnosing a microbial disease in a subject, e.g. as described herein in the context of the inventive method for diagnosing a microbial disease in a subject provided herein.

The term “microbial disease”, as used herein, refers to a disease that is associated with and/or caused by a microbe, i.e. by infection with a microbe. Preferably herein, the microbial disease is a bacterial disease. For example, a bacterial disease, i.e. a disease that is associated with and/or caused by a bacterium, may be Clostridioides difficile infection, a Salmonella infection, obesity, sepsis or diseases of the gut microbiome such as gut dysbiosis, or bacterial vaginitis or vaginal dysbiosis. For example, the microbial disease may be associated with and/or caused by infection and/or proliferation of a bacterium in the gut, such as, inter alia, Clostridioides difficile infection.

Therefore, the invention also relates to a method for diagnosing a microbial disease in a subject, wherein said method comprises the steps of
(a) quantifying the abundance and/or evaluating the presence of at least one target microbe in a sample as described herein in the context of the present invention, wherein said at least one target microbe is associated with and/or causes said disease, and
(b) indicating that said subject has said microbial disease if the abundance of said at least one target microbe in said sample is greater than expected and/or it is found that said at least one target microbe is present in the sample. The presence of a target microbe in a sample can be determined as described herein.

In particular, the method for diagnosing a microbial disease in a subject may further comprise a step (a′), wherein said step (a′) comprises comparing the abundance of said at least one target microbe in said sample to the expected abundance of said at least one target microbe in a respective sample of a subject who does not suffer from said microbial disease.

In the context of the diagnostic methods provided herein, the subject may be a human, an animal or a plant, preferably a human or an animal, preferably a human. The plant is preferably an agricultural plant such as inter alia a crop, vegetable and/or fruit tree. The animal is preferably a mammal and/or a domestic animal or a pet such as inter alia a cow, a horse, a sheep, a goat, a cat, a dog, a chicken, a duck or goose. The human is preferably a patient suffering from the disease to be diagnosed and/or suspected to suffer from the disease to be diagnosed.

In certain embodiments of the method for diagnosing a microbial disease in a subject, the abundance of at least one target microbe in a sample is quantified in step (a) according to the method for quantifying the abundance of at least one target microbe in a sample, wherein the abundance of said at least one target microbe is determined in a series of samples, and wherein said samples are at different time-points from a similar location/origin, the expected abundance step (a′) is the expected abundance at the respective time-points, and it is indicated in step (b) that the subject has the microbial disease if the abundance of said at least one target microbe in said location is greater than expected over time.

In the context of the method for diagnosing a microbial disease in a subject, the sample is preferably a sample from the subject for whom the microbial disease is diagnosed. In particular, the target microbe is a bacterial species or strain or a subpopulation thereof, as described herein.

In one embodiment of the inventive method for diagnosing a microbial disease in a subject provided herein, the microbial disease is Salmonella infection, and the at least one target microbe which is associated with and/or causes said disease, is Salmonella enterica and/or Salmonella typhimurium.

In a particular embodiment of the inventive method for diagnosing a microbial disease in a subject provided herein, the microbial disease is Clostridioides difficile infection, and the at least one target microbe which is associated with and/or causes said disease, is Clostridioides difficile. In particular, the classifier used in said diagnostic method comprises as output Clostridioides difficile, and has, i.e., been generated based on a training data set comprising data of Clostridioides difficile. Preferably, said training data set further comprises data of Clostridium scindens, and thus said classifier further comprises as output class (label) Clostridium scindens. Preferably, said classifier distinguishes Clostridioides difficile from Clostridium scindens with a high specificity and/or precision as described herein, and as illustrated in the appended Examples. Furthermore, the classifier may detect Clostridioides difficile with a high sensitivity, as described herein, and as illustrated in the appended Examples. Preferably, said classifier and/or diagnostic method is applied to a sample from a human subject suffering from Clostridioides difficile infection or a human subject being suspected of Clostridioides difficile infection, and/or a human subject having symptoms associated with Clostridioides difficile infection, such as diarrhea and/or fever. Preferably said sample is a stool sample.

Clostridioides difficile infection (CDI) or Clostridium difficile infection, is a symptomatic infection due to the spore-forming bacterium Clostridioides difficile. Symptoms include watery diarrhea, fever, nausea, and abdominal pain. CDI is particularly associated with antibiotic-associated diarrhea. Complications may include pseudomembranous colitis, toxic megacolon, perforation of the colon, and sepsis.

Clostridia are anaerobic motile bacteria, that are ubiquitous in nature, and especially prevalent in soil. Clostridia are long, irregular (often drumstick- or spindle-shaped) cells with a bulge at their terminal ends. When stressed, the bacteria may produce spores that are able to tolerate extreme conditions. Clostridioides difficile may become established in the human colon and may be present in 2-5% of the adult population. However, Clostridioides difficile is a poor competitor, and is often outcompeted for nutrients by other bacteria in the digestive system. As a result, the number of Clostridioides difficile cells may be kept low. However, upon an environmental change, i.e. upon the intake of antibiotics, the microbiome in the digestive system may be disrupted, and Clostridioides difficile may be able to grow because many of its competitors are eliminated.

An important niche competitor of Clostridioides difficile is Clostridium scindens. Clostridium scindens may become established in the human colon, and its presence is associated with resistance to Clostridioides difficile infection, i.e. due to production of secondary bile acids which inhibit the growth of Clostridioides difficile.

Thus, identifying and/or distinguishing Clostridioides difficile and Clostridium scindens may particularly useful for diagnosing Clostridioides difficile infection and/or indicating the susceptibility for Clostridioides difficile infection. In particular, the Clostridioides difficile and/or Clostridium scindens may be identified in a stool sample as described herein, i.e. with a classifier according to the invention comprising Clostridioides difficile and/or Clostridium scindens as output classes (labels). Furthermore, identifying and/or distinguishing Clostridioides difficile and Clostridium scindens may particularly useful for diagnosing a dysbiosis of the human gut.

As illustrated in the appended Examples, an inventive classifier provided herein can be used for identifying Clostridium scindens amidst a microbial community of soil bacteria. It is expected that the performance of the classifier for identifying Clostridium scindens can be further improved by using more cytometric parameters, and including data of the microbial cells from which Clostridium scindens is to be distinguished into the training data set. For example, when Clostridium scindens is to be traced in stool samples, the classifier is preferably trained with a training data set comprising multidimensional flow cytometry data of gut microbiota representatives such as Clostridioides difficile as well as Clostridium scindens itself.

Furthermore, as also illustrated in the appended Examples, an inventive classifier provided herein can be used, e.g., for identifying Clostridium scindens amidst a microbial community of soil bacteria (FIG. 12) and/or for identifying Clostridioides difficile amidst a microbial community of soil and human gut bacteria including Clostridium scindens (FIG. 13). It has been found that CellCognize with more than one cell marker can particularly well classify Clostridia species in in silico mixture up to 95% of correct prediction (compared to about 58-78% with E. coli species in FIG. 4d).

In particular, the inventive method for diagnosing a microbial disease in a subject is, in its essence, an in silico method, and thus may be considered a computer-implemented method as described herein. However, the diagnostic method of the invention may further comprise a step of obtaining a sample from a subject, i.e. a human subject, and then may be considered an in vitro method. Preferably, the sample is obtained in a non-invasive way from the subject, e.g. from the stool of the subject.

In one aspect, the invention relates to an inventive classifier according to the invention for use in a method for diagnosing a microbial disease in a subject, i.e. as described herein. In particular, said method may comprise a step of obtaining a sample from the body of the subject, wherein said subject is an animal or a human.

It has been further strikingly found by the inventors that the inventive classifiers provided herein can be further used for capturing the change of an unknown microbial community, e.g. in a lake water sample, upon induction of an environmental change (e.g. addition of a carbon source such as phenol or 1-octanol). Strikingly, the outgrowth of certain microbial species or strains was detected, which was, at least in some aspects, remarkably similar to the results obtained by 16S rRNA sequencing of the samples, as illustrated in the appended Examples. Moreover, some aspects of the diversity of the microbial composition in the differently treated samples, i.e. as determined by the Shannon index or the Bray-Curtis dissimilarity index, were similarly found by a method using the classifier of the present invention provided herein as with 16S rRNA sequencing, as illustrated in the appended Examples.

Thus, in a further aspect, the invention relates to a computer-implemented method for analyzing the microbial composition in a sample, wherein said method comprises
(a) obtaining a classifier according to the invention as provided herein,
(b) obtaining data of a plurality of objects from said sample, wherein said data comprises for each of said objects a vector comprising a plurality of cytometric parameters, and
(c) assigning the objects in the sample to the labels by applying said classifier to the sample data, thereby estimating the microbial composition in said sample.

As regards the classifier, the plurality of objects, the sample, the cytometric parameters, and assigning the objects in the sample to the labels in the context of the method for analyzing the microbial composition in a sample, in principle, the same applies as is described herein in the context of the inventive method for quantifying the abundance of at least one target microbe in a sample or the inventive method for classifying at least one target microbe in a sample provided herein, however, with the following exceptions:
in the context of the inventive method for analyzing the microbial composition in a sample, the classifier does not necessarily have to comprise any of the microbes present in the sample as output class (label/target microbe); the plurality of objects may be undefined; and the microbial composition may be entirely unknown and/or the microbial species comprised as labels in the classifier may be not and/or may be not suspected to be present in said sample.

As used herein, the term mg C I⁻refers to the unit of substrate concentration corrected for its carbon content. For example, phenol has 6 carbon atoms and a molar mass of 94.113 g*mol⁻¹. Thus, phenol has about 72 g carbon per mol. Thus, 10 mg C I⁻¹ phenol equals about 13.1 mg phenol. 1-octanol instead has 8 carbon atoms and a molar mass of 130.231 g*mol⁻¹. Thus, 1-octanol has about 96 g carbon per mol. Thus 10 mg C I⁻¹ equals about 13.6 mg 1-octanol.

Thus, in some embodiments of the method for analyzing the microbial composition in a sample, the classifier may not comprise all or any of the microbes in the sample as output class (label). In particular, none or not all of the microbial species comprised in the classifier (target microbes) may be suspected to be present in said sample.

In particular, if none or not all of the microbial species comprised in the classifier (target microbes) are suspected to be present in said sample, the microbial composition in said sample may be rather estimated than provided with certainty. This estimation is preferably based on a similarity index, as provided herein. In general, an estimate of the microbial composition in a sample may be valuable even if the true composition of the sample is not fully correctly depicted. For example, the microbial composition under certain environmental conditions in a certain location, e.g. scarcity of nutrients vs. a surplus of nutrients in a lake, may be captured by the classifier of the invention as signatures or fingerprints. In particular, such a signature or fingerprint refers to the proportions of microbes in a sample assigned to the different output classes of the classifier. Hence, even when it cannot be determined with certainty which microbes are present in the sample, the determined signature/fingerprint can be kept as reference and/or compared to another sample. Thus, this approach may be further useful for analyzing changes of the microbial composition at a certain location over time and/or compare microbial compositions at different locations, i.e. at different habitats or different human or animal subjects. Moreover, for example, microbial changes in a body tissue such as inter alia the gut, may be monitored over time, e.g. upon a therapeutic treatment such as inter alia administration of antibiotics, chemotherapy or radiotherapy.

In particular herein, i.e. in the context of the inventive method for analyzing the microbial composition in a sample, an object may be assigned to a certain label, if the probability that said object corresponds to said certain label is higher than the probability that the object corresponds to another particular label. Furthermore, the probability that said object corresponds to said certain label may be further above a predetermined threshold, as described herein. For example, if the probability of assignment is below said threshold, an extra output may be generated, e.g. such as inter alia “non-identifiable” or “n/a”.

In particular, the inventive method for analyzing the microbial composition in a sample may further comprise a step of counting for each label the number of objects which have been assigned to said label (output class of the used classifier), and optionally counting the objects which have not been assigned to any label, thereby estimating the microbial composition in the sample, i.e. the signature/fingerprint of said microbial composition/sample.

In the context of the present invention, an assignment (mapping) of an object in a sample, i.e. a microbial cell, is usually accompanied by a probability value of assignment. In particular, this probability value indicates how certain it is that an object corresponds to the output class of the classifier to which said object is assigned. Preferably, the classifier of the invention assigns an object to the output class for which the probability of assignment is the highest. This means that an assignment of the object to another output class would be less likely. Thus, when analyzing a data set comprising data of a plurality of objects, the classification of objects may be accompanied by a distribution of probability values of assignment, as illustrated in the appended Examples. Moreover, the average probability of assignment of objects in a data set/sample may be calculated and, in particular, used for calculating a measure of the average similarity of objects assigned to a certain output class (label) compared the average probability of assigned of known true objects to the correct output class (with the corresponding label). This measure is also called herein the similarity score or similarity index. In particular, the similarity score is the ratio of the average probability of assignment of objects in a sample to a certain output class (label) over the average probability of assignment of true (known) objects of the type corresponding to said output class. For example, the cells of a pure culture of a certain target microbe, e.g. subpopulation 1 of Pseudomonas veronii (PVR1) as illustrated in the appended Examples, may be assigned with a high average probability to the correct output class, e.g. p=0.81, whereas cells of a sample, e.g. a lake water sample, that are assigned to the same output class, e.g. the PVR1 class, are assigned to that class with a lower average probability of assignment, e.g. p=0.72. In this example, the similarity score for the PVR-1-like lake water cells compared to PVR1 would be 0.89 (0.72/0.81). For determining the similarity score, preferably the same classifier is used for the pure culture standard and the sample. Moreover, the similarity score may be used as a quality measure when determining the signature/fingerprint of a microbial composition in a sample. In particular, the quality of the signature/fingerprint is high when the similarity indices are high for many, most or all output classes of the used classifier. Moreover, output classes with a low similarity score may be ignored when determining the signature/fingerprint. For example, a similarity score below 0.9, 0.85, 0.8, 0.75, 0.7, 0.6, 0.5, 0.4, 0.3, 0.2, or 0.1 may be considered low, and a similarity score of at least 0.5, 0.6, 0.7, 0.75, 0.8, 0.85, 0.9, 0.95, or 0.99, preferably at least 0.95, may be considered high. If the similarity score is both considered low and high, or neither low nor high, according to this definition, the similarity score may be rather considered as intermediate. Preferably, the threshold values are chosen such that the similarity score is either considered low or high (but not both). Preferably, said similarity score is at most 1.

Thus, in certain embodiments, i.e. in the context of the method for analyzing the microbial composition in a sample, the inventive method provided herein further comprises a step of determining a similarity score, wherein said similarity score indicates the similarity between a certain label and the objects which have been assigned to said certain label, and wherein said similarity score is determined by comparing (i) the mean probability of an assignment of an object in said sample to said certain label, and (ii) the respective mean probability of an assignment of an object in a sample to said certain label, wherein the latter sample comprises true objects of said certain label, preferably essentially consists of true objects of said certain label. Evidently, a sample may be considered to essentially consist of a certain type of an object, even if there are other, i.e. rare, background objects or other compounds contained in the sample as far as there are essentially no other microbes or beads, as described herein, contained therein, e.g. in a pure culture of a certain microbial species or strain. In one embodiment, the similarity score is high, if said mean probabilities of (i) and (ii) have a ratio between 0.5 and 2, preferably between 0.7 and 1.4, preferably between 0.9 and 1.1 and/or the ratio of (i) over (ii) is at least 0.5, preferably 0.9, preferably 0.95.

Moreover, the inventive method for analyzing the microbial composition in a sample may be further used for analyzing the microbial composition in a series of samples, wherein said samples have been obtained at different time-points from a similar location/origin, thereby quantifying the change of the microbial composition over time in said location. Furthermore, the location/origin may have been modified between any of said time-points. In particular, said modification may comprise the addition and/or removal of a molecule or radiation to said location/origin, thereby analyzing the change of the microbial composition over time in response to the addition and/or removal of said molecule/radiation. Said molecule or radiation may be added or removed on purpose or it may happen as a result of environmental processes, for example, inter alia pollution of a lake or a water system, or the damaging of gut microbiota, e.g. by antibiotics, drug consumption or radiotherapy. As described herein, comparing signature or fingerprints of different samples may provide information about the occurrence of a certain modification, e.g. inter alia a surplus of nutrients in a lake, or side effects of a therapy with antibiotics.

In particular, the modification is suspected to alter the proliferation of at least one microbe comprised in said location/origin, or of at least one microbe which is suspected to be comprised in said location/origin.

In one embodiment, the inventive method for analyzing the microbial composition in a sample further comprises a step of comparing the determined change of the microbial composition over time with the respective change determined with an independent method, wherein said independent method allows identifying the microbial composition in a sample, and wherein a correlation of (i) the determined change of the abundance of a certain label and (ii) the change of a certain microbe determined with said independent method, indicates that said label is similar to said certain microbe.

In certain embodiments of the inventive method for analyzing the microbial composition in a sample, the microbial composition of the sample is determined. Said determination is preferably done when the target microbes comprised in the classifier and the microbes in the sample are at least partly, preferably, highly overlapping.

In certain embodiments of the inventive method for analyzing the microbial composition in a sample, the diversity of the microbial composition is determined, e.g. by the Shannon index and/or the Bray-Curtis dissimilarity index, as described herein.

Thus, the inventive method for analyzing the microbial composition in a sample may be further used for determining the diversity of the microbial composition in a series of samples, wherein said samples have been obtained at different time-points from a similar location/origin, as described herein, thereby determining the change of the diversity of the microbial composition overtime in said location. Moreover, the diversity of the microbial composition in different samples from different sites may be compared.

Shannon index is a diversity index, wherein the proportion of species relative to the total number of species is calculated, and then multiplied by the natural logarithm of this proportion. In particular, the Shannon index may be calculated as follows:

$${H}^{′} = - {\sum }_{i = 1}^{R} {p}_{i} ln {p}_{i}$$

where pᵢ is the proportion of objects belonging to the ᵢth output class.

The Bray-Curtis dissimilarity index is an index of dissimilarity between two sites i.e. i and j. the Bray-Curtis dissimilarity index is calculated as 1−[(2*the sum of only the lesser counts for each species found in both sites)/(the total number of specimens counted on site i+the total number of specimens counted on site j)]. It is bounded between 0 and 1.0 indicates the two samples have the same microbial composition whereas 1 suggests that the two samples do not share any microbial species or strains. The Bray-Curtis dissimilarity index may be visualized by a multidimensional scaling plot (MDS) which is, in particular, a way of visualizing the level of similarity of individual cases of a dataset.

Furthermore, it has been strikingly found by the inventors, as illustrated in the appended Examples, that the classifier of the invention, i.e. a method for analyzing the microbial composition in a sample employing said classifier, as provided herein, may be further used for determining the carbon biomass of a microbial composition. The differentiation of objects, i.e. microbial cells, in a sample may be particularly useful for estimating the biomass, i.e. the carbon biomass in a sample, if there are or could be objects of different shapes and sizes, and thus different biomasses, and/or cell clumps in the sample.

Thus, in certain embodiments, the inventive method for analyzing the microbial composition in a sample provided herein may further comprises a step of determining the carbon biomass of the microbial composition, wherein quantifying the carbon biomass comprises the steps of
(a) determining the average carbon masses of the labels comprised in the classifier, and
(b) multiplying the number of objects which have been assigned to a certain label with the average carbon mass of said certain label. In particular, the average carbon mass of an object may be determined based on the volume of said object. For example, the volume of an object according to the invention can be determined by microscopic imaging.

In particular, said method further comprises a step of summing up the determined carbon biomasses of all objects, thereby determining the total carbon microbial biomass in the sample.

Thus, the invention further relates to a method for determining the carbon biomass of a microbial composition in a sample, wherein said method comprises the steps of
(a) estimating the microbial composition in a sample according to the inventive method for analyzing the microbial composition in a sample provided herein by using a classifier of the invention,
(b) determining the average carbon masses of the labels comprised in the classifier,
(c) multiplying the number of objects which have been assigned to a certain label in the classifier with the average carbon mass of said certain label, and
(d) summing up the determined carbon biomasses of all objects, thereby determining the total carbon microbial biomass in the sample.

As described herein, the data used for training the classifier usually controls the output classes of the classifier and/or the performance of the classifier. The data in the training data set may correspond to the cytometric data of a set of standards. A standard, as used herein, refers, in particular, to a label, i.e. a certain type of objects or a microbial species or strain or a subpopulation thereof, as described herein, that is comprised in the training data set, and thus usually as output class in the classifier of the invention (e.g. a target microbe). As described herein, a microbial species or strain may be split into subpopulations by analyzing the population, i.e. a pure population of said microbial species or strain as described herein, e.g. by flow cytometry. In particular, a subpopulation of a microbial species or strain may be isolated and/or purified, and used as a reference standard for the generating of future training data sets and classifiers. A set of standards may be further selected based on several criteria: (a) the presence of related target microbes, i.e. closely related target microbes, as described herein; (b) the presence of target microbes with different morphologies; and/or (c) the presence of unrelated target microbes, as described herein. Moreover, an inventive set of standards provided herein preferably has a technical purpose, i.e. as part of the training data set and/or the classifier of the invention wherein it may control the performance of the classifier and contribute to the technical effects of the classifier; and/or for the preparation of cytometric data that may be used in a training data set and/or for generating a classifier of the invention. Thus, the set of standards provided herein may be comprised in the classifier of the present invention, a computer-readable storage medium, and/or in an inventive kit provided herein.

Thus, the invention further relates to a set of standards, wherein the set of standards corresponds to a set of standards comprised in the inventive classifiers, the inventive computer-readable storage medium, the inventive methods, and/or the inventive kits provided herein. Thus, the inventive set of standards provided herein may comprise at least one subgroup of target microbes, wherein a certain subgroup consists of
(a) at least 2, preferably at least 3, preferably at least 5, preferably at least 10, preferably at least 15, preferably at least 30, preferably at least 50 different related target microbes, wherein related target microbes are (i) microbial species or strains of the same family, subfamily, and/or genus, (ii) microbial strains of the same microbial species, and/or (iii) subpopulations of the same microbial species or strain;
(b) at least 2, preferably at least 3, preferably at least 5, preferably at least 10, preferably at least 15, preferably at least 30, preferably at least 50 different target microbes with a different morphology, wherein a cell of a certain one of said target microbes is characterized by its length, width, height, length/width ratio, longest axis, eccentricity, refraction index, area and/or volume; or
(c) at least 2, preferably at least 3, preferably at least 5, preferably at least 10, preferably at least 15, preferably at least 30, preferably at least 50 different, preferably at least 100, preferably at least 500 unrelated target microbes, wherein unrelated target microbes are microbial species or strains from different families, suborders, orders, subclasses and/or classes;
wherein a certain target microbe may be comprised in more than one of said subgroups.

In particular, the classifier of the invention may comprise said set of standards as labels/classes (output classes).

Furthermore, the invention relates to a classifier obtainable by the computer-implemented method for generating a classifier for at least one target microbe according to the invention. Said classifier may comprise a set of standards provided herein, i.e. as output classes (labels). Moreover, the training data set used for generating the inventive classifier provided herein may comprise a set of standards provided herein.

Thus, a classifier comprising a set of standards according to the invention is preferably obtainable by the computer-implemented method for generating a classifier for at least one target microbe according to the invention.

Furthermore, the invention relates to a kit comprising a set of standards according to the invention, in particular wherein said standards are pure microbial cultures or stocks thereof. The microscopic objects, i.e. the microbial cells comprised in a pure microbial culture consist essentially of microbial cells of the microbe for which the pure culture is prepared, i.e. as described herein. Microbial cells, i.e. bacteria, may be conserved, e.g. as frozen agar stocks, and/or fixed with a fixation solution, for example, formalin.

In one embodiment, the inventive set of standards provided herein comprises at least 1, preferably at least 2, preferably at least 3, preferably at least 5 microbes selected from the group consisting of Acinetobacter johnsonii, Escherichia coli, Pseudomonas veronii, and any subpopulation thereof. Preferably, Escherichia coli and/or Pseudomonas veronii are split into two subpopulations based on the analysis of the cytometric data, i.e. as illustrated in the appended Examples.

In one further embodiment, the inventive set of standards provided herein comprises at least 1, preferably at least 2, preferably at least 3, preferably at least 5, preferably at least 10, preferably at least 15, preferably at least 20, preferably at least 24 target microbes selected from the group consisting of Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof. Furthermore, said group or set of standards may further comprise Clostridium scindens, i.e. separated a priori into a subpopulation that is in the stationary phase and/or a subpopulation that is in the exponential phase, and/or Pseudomonas azotoformans.

In a particular embodiment, the set of standards comprises Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, and Sphingomonas yanoikuyae.

Furthermore, said set of standards may further comprise Clostridium scindens. Moreover, Clostridium scindens may be separated a priori into a subpopulation that is in the stationary phase and/or a subpopulation that is in the exponential phase.

Furthermore, said set of standards may further comprise Pseudomonas azotoformans. As illustrated in the appended Examples, Acinetobacter johnsonii, Acinetobacter tjernbergiae, Bacillus subtilis, Caulobacter crescentus, or Pseudomonas veronii may be preferably split into two subpopulations based on the analysis of the cytometric data. Moreover, Arthrobacter chlorophenolicus may be preferably split into three subpopulations based on the analysis of the cytometric data.

Furthermore, Escherichia coli may be separated a prior into different subpopulations. A priori subpopulations of Escherichia coli may be, as illustrated in the appended Examples, different strains, e.g. MG1655 or DH5α-λpir, cells grown in different media, e.g. Luria-Bertani Broth (LB) medium or M9-glucose, casamino acids (M9-CAA) medium, and/or cells in different growth phases, e.g. the exponential phase or the stationary phase. In one embodiment, the a priori selected subpopulations of Escherichia coli comprise MG1655 in the exponential phase in M9-CAA medium, MG1655 in the stationary phase in M9-CAA medium, MG1655 in the stationary phase in LB medium, and DH5α-λpir in the stationary phase in LB medium.

In a particular embodiment, the set of standards comprises Acinetobacter johnsonii, Acinetobacter tjernbergiae, Arthrobacter chlorophenolicus, Bacillus subtilis, Caulobacter crescentus, Cryptococcus albidus, Escherichia coli, Lactococcus lactis, Pseudomonas knackmussii, Pseudomonas migulae, Pseudomonas putida, Pseudomonas veronii, Sphingomonas wittichii, and Sphingomonas yanoikuyae, and beads with a diameter of 0.2 μm, 0.5 μm, 1 μm, 2 μm, 4 μm, 6 μm, 10 μm and 15 μm, wherein Acinetobacter johnsonii, Acinetobacter tjernbergiae, Bacillus subtilis, Caulobacter crescentus, or Pseudomonas veronii are split into two subpopulations, as described herein, Arthrobacter chlorophenolicus is split into three subpopulations, as described herein, and Escherichia coli is a priori separated into MG1655 in the exponential phase in M9-CAA medium, MG1655 in the stationary phase in M9-CAA medium, MG1655 in the stationary phase in LB medium, and DH5α-λpir in the stationary phase in LB medium, as described herein.

In one further embodiment, the inventive set of standards provided herein comprises at least 1, preferably at least 2, preferably at least 3, preferably at least 5, preferably at least 10, preferably at least 15, preferably at least 20, preferably at least 24, preferably at least 32, preferably at least 50 target microbes selected from the group consisting of the following (i) and/or (ii): (i) Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof; (ii) Bacteroides fragilis, Bacteroides vulgatus, Bifidobacterium adolescentis, Clostridioides difficile, Enterococcus faecalis, Lactobacillus plantarum, Enterobacter cloacae, Escherichia coli, Helicobacter pylori, Salmonella enterica subsp. Enterica, Yersinia enterocolitica, Fusobacterium nucleatum, Bifidobacterium longum, and any subpopulation thereof; preferably at least Clostridioides difficile, Clostridium scindens, Escherichia coli, Klebsiella sp., and/or Salmonella sp., preferably at least Clostridioides difficile and/or Clostridium scindens, preferably at least Clostridium scindens, even more preferably at least Clostridioides difficile. Any of said microbes may be split into subpopulations as described herein, e.g. Clostridium scindens may be separated a priori into a subpopulation that is in the stationary phase and/or a subpopulation that is in the exponential phase.

In one further embodiment, the inventive set of standards provided herein comprises at least 1, preferably at least 2, preferably at least 3, preferably at least 5, preferably at least 10, preferably at least 15, preferably at least 20, preferably at least 24, preferably at least 32, preferably at least 50 target microbes selected from the group consisting of Clostridium (e.g. Clostridium scindens and/or Clostridioides difficile Microbacterium (e.g. Microbacterium sp. PAMC 28756), Mucilaginibacter (e.g. Mucilaginibacter pineti), Curtobacterium (e.g. Curtobacterium pusillum), Variovorax (e.g. Variovorax paradoxus), Flavobacterium (e.g. Flavobacterium pectinovorum DSM 6368), Cellulomonas (e.g. Cellulomonas xylanilytica), Tardiphaga (e.g. Tardiphaga sp. vice352), Devosia (e.g. Devosia riboflavina), Mesorhizobium (e.g. Mesorhizobium amorphae CCNWGS0123), Burkholderia (e.g. Burkholderia sp. OLGA172), Pseudomonas 1 (e.g. Pseudomonas koreensis strain D26 or Pseudomonas fluorescens), Luteibacter (e.g. Luteibacter rhizovicinus DSM 16549 strain), Chitinophaga (e.g. Chitinophaga pinensis DSM 2588), Lysobacter (e.g. Lysobacter capsici strain KNU-14), Pseudomonas 2 (e.g. Pseudomonas sp. CFSAN084952), Rhodococcus (e.g. Rhodococcus fascians D188), Caulobacter (e.g. Caulobacter sp. Ji-3-8), Cohnella (e.g. Cohnella sp. HS21), Serratia (e.g. Rahnella sp. Y9602), Phenylobacterium (e.g. Phenylobacterium zucineum HLK1), Bradyrhizobium (e.g. Bradyrhizobium betae strain PL7HG1), and any subpopulation thereof, preferably at least Clostridium scindens.

In a further embodiment, the inventive set of standards provided herein comprises at least 1, preferably at least 2, preferably at least 3, preferably at least 5, preferably at least 10, preferably at least 15, preferably at least 20, preferably at least 24, preferably at least 32, preferably at least 50 target microbes selected from the group consisting of Stenotrophomonas rhizophila (e.g. DSMZ 14405), Escherichia coli (e.g. DSMZ 4230, MG1655, and/or ATTC 700926), Fusobacterium nucleatum (e.g. ATTC 25586), Enterobacter cloacae (e.g. ATTC 13047), Bacteroides fragilis (e.g. ATTC 25285), Bacteroides vulgatus (e.g. ATTC 8432), Kocuria rhizophila (e.g. DSMZ 348), Paenibacillus polymyxa (e.g. DSMZ 36), Enterococcus faecalis (e.g. ATTC 700802), Clostridioides difficile (e.g. ATTC 9689 and/or DH 196), Clostridium scindens (e.g., ATTC 35704), and Bifidobacterium longum (e.g. Inflora drug isolate), and any subpopulation thereof, preferably at least Clostridioides difficile.

The subpopulations may be defined by unsupervised clustering based on k-means algorithm, refer to different strains, and/or cells in a certain growth phase (e.g. stationary vs. exponential phase). A certain species or strain may be split, e.g., into two subpopulations by said unsupervised clustering, e.g. as illustrated in Table 6 herein.

In a particular embodiment, the set of standard comprises Enterobacter cloacae, Stenotrophomonas rhizophila, Bacteroides fragilis, Fusobacterium nucleatum, Kocuria rhizophila, Paenibacillus polymyxa, Escherichia coli DSMZ 4230, Escherichia coli MG1655, Escherichia coli ATTC 700926, Enterococcus faecalis, Bacteroides vulgatus, Clostridioides difficile ATTC 9689, Clostridioides difficile DH 196 in stationary phase, Clostridioides difficile DH 196 in exponential phase, Clostridium scindens, i.e. in stationary phase, and Bifidobacterium longum.

Furthermore, the inventive set of standards may further comprise at least 2, preferably at least 4, preferably at least 8, preferably at least 10, preferably at least 15, preferably at least 20, preferably at least 24 specific different types of particles. Preferably said particles are beads of a certain size. Preferably the size (e.g. length) of said particles or the diameter of said beads is 0.2 μm, 0.5 μm, 1 μm, 2 μm, 4 μm, 6 μm, 10 μm or 15 μm. Preferably, said beads may be used for calibrating a flow cytometry instrument and/or standardizing/normalizing flow cytometric data. In one embodiment, the different type of particles comprise beads with a diameter of 0.2 μm, 0.5 μm, 1 μm, 2 μm, 4 μm, 6 μm, 10 μm and 15 μm.

Furthermore, the inventive set of standards may comprise a list of target microbes provided herein.

In certain embodiments, the inventive set of standards comprises at least 50%, preferably at least 70%, preferably at least 90%, preferably all of the standards comprised in the set of standards are found in one certain natural sample. A natural sample, as used herein, refers, in particular to a sample from a multicellular organism, a body of water, a biotope, an agricultural field or a certain part thereof, a water system and/or a place under hygienic control, as described herein.

Furthermore, the inventive set of standards may comprise, i.e. in subgroup (a) as described herein, at least one pathogenic microbe and at least one non-pathogenic microbe as described herein, i.e. in the context of the diagnostic methods of the invention. In one embodiment, the non-pathogenic microbe is Clostridium scindens, and the pathogenic microbe is Clostridioides difficile.

In some embodiments, subgroups (b) and/or (c) of the set of standards described herein, do(es) not comprise any pathogenic microbe.

The invention also relates to a computer-readable storage medium containing data of a plurality of cells of a plurality of target microbes for generating a classifier for at least one target microbe, e.g. a training data set, wherein said data comprise for each cell of said target microbes (a) a label which identifies the type of the cell, and (b) an input vector which comprises a plurality of cytometric parameters of said cell, preferably wherein said parameters have been determined by flow cytometry. In particular said target microbes comprise at least 2, 10, 15 or 50 target microbes selected from a group consisting of at least one of the following (i) to (iv):
(i) Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof;
(ii) Stenotrophomonas rhizophila, Kocuria rhizophila, and Paenibacillus polymyxa, and any subpopulation thereof;
(iii) Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof, preferably at least Clostridioides difficile, Clostridium scindens, Escherichia coli, Klebsiella sp., and/or Salmonella sp., and any subpopulation thereof;
(iv) Bacteroides fragilis, Bacteroides vulgatus, Bifidobacterium adolescentis, Clostridioides difficile, Enterococcus faecalis, Lactobacillus plantarum, Enterobacter cloacae, Escherichia coli, Helicobacter pylori, Salmonella enterica subsp. Enterica, Yersinia enterocolitica, Fusobacterium nucleatum, Bifidobacterium longum, and any subpopulation thereof;
preferably at least Clostridioides difficile and/or Clostridium scindens, preferably Clostridioides difficile.

The training data set according to the invention may comprise data of each target microbe or type of particles comprised in the inventive set of standards provided herein. In particular, a classifier comprising option (a) of the set of standards as described herein may be used in a method for diagnosing a microbial disease in a subject according to the invention.

Furthermore, a classifier comprising options (b) and/or (c) of the set of standards as described herein may be used in a computer-implemented method for analyzing the microbial composition in a sample according to the invention.

In a further aspect, the invention relates to a computer-implemented method for predicting the future abundance of at least one target microbe in a sample, wherein the abundance of the target microbe is predicted to increase in the next hours, days or weeks, if the exponential phase subpopulation of said target microbe is abundant in said sample, in particular if said exponential phase subpopulation comprises at least 20%, preferably at least 50%, preferably at least 80% of the combined exponential and stationary phase subpopulations of said target microbe in said sample.

The method of the present invention employing a plurality of cytometric parameters may further comprise a step of determining with flow cytometry the values of said plurality of cytometric parameters, i.e. as described herein.

Therefore, the present invention relates further to a method comprising a computer-implemented method of the invention, wherein said method further comprises a step of determining with flow cytometry the values of the plurality of cytometric parameters, i.e. of the plurality of objects comprised in the training data set and/or a sample data set as described herein.

In particular, the objects may be stained with at least one dye before flow cytometry analysis. Preferably, said at least one dye comprises a fluorescent dye that is a fluorescent stain for DNA, membrane, dead cells, cell wall polysaccharide, or metabolism, as described herein. In particular, a DNA stain may be, for example, inter alia, a SYBR Green or a Hoechst stain such as Hoechst 33258 and Hoechst 33342, or SYTO stains such as SYTO 9, preferably SYBR Green I; a membrane stain may be, for example, Nile red, FM4-64 or DiOC2(3); a dead stain may be, for example, inter alia, propidium iodide (e.g. PI-red); the cell wall polysaccharide stain may be, for example, fluorescently labeled lectin (e.g. a lectin-FITC) such as inter alia WGA or ConA; and the metabolic stain may be, for example, inter alia, 5-cyano-2,3-ditolyl tetrazolium chloride (CTC), preferably in combination with propidium iodide.

In one embodiment, a flow cytometry analysis or measurement comprises the use of a flow cytometer with volumetric-based cell counting hardware. For example, a suitable flow cytometer may be, inter alia, a NovoCyte cytometer, in particular, wherein the sheath flow rate may be fixed at a value between 6 and 7 ml/min, preferably at 6.5 ml/min. To prevent loss of the sample (and thus data), the data acquisition rate preferably does not exceed 10000 events per second. Moreover, the sample concentration is preferably not more than 5*10⁶ cells per ml, preferably about 2*10⁶ cells per ml. Preferably, the sample flow rate is slow, e.g. about 5 to 20 μl/min, preferably 10 to 18 μl/min, preferably about 14 μl/min, i.e. when a core diameter of about 7.7 μm is used. Preferably, a core diameter of 4 to 10 μm, preferably 6 to 8 μm, preferably 7.7 μm is used. Of note, the sample is hydrodynamically focused by the sheath fluid to form a small stream inside the flow cell. The diameter of the focused sample stream (“core diameter”) is determined by the ratio between the sample flow rate and the sheath flow rate.

As described herein, the set of standards provided herein may be comprised in a kit, e.g. as cell stocks or fixed samples. Methods to cultivate the standards are known in the art and/or described in the appended Examples.

Thus, the invention further relates to a method for producing a kit of standards as provided herein, wherein said method comprises a step of isolating and/or cultivating each microbe comprised in said kit of standards. In particular, isolating comprises isolating a microbe from a sample, preferably thereby enriching and/or purifying the microbe. The isolation, enrichment and/or purification may be achieved, e.g. by a limiting dilution assay, wherein individual microbial clones grow separately from each other, e.g. on an agar plate; and/or by sorting subpopulations of microbial species or strains as described herein, e.g. by FACS. In certain embodiments, a clonal population of a microbe is obtained.

Moreover, a microbe, e.g. a clone, may be cultivated by growing the microbe in a liquid medium until the stationary phase.

Furthermore, the inventive method for producing a kit of standards provided herein, may further comprise a step of staining each microbe comprised in the set of standards with at least one dye, preferably wherein said at least one dye comprises a fluorescent dye that is a fluorescent stain for DNA, membrane, dead cells, cell wall polysaccharide, or metabolism, as described herein.

In one embodiment, each microbe standard is fixed, e.g. by a solution comprising formaldehyde such as formalin.

Accordingly, the invention further relates to the following items:
1. A computer-implemented method for generating a classifier for at least one target microbe, wherein said target microbe is a microbial species or strain or a subpopulation thereof, and wherein said method comprises the steps of
(a) obtaining a training data set, wherein said training data set comprises data of a plurality of objects, wherein said plurality of objects comprises cells of said at least one target microbe, and wherein said data comprises for each of said objects
   (i) a label which identifies the type of the object, and
   (ii) an input vector which comprises a plurality of cytometric parameters of said object,
(b) analyzing said training data set with a supervised machine learning algorithm, e.g., including an artificial neural network, and
(c) obtaining said classifier as output from said supervised machine learning algorithm.
2. A computer-implemented method for quantifying the abundance of at least one target microbe in a sample, wherein said target microbe is a microbial species or strain or a subpopulation thereof, and wherein said method comprises the steps of
(a) obtaining a classifier according to item 1,
(b) obtaining data of a plurality of objects from said sample, wherein said data comprises for each of said objects a vector comprising a plurality of cytometric parameters, and
(c) determining the number of objects in the sample that correspond to a certain target microbe (label) by applying said classifier to the sample data.
3. A computer-implemented method for quantifying the abundance of at least one target microbe in a sample, wherein said target microbe is a microbial species or strain or a subpopulation thereof, and wherein said method comprises the steps of
(a) obtaining a training data set, wherein said training data set comprises data of a plurality of objects wherein said plurality of objects comprises cells of said at least one target microbe, and wherein said data comprises for each of said objects
   (i) a label which identifies the type of the object, and
   (ii) an input vector which comprises a plurality of cytometric parameters of said object,
(b) analyzing said training data set with a supervised machine learning algorithm, e.g., an artificial neural network,
(c) obtaining a classifier as output from said supervised machine learning algorithm, e.g., said artificial neural network,
(d) obtaining data of a plurality of objects from said sample, wherein said data comprises for each of said objects a vector comprising a plurality of cytometric parameters, and
(e) determining the number of objects in the sample that correspond to a certain target microbe (label) by applying said classifier to the sample data.
4. The method of any one of the preceding items, wherein the target microbe is a prokaryote.
5. The method of any one of the preceding items, wherein the target microbe is a bacterium.
6. The method of any one of items 2 to 5, wherein determining the number of objects in the sample that correspond to a certain target microbe (label) comprises the steps of
(a) using the classifier for determining for each of the objects in the sample the probability that the object corresponds to a certain target microbe (label),
(b) determining that the object corresponds to said certain target microbe, if said probability is above a predetermined threshold and/or, the probability that said object corresponds to any particular one of the other label(s) comprised in the classifier is lower than the probability that said object corresponds to said certain target microbe (label), and
(c) counting the objects which have been determined to correspond to said certain target microbe, thereby determining the abundance of said certain target microbe in said sample.
7. The method of any one of the preceding items, wherein the classifier is capable of distinguishing at least two related target microbes.
8. The method of item 6, wherein the plurality of objects comprised in the training data set that is used for obtaining the classifier comprises cells of said at least two related target microbes.
9. The method of any one of items 2 to 8, wherein the sample comprises a plurality of different microbes, in particular a microbiome or microbial community.
10. The method of item 9, wherein the sample comprises at least two related target microbes.
11. The method of item 10, wherein the abundance of at least one of the at least two related target microbes in said sample is determined.
12. The method of any one items 7 to 11, wherein the at least two related target microbes are (i) at least two related microbial species, (ii) at least two microbial strains of the same species, and/or (iii) at least two subpopulations of the same microbial species or strain.
13. The method of item 12, wherein in option (i) the two related microbial species are microbial species or strains of the same family, preferably subfamily, preferably genus and/or in option (iii) one of the two subpopulations is in the exponential phase, and the other one is in the stationary phase.
14. The method of any one of items 1 to 12, wherein the subpopulation of a certain microbial species or strain is a physiologically distinct subpopulation.
15. The method of item 14, wherein the physiologically distinct subpopulation has a distinct growth rate.
16. The method of items 14 or 15, wherein the physiologically distinct subpopulation is in the exponential phase or the stationary phase.
17. The method of any one of the preceding items, wherein the classifier is capable of distinguishing at least two subpopulations of the same microbial species or strain, wherein one of said at least two subpopulations is in the exponential phase, and another one is in the stationary phase.
18. The method of any one of the preceding items, wherein the values of the cytometric parameters of an object have been determined by flow cytometry.
19. The method of any one of the preceding items, wherein the plurality of parameters of the object comprises at least one, preferably at least 2, preferably at least 4, preferably at least 6 parameters selected from the group consisting of FSC-A, FSC-H, SSC-A, SSC-H, Width and the fluorescence intensity in at least one flow cytometry channel, preferably wherein the fluorescence intensity is from a fluorescent stain for DNA, membrane, dead cells, cell wall polysaccharide, and/or metabolism, preferably wherein the DNA stain is SYBR Green, the membrane stain is Nile red, FM4-64 or DiOC2(3), the dead stain is propidium iodide, the cell wall polysaccharide stain is lectin, and the metabolic stain is 5-cyano-2,3-ditolyl tetrazolium chloride (CTC), preferably in combination with propidium iodide.
20. The method of any one of any one of the preceding items, wherein the plurality of parameters of the object consists of at least 2, preferably at least 4, preferably at least 7 or 11 parameters and/or at most 200, preferably at most 100, preferably at most 50, preferably at most 20, preferably at most 10, preferably at most 7 or 11 parameters.
21. The method of any one of items 2 to 20, wherein the cytometric parameters of the objects from the sample are the same parameters as the parameters that are used for the classifier.
22. The method of any one of items 2 to 21, wherein the values of the parameters of the objects from the sample are determined the same way as the values that are used for the classifier.
23. The method of any one of the preceding items, wherein the data are pre-processed, wherein the pre-processing comprises selecting and/or scaling the data of at least one cytometric parameter between a minimum and a maximum value.
24. The method of item 23, wherein the pre-processing of the data of a cytometric parameter comprises the steps of
(a) determining a lower and an upper boundary of said cytometric parameter,
(b) adding the lower and upper boundaries of said cytometric parameter as two data points to the data of said cytometric parameter, and
(c) assigning to the lower boundary a minimum value and assigning to the upper boundary a maximum value, thereby scaling the data.
25. The method of items 23 or 24, wherein the difference of the minimum value to the mean of the minimum and maximum values has the same absolute value as the difference of the maximum value to said mean.
26. The method of any one of items 23 to 25, wherein the minimum and maximum values are −1 and 1, respectively.
27. The method of any one of items 23 to 26, wherein the data of the at least one cytometric parameter is log transformed before the scaling.
28. The method of any one of items 23 to 27, wherein selecting and/or scaling the data comprises (a) determining a lower and an upper boundary of at least one cytometric parameter and (a′) removing the data of the objects whereof any of the cytometric parameters is outside of the determined boundaries.
29. The method of any one of the preceding items, further comprising a step of determining subpopulations of a target microbe, wherein said determination comprises the steps of
(a) plotting a plurality of objects of said target microbe based on at least one cytometric parameter, preferably in two dimensions, preferably after log transformation, and
(b) evaluating whether at least two dense areas are discernible in a plot, and
(c) determining that a dense area is a subpopulation, in particular, if said dense area comprises between 5% and 95% of the total data in said plot, or wherein said determination of subpopulations comprises unsupervised clustering, e.g. by k-means, of the plurality of objects of said target microbe based on cytometric parameters.
30. The method of item 29, wherein the subpopulations are gated, preferably wherein the gating comprises determining an upper and lower boundary of at least one, at least two or at least three cytometric parameters.
31. The method of item 30, wherein the training data set comprises at least one gated subpopulation.
32. The method of any one of items 29 to 31, wherein a subpopulation has a distinct label in the training data set and/or the classifier, and may be a target microbe.
33. The method of any one of the preceding items, wherein the artificial neural network comprises an input layer receiving input from the input vector and an output layer, preferably wherein the number of nodes of the input layer corresponds to the number of parameters in said input vector, and wherein the number of nodes of the output layer corresponds to the number of classes (labels) of the classifier.
34. The method of any one of the preceding items, wherein the artificial neural network is a feedforward neural network.
35. The method of any one of the preceding items, wherein the artificial neural network comprises one or two hidden layers, preferably one hidden layer.
36. The method of any one of items 33 to 35, wherein the nodes of the input layer are connected to the nodes of a hidden layer by the sigmoid function, and/or the nodes of a hidden layer are connected to the nodes of the output layer by the softmax transfer function.
37. The method of any one of the preceding items, wherein analyzing said training data set with the artificial neural network comprises supervised learning.
38. The method of any one of the preceding items, wherein analyzing said training data set with the artificial neural network comprises backpropagation.
39. The method of any one of the preceding items, further comprising the steps of validating the classifier comprising obtaining a validation data set comprising data of a plurality of different objects than the objects used for the training data set, wherein said plurality of objects is drawn from the same population of objects as the objects used for the training data set, and wherein the parameters and labels of said data correspond to the parameters and labels of said training data set.
40. The method of any one of the preceding items, wherein the training data set comprises data of at least 2, preferably at least 3, preferably at least 5, preferably at least 10, preferably at least 15, preferably at least 20, preferably at least 24, preferably at least 32, preferably at least 50 target microbes.
41. The method of any one of the preceding items, wherein the classifier comprises at least 2, preferably at least 3, preferably at least 5, preferably at least 10, preferably at least 15, preferably at least 20, preferably at least 24, preferably at least 32, preferably at least 50, preferably at least 58 output classes (labels).
42. The computer-implemented method for quantifying the abundance of at least one target microbe in a sample according to item 39, wherein the abundance of at least 2, preferably at least 3, preferably at least 5, preferably at least 10, preferably at least 15 target, preferably at least 20, preferably at least 24, preferably at least 32, preferably at least 50 microbes in a sample is quantified.
43. The method of any one of the preceding items, wherein the plurality of objects comprises cells of at least one further non-bacterial microorganism and/or particles of at least one certain type, wherein said type is a particle with a size between 0.1 μm and 10 μm, preferably wherein said type is a bead with a diameter between 0.1 μm and 10 μm, preferably wherein said bead has a diameter of 0.2 μm, 0.5 μm, 1 μm, 2 μm, 4 μm, 6 μm, 10 μm or 15 μm.
44. The method of any one of the preceding items, wherein the at least one target microbe is selected from the group consisting of Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof.
45. The method of any one of the preceding items, wherein the at least one target microbe is a bacterium of the gut, preferably the human gut, preferably the colon.
46. The method of any one of the preceding items, wherein the at least one target microbe is selected from the group consisting of Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof, preferably at least Clostridioides difficile, Clostridium scindens, Escherichia coli, Klebsiella sp., and/or Salmonella sp., preferably at least Clostridioides difficile and/or Clostridium scindens.
47. The method of any one of items 2 to 46, wherein the sample comprises a microbiome or microbial community.
48. The method of any one of items 1 to 47, wherein the sample is from a body of water, food, a biotope, an agricultural field, a water system and/or a place under hygienic control.
49. The method of any one of items 1 to 48, wherein the sample is from a multicellular organism, preferably an animal, preferably a human.
50. The method of item 49, wherein the sample is a stool sample, a blood sample, a lung sputum or a skin swab, preferably a stool sample.
51. The computer-implemented method for quantifying the abundance of at least one target microbe in a sample according to the method of any one of items 2 to 50, wherein the abundance of said at least one target microbe is determined in a series of samples, wherein said samples are at different time-points from a similar location/origin, thereby quantifying the change of the abundance of said at least one target microbe over time in said location.
52. A method for diagnosing a microbial disease in a subject, wherein said method comprises the steps of
(a) quantifying the abundance of at least one target microbe in a sample according to the method of any one of items 2 to 51, wherein said at least one target microbe is associated with and/or causes said disease,
(b) comparing the abundance of said at least one target microbe in said sample to the expected abundance of said at least one target microbe in a respective sample of a subject who does not suffer from said microbial disease, and
(c) indicating that said subject has said microbial disease if the abundance of said at least one target microbe in said sample is greater than expected.
53. The method of item 52, wherein in step (a) the abundance of at least one target microbe in a sample is quantified according to the method of item 51, wherein in step (b) the expected abundance is the expected abundance at the respective time-points, and wherein in step (c) said indication is made if the abundance of said at least one target microbe in said location is greater than expected over time.
54. The method of items 52 or 53, wherein the sample is a sample from the subject for whom the microbial disease is diagnosed.
55. The method of any one of items 52 to 54, wherein the target microbe is a bacterial species or strain or a subpopulation thereof.
56. The method of any one of items 52 to 55, wherein the microbial disease is Clostridioides difficile infection, and the at least one target microbe which is associated with and/or causes said disease, is Clostridioides difficile.
57. The method of any one of items 52 to 56 which is an in silico method, and optionally in addition an in vitro method.
58. The classifier obtainable by any of the methods of items 1 to 28 for use in a method for diagnosing a microbial disease in a subject according to any one of items 52 to 57, wherein the sample is obtained from the body of the subject, and wherein said subject is an animal or a human.
59. A computer-implemented method for analyzing the microbial composition in a sample, wherein said method comprises
(a) obtaining a classifier according to any of the preceding items,
(b) obtaining data of a plurality of objects from said sample, wherein said data comprises for each of said objects a vector comprising a plurality of cytometric parameters, and
(c) assigning the objects in the sample to the labels by applying said classifier to the sample data, thereby estimating the microbial composition in said sample.
60. The method of item 59, wherein an object is assigned to a certain label, if the probability that said object corresponds to said certain label is higher than the probability that the object corresponds to another particular label, optionally wherein the probability that said object corresponds to said certain label is further above a predetermined threshold.
61. The method of item 60 further comprising a step of counting for each label the number of objects which have been assigned to said label, and optionally counting the objects which have not been assigned to any label, thereby estimating the microbial composition in the sample.
62. The method of any of items 59 to 61, wherein the classifier comprises at least 2, preferably at least 3, preferably at least 5, preferably at least 10, preferably at least 15, preferably at least 20, preferably at least 24, preferably at least 32, preferably at least 50, preferably at least 58 output classes (labels).
63. The method of any of items 59 to 62, wherein the classifier may not comprise all or any of the microbes in the sample as output class, in particular wherein none or not all of the microbial species comprised in the classifier is/are suspected to be present in said sample.
64. The method of any of items 59 to 63 further comprising a step of determining a similarity score, wherein said similarity score indicates the similarity between a certain label and the objects which have been assigned to said certain label, and wherein said similarity score is determined by comparing (i) the mean probability of an assignment of an object in said sample to said certain label, and (ii) the respective mean probability of an assignment of an object in a sample to said certain label, wherein the latter sample comprises true objects of said certain label, preferably exclusively true objects of said certain label.
65. The method of item 64, wherein the similarity score is high, if the mean probabilities of (i) and (ii) have a ratio between 0.5 and 2, preferably between 0.7 and 1.4, preferably between 0.9 and 1.1.
66. The method of any of items 59 to 65, wherein the microbial composition is analyzed in a series of samples, wherein said samples have been obtained at different time-points from a similar location/origin, thereby quantifying the change of the microbial composition over time in said location.
67. The method of item 66, wherein the location/origin has been modified between any of said time-points, and wherein said modification comprises the addition and/or removal of a molecule or radiation to said location/origin, thereby analyzing the change of the microbial composition over time in response to the addition and/or removal of said molecule/radiation.
68. The method of item 67, wherein said modification is suspected to alter the proliferation of at least one microbe comprised in said location/origin, or of at least one microbe which is suspected to be comprised in said location/origin.
69. The method of items 67 or 68, comprising a step of comparing the determined change of the microbial composition over time with the respective change determined with an independent method, wherein said independent method allows identifying the microbial composition in a sample, and wherein a correlation of (i) the determined change of the abundance of a certain label and (ii) the change of a certain microbe determined with said independent method, indicates that said label is similar to said certain microbe.
70. The method of any one of items 59 to 69, wherein the microbial composition of the sample is determined.
71. The method of any one of items 59 to 70, wherein the diversity of the microbial composition is determined.
72. The method of any one of items 59 to 70, wherein said method further comprises a step of determining the carbon biomass of the microbial composition, wherein quantifying the carbon biomass comprises the steps of
(a) determining the average carbon masses of the labels comprised in the classifier, and
(b) multiplying the number of objects which have been assigned to a certain label with the average carbon mass of said certain label.
73. The method of item 72, wherein the average carbon mass of an object is determined based on the volume of said object, preferably wherein said volume has been determined by microscopic imaging of said object.
74. The method of items 72 or 73, further comprising a step of summing up the determined carbon biomasses of all objects, thereby determining the total carbon microbial biomass in the sample.
75. The method of any one of the preceding items, wherein the classifier comprises a set of standards (labels/output classes), wherein said set of standards comprises at least one subgroup of target microbes, wherein a certain subgroup consists of
(a) at least 2, preferably at least 3, preferably at least 5, preferably at least 10, preferably at least 15, preferably at least 30, preferably at least 50 different related target microbes, wherein related target microbes are (i) microbial species or strains of the same family, subfamily, and/or genus, (ii) microbial strains of the same microbial species, and/or (iii) subpopulations of the same microbial species or strain,
(b) at least 2, preferably at least 3, preferably at least 5, preferably at least 10, preferably at least 15, preferably at least 30, preferably at least 50 different target microbes with a different morphology, wherein a cell of a certain one of said target microbes is characterized by its length, width, height, length/width ratio, longest axis, eccentricity, refraction index, area and/or volume, or
(c) at least 2, preferably at least 3, preferably at least 5, preferably at least 10, preferably at least 15, preferably at least 30, preferably at least 50 different, preferably at least 100, preferably at least 500 unrelated target microbes, wherein unrelated target microbes are microbial species or strains from different families, suborders, orders, subclasses and/or classes,
wherein a certain target microbe may be comprised in more than one of said subgroups.
76. A classifier obtainable by the computer-implemented method for generating a classifier for at least one target microbe according to any one of the preceding items.
77. A classifier comprising the set of standards according to item 75, in particular wherein said classifier is obtainable by the computer-implemented method for generating a classifier for at least one target microbe according to any one of the preceding items.
77. A kit comprising the set of standards according to item 75, in particular wherein said standards are pure microbial cultures or stocks thereof.
78. The method of item 75, the classifier of item 76 or the kit of item 77, wherein the set of standards comprises at least 1, preferably at least 2, preferably at least 3, preferably at least 5, preferably at least 10, preferably at least 15, preferably at least 20, preferably at least 24 target microbes selected from the group consisting of Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof.
79. The method of item 75, the classifier of item 76 or the kit of item 77, wherein the set of standards comprises at least 1, preferably at least 2, preferably at least 3, preferably at least 5, preferably at least 10, preferably at least 15, preferably at least 20, preferably at least 24, preferably at least 32, preferably at least 50 target microbes selected from the group consisting of Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof, preferably at least Clostridioides difficile, Clostridium scindens, Escherichia coli, Klebsiella sp., and/or Salmonella sp., preferably at least Clostridioides difficile and/or Clostridium scindens, preferably Clostridium scindens.
80. The method of any one of items 75, 78 or 79, the classifier of any one of items item 76, 78 or 78, or the kit of any one of items 77 to 79, wherein the set of standards further comprises at least 2, preferably at least 4, preferably at least 8, preferably at least 10, preferably at least 15, preferably at least 20, preferably at least 24 specific different types of particles, preferably beads, of a certain size, wherein said size, preferably diameter, is 0.2 μm, 0.5 μm, 1 μm, 2 μm, 4 μm, 6 μm, 10 μm or 15 μm.
81. The method of any one of items 75, or 78 to 80, the classifier of any one of items item 76 or 78 to 80, or the kit of any one of items 77 to 80, wherein at least 50%, preferably at least 70%, preferably at least 90%, preferably all of the standards comprised in the set of standards are found in one certain natural sample.
82. The method of any one of items 75, or 78 to 81, the classifier of any one of items item 76 or 78 to 81, or the kit of any one of items 77 to 81, wherein subgroup (a) of the set of standards comprises at least one pathogenic microbe and at least one non-pathogenic microbe.
83. The method, classifier or kit of item 82, wherein the non-pathogenic microbe is Clostridium scindens, and the pathogenic microbe is Clostridioides difficile.
84. The method of any one of items 75, or 78 to 83, the classifier of any one of items item 76 or 78 to 83, or the kit of any one of items 77 to 83, wherein subgroups (b) and/or (c) of the set of standards do(es) not comprise any pathogenic microbe.
85. The method of any one of items 75, or 78 to 83, wherein the training data set comprises data of each target microbe or type of particles comprised in the set of standards.
86. The method for diagnosing a microbial disease in a subject according to any one of items 52 to 57, wherein classifier comprises option (a) of the set of standards according to any of items 75, or 78 to 85.
87. The computer-implemented method for analyzing the microbial composition in a sample according to any one of items 59 to 73, wherein classifier comprises options (b) and/or (c) of the set of standards according to any of items 75, or 78 to 85
88. A computer-implemented method for predicting the future abundance of at least one target microbe in a sample, wherein the abundance of the target microbe is predicted to increase in the next hours, days or weeks, if the exponential phase subpopulation of said target microbe is abundant in said sample, in particular if said exponential phase subpopulation comprises at least 20%, preferably at least 50%, preferably at least 80% of the combined exponential and stationary phase subpopulations of said target microbe in said sample.
89. A method comprising the computer-implemented method of any one of the preceding items, wherein said method further comprises a step of determining with flow cytometry the values of the plurality of cytometric parameters.
90. The method of item 89, wherein the objects are stained with at least one dye before flow cytometry analysis, preferably wherein said at least one dye comprises a fluorescent dye that is a fluorescent stain for DNA, membrane, dead cells, cell wall polysaccharide, or metabolism.
91. The method of items 89 or 90, wherein the flow cytometry comprises a flow cytometer with volumetric-based cell counting hardware, preferably a NovoCyte cytometer, preferably wherein the sheath flow rate is fixed at a value between 6 and 7 ml/min, preferably at 6.5 ml/min.
92. A method for producing a kit of standards according to any one of items 77 to 84, wherein said method comprises a step of isolating and/or cultivating each microbe comprised in said kit of standards, wherein isolating comprises isolating a microbe from a sample, preferably thereby enriching and/or purifying the microbe, preferably thereby obtaining a clonal population of the microbe.
93. The method of item 92, wherein cultivating a microbe comprises growing the microbe in a liquid medium until stationary phase.
94. The method of items 92 or 93, wherein the method further comprises a step of staining each microbe comprised in said set of standards with at least one dye, preferably wherein said at least one dye comprises a fluorescent dye that is a fluorescent stain for DNA, membrane, dead cells, cell wall polysaccharide, or metabolism.
95. The method of any one of items 92 to 94, wherein each microbe standard is fixed.
96. The computer-implemented method of any one of the preceding items, wherein the training data set, the supervised machine learning algorithm, e.g. the artificial network, and/or the classifier is saved on a computer-readable storage medium.
97. A data processing device comprising means for carrying out the computer-implemented method of any one of the preceding items.
98. A computer program comprising instructions which, when the program is executed by a computer, cause the computer to carry out the computer-implemented method of any one of the preceding items.
99. A computer-readable storage medium comprising instructions which, when executed by a computer, cause the computer to carry out the computer-implemented method of any one of the preceding items.

The invention is also characterized by the following figures, figure legends and the following non-limiting examples.

### BRIEF DESCRIPTION OF THE DRAWINGS

FIG. 1. CeliCognize: A flow cytometry (FCM)—supervised artificial neural network (ANN) pipeline for classification of microbial cell diversity and physiology. (a) and (b): Representative stained cell and bead standards with known volume and mass are analyzed by FCM to capture multidimensional optical and shape characteristics. Note that FITC here represents the channel to capture the SYBRGreen I fluorescence of cell staining. (c) Multiparametric data of each of the strain and bead standards, separated where they consist of recognizable subpopulations, are used as input for training, validating and testing the ANN, thereby producing the classifiers. (d) and (e): FCM data from stained known target strains or unknown microbial communities are assigned to the strain and bead output classes using the ANN classifiers. (f) The diversity attribution can subsequently be used to estimate individual population densities and their biomass, and, i.e., in the case of unknown communities, to calculate similarities to the used standards.

FIG. 2. Planar representation of a 1 μm-stack of holographic imaging of strain standards used in the FCM-ANN pipeline. Scale bar is 20 μm. “White” cell outlines result from the recognized cell shape boundaries in the holographic imaging software.

FIG. 3. Illustration of strain standard gating. (A) Raw FCM data of the FSC-height, SSC-height and FITC-height channels for standard PVR (Pseudomonas veronii stained with SybrGreen I), subsampled to 20,000 events for ease of plotting. Note the two visible subpopulations in the histograms of each channel. (B) Subpopulations are separated by imposing respective minima and maxima values on each of the log-scales and anchored by the anchor values (see Data preprocessing). (C) The resulting two subpopulations PVR1 and PVR2 were included as separate standards for generating the ANN classifiers.

FIG. 4. CellCognize performance and analysis of microbiota with known members.
a) Classification of a three-membered bacterial community composed of Acinetobacter johnsonii (AJH), Escherichia coli MG1655 (ECL), and Pseudomonas veronii (PVR), using a five-class ANN classifier. Bars show the means of CellCognize-inferred strain abundance for in vitro grown pure cultures and mixtures compared to their true abundance (T), with classification (C). The predicted classification rate (ratio of C:T) indicated as percentage values (top). b) Principal component analysis of multiparametric variation among the 24 defined cell and 8 bead standards (7 FCM parameters; 20,000 events for each). (c) Confusion matrix for the 32-standard ANN classifiers showing predicted (rows) and true (columns) class. The grey-level shows the proportion of objects assigned to an output class (TP+FP; “row”) belonging to a certain class, according to the scale bar on the right. Numerical averages across all five independent ANN runs are reported in Table 1, and details of the classes are shown in FIG. 5b. d) Correct predicted classification of pure E. coli MG1655 or DH5α-λpir cultures grown to exponential (EXPO) or stationary phase (STAT) in M9-CAA (MM) medium or in Luria broth (LB), individually (left, n=20,000 cells) or as an in silico mixture (right, n=5000 cells each, randomly subsampled). Bar plots show the mean class attribution±one SD and together with the percentage of correct predicted classification of E. coli from five independent ANN-32 classifiers. Figure d) plus shows the same data of pure cultures but assignments for all output classes. References in the text to FIG. 4d also refer to FIG. 4d plus.
e) Predicted classification (absolute cell counts±one SD) from the five 32-standard ANN classifiers for cells from a Lake Geneva microbial community (top bars, n=5039) or for the same community in silico mixed with n=5000 cells each of the standards AJH1, MG_STAT_MM and PVR1 (bottom bars). Correct predicted classifications were calculated as the mean percentage of the 5000 cells of each standard attributed to its own class. f) Predicted classification (mean of absolute cell counts±one SD, five 32-standard ANN classifiers) of FCM data of in vivo filtered (0.2-40 μm) Lake Geneva microbiota mixed with 1.0×10⁴ or 1.0×10⁵ cells ml⁻¹ of E. coli strain MG1655 grown on LB or M9-CAA medium (MM) to stationary phase. Each figure shows data from three independent biological replicates, each measured in two technical replicates. Correct predicted classification rates were calculated as the mean number (±one SD) of the added cells assigned to the four E. coli classes as a percentage of the expected added number. Individual calculations underlying the Figures are detailed out in Example 9 (Supplementary Methods).

FIG. 5. Confusion matrix plots of five- and 32-standard ANNs. A) ANN classifier with five classes covering the five subpopulations from the three strains, A. johnsonii (AJH), E. coli MG1655 (ECL1 and ECL2), and P. veronii (PVR1 and PVR2). The confusion matrix shows absolute numbers of events assigned to each of the classes for a dataset consisting of n=5000 randomly subsampled FCM data for each of the standards. The rows correspond to the predicted class (Output Class) and the columns correspond to the true class (Target Class). The diagonal cells correspond to observations that are correctly classified. The off-diagonal cells correspond to incorrectly classified observations. Both the number of observations and the percentage of the total number of observations are shown in each cell. The column on the far right of the plot shows the percentages of all the examples predicted to belong to each class that are correctly and incorrectly classified. These metrics are called the precision (or positive predictive value) and false discovery rate, respectively. The row at the bottom of the plot shows the percentages of all the examples belonging to each class that are correctly and incorrectly classified. These metrics are called the recall (or true positive rate) and false negative rate, respectively. The cell in the bottom right of the plot shows the overall accuracy. B) Confusion matrix and ROC plot for one of the 32-standard ANN classifiers showing performance of the classifier (i.e. the proportion of objects assigned to an output class (TP+FP; “row”) belonging to a certain class as grey-level, according to the scale bar on the right) for the predicted (rows) versus the true classes (columns) for a dataset consisting of n=5000 randomly subsampled and merged FCM data for each of the 32 standards. Abbreviations for the standards are given in Table 1. Numerical averages across all five independent ANN runs are reported in Table 1, Table 3 and shown in FIG. 4c. Receiver Operating Characteristics (ROC) curves show the predicted false positive rate at expected true positive rate for each strain or bead standard (different lines), with three labeled curves for standards that have the highest false positive rates at 80% true positives. Note that ROC curves toward the upper left corner indicate higher probability for true positive classification at low expected false positive rate. The grey diagonal line represents random classification for any single class. C) Confusion plot showing the average performance of the five 32-standard ANN classifiers for each of the standards (n=5000 cells) in silico mixed within a background of the freshwater microbial community (n=5038 cells). Correct predicted classifications were calculated as the mean percentage of each standard attributed to its own class after subtracting the background lake water cells: (Absolute cell counts of class attribution−absolute cell counts of freshwater assigned to that class)/added cells (n=5000).

FIG. 6. Predicted classification of strain standard data added in silico to a Lake Geneva microbiota background. Panels show the collective (top) and individual percentage of predicted classification of 5000 randomly subsampled FCM data from the strain standards, in silico combined with 5036 events from FCM analysis of lake water microbiota. Note that in all cases the majority of events are attributed to the true class of the standard, but also that some standards are better differentiated than others.

FIG. 7. Diversity analysis of an unknown microbial community using CellCognize. a) Inferred mean class cell densities from the five 32-standard classifiers (absolute counts, ABS.) of a size-filtered (0.2-40 μm), resuspended Lake Geneva water microbial community over the course of three days amended with 0.1, 1 or 10 mg C I⁻¹ phenol or 1-octanol, compared to a zero added carbon control. Bars show individual biological replicates with data merged from two technical replicates. b) Proportional cell counts (REL.) for the phenol-amended communities shown in a. c) Comparison of community diversity inferred using CellCognize and taxonomic diversity estimated from 16S rRNA gene amplicon data (shown as proportions of 20,000 normalized cleaned sequence reads, grey scale as shown in a)) for communities amended with 10 mg C I⁻¹ phenol or 1-octanol for each individual replicates. d) Diversity measures of communities shown in c): richness (16S: class level, CellCognize: assigned classes >0.05%) initially (TO) and after three days incubation (T3), Shannon index and Multidimensional scaling plot (MDS) based on calculated Bray-Curtis similarities. Alpha- and beta-diversity measures were calculated in R using the phyloseq package in R. Symbols represent individual replicate diversities, circumscribed by ellipses to indicate similar treatments.

FIG. 8. CellCognize diversity inferred from the ANN-32 classifiers on four independent repetitions of lake water communities enriched with 10 mg C I⁻¹ phenol. Shown is a stackplot of the normalized attributed relative class abundances (according to legend), at time 0 and after 3 days.

FIG. 9. Similarity measures of cells attributed to CellCognize classes. a) Class attribution (absolute cell counts) from a single 32-standard ANN classifier for in vivo filtered (0.2-40 μm) n=5036 cells from a Lake Geneva microbial community (black bars), with their corresponding mean probability of assignment (light grey bars, LW attributed). In background (dark grey bars), mean probabilities of assignment (±one SD) of each of the standards within an in silico mixture of all FCM standard datasets (subsampled to n=5000 cells each, five 32-standard ANN classifiers). Black bars at the bottom show the absolute number of LW cells assigned to the classes. b) Distributions of classification probabilities for four classes that were attributed in high numbers within the lake water community in the classifier results of panel a (i.e., B02, ACH2, CCR1 and PVR1) for each standard individually, for lake water (LW), or, in one case, of LW in silico mixed with n=5000 cells of the PVR1 standard classified with ANN-32 classifier. Values within panels indicate the mean probability of the shown distribution, and correspond to the value plotted in panel a). c) Mean class attribution (absolute cell numbers) of the lake water enriched community on 1-octanol (n=536,783 cells), and of the pure culture isolate (OCT, n=63,824 cells) derived from this enrichment grown on 1-octanol, both after three days of incubation, for one of the ANN-32 classifiers and for a new classifier that was trained using a dataset that in addition included FCM data from the OCT isolate itself (ANN-33). Numbers on the bars indicate the mean probability of class attribution. The calculations underlying the Figures are detailed out in Example 9 (Supplementary Methods).

FIG. 10. Subpopulation growth of Lake Geneva freshwater communities upon substrate amendment. Panels show total community size and the abundance of class subpopulations over time on phenol and 1-octanol at three different substrate concentrations, compared to a no-added carbon control (no C), as indicated. Error bars indicate the calculated standard deviation from the mean in biological triplicates. Subpopulations (means from biological triplicates) were defined from class assignment with the ANN-32 standard classifier, according to the color legend below the panels.

FIG. 11. Mass balance recovery from ¹⁴C-labeled substrate experiments. Bars show the mean radioactivity measured after 3 d incubation in two series of phenol and one series of 1-octanol incubations with the Lake Geneva microbiota or abiotic controls without cells (mean±one SD from biological triplicate experiments). The ¹⁴C-substrate was dosed at 4000 (phenol) or 1200 dpm ml⁻¹ (1-octanol) amidst 10 mg non-labeled carbon of the same. White bars, radioactivity measured in solution at time 0; moderate dark grey bars, radioactivity recovered on 0.22-μm filters and assumed to be the microbial biomass; dark grey bars, radioactivity recovered in the sodium hydroxide solution after purging at day 3, assumed to consist of dissolved ¹⁴C—CO₂; light grey bars, radioactivity recovered in the filtrate, assumed to consist of remaining non-consumed substrate and dissolved excreted cell material or metabolites. Percentages indicate the mean recovery in the three fractions compared to the original dosed ¹⁴C.

FIG. 12. Correct predicted classification of C. scindens. Pure C. scindens cultures (˜10⁷ cells ml⁻¹) grown to exponential (CSCIN_EXPO) or stationary phase (CSCIN_STAT) in Brain Heart Infusion Salts Solution (BHIS-S broth), individually (first two figures, on top). Bar plots show the class attribution together with the percentage of correct predicted classification from an ANN-34 classifier. Predicted classification of FCM data of in vitro mixed soil microbiota (˜10⁶ cells ml⁻¹) (third figure from the top) or its mixture with ˜10⁷ cells ml⁻¹ of C. scindens strain at stationary phase (CSCIN_STAT) (bottom). Percentage of correct predicted classification of C. scindens strain at stationary phase (CSCIN_STAT) within a diverse soil microbiota background was calculated as the absolute number of cells assigned to CSCIN_STAT class divided by the expected added number in the mixture. The enlarged lower panel including all output class labels is shown in FIG. 12 plus. References in the text to FIG. 12 also refer to FIG. 12 plus.

FIG. 13. CellCognize performance and analysis of microbiota with known members, i.e. Clostridia species. Correct prediction classification of in silico mixed Clostridia species grown to exponential (exp) or stationary phase (Stat) individually and randomly subsampled and in silico mixed (top, n_{individual}=50,000 cells per strain; n_{in sitico mixture}=200,000 cells) and the in silico mixed sample assigned to all output classes. Correct predicted classifications (shown as % on top of the bars in the bar plot) were calculated as the percentage of each strain attributed to its own class. Bar plots (bottom) show distribution of the probability of class attribution for each cells for the target classes.

FIG. 14. CellCognize analysis of gut microbiota composition of a human stool sample and predicted classification of Clostridioides difficile data added in silico (at different growing phases) to the gut microbiota background of the stool sample. a) Predicted classification (proportion in class (%)=assigned cell numbers in the target class/total number of cells) from the 29-standard ANN classifiers for cells from a stool sample representing healthy gut microbiota (FIG. 14a; n=500,000 cells). b) The same microbial community shown in a) in silico mixed with n=50,000 cells each of the target microbes CD-exp and CD-stat (Clostridioides difficile at exponential and stationary phases, respectively). It can be seen that the proportions of cells attributed to CD-exp and CD-stat considerably increased upon addition of CD-exp and CD-stat data, whereas the proportions of cells attributed to other classes slightly decreased (e.g. CS-stat) reflecting the proportional decrease of the background microbes upon addition of CD-exp and CD-stat. This further shows that CD-exp and CD-stat were correctly attributed to their own classes and not to others such as C. scindens (CS-stat). Correct predicted classifications (shown on top of CD-exp and CD-stat) were calculated as the percentage of the 50,000 cells of each standard attributed to its own class, and were 95% for each of CD-exp and CD-stat.

### EXAMPLES

Methods and materials are described herein for use in the present disclosure, other, suitable methods and materials known in the art can also be used. The materials, methods, and examples are illustrative only and not intended to be limiting.

The following Examples illustrate, in particular, that CellCognize based classifiers allow rapidly recognizing and quantifying known microbial cell types, and their physiology and growth (target microbes), amidst a known or unknown community background, and inferring community diversity changes in unknown microbial communities. CellCognize can be tuned to target microbes by including strain standards derived from the target itself, or can be used as a general diversity method based on similarity scoring derived from assignment probabilities to a more general set of standards. The low-cost, rapidity and ease of FCM quantitative single-cell analysis and fast downstream classification of cell populations makes this a powerful tool for analyzing microbiota samples in a wide variety of areas including clinical settings.

Detailed scripts for the CellCognize pipeline for some experiments and Figures are provided in Example 9 (Supplementary Methods). Script and data are accessible from a single online accession at Zenodo.org (DOI: 10.5281/zenodo.3822094).

### Example 1. Development of an Artificial Neural Network Pipeline Categorizing Microbial Cell Types from Multiparametric Flow Cytometry (FCM) Data

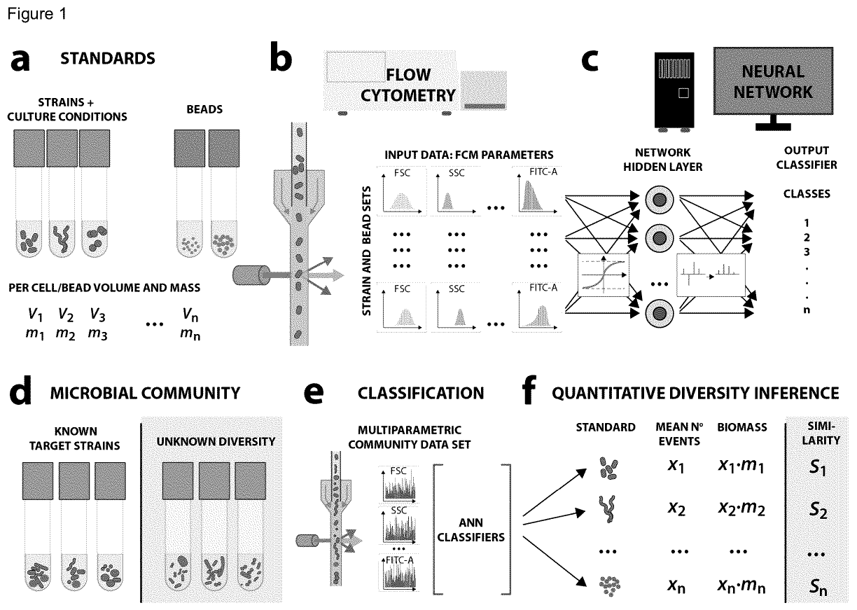

A pipeline (CellCognize) was developed using a supervised artificial neural network (ANN), which classifies cell types in microbial community samples based on FCM multiparametric signature similarities with a predefined set of standards (FIG. 1). FCM signatures of the standards are first captured individually (FIG. 1a, b), then combined in silico to build the training, validation and test sets, which the network learns to differentiate in a feed-forward back-propagation algorithm (FIG. 1c). The outcome of the trained, validated and tested ANN model is a set of classifiers. These can then be used to assign each cell within community samples (FIG. 1d) on the basis of its FCM signature into its most similar standard class (FIG. 1e) and to calculate relative abundances or biomass of that standard in the community (FIG. 1f). Class assignments come with a corresponding probability score, which may be interpreted as a measure of similarity to the standard classes.

### Preparation of Standard Samples

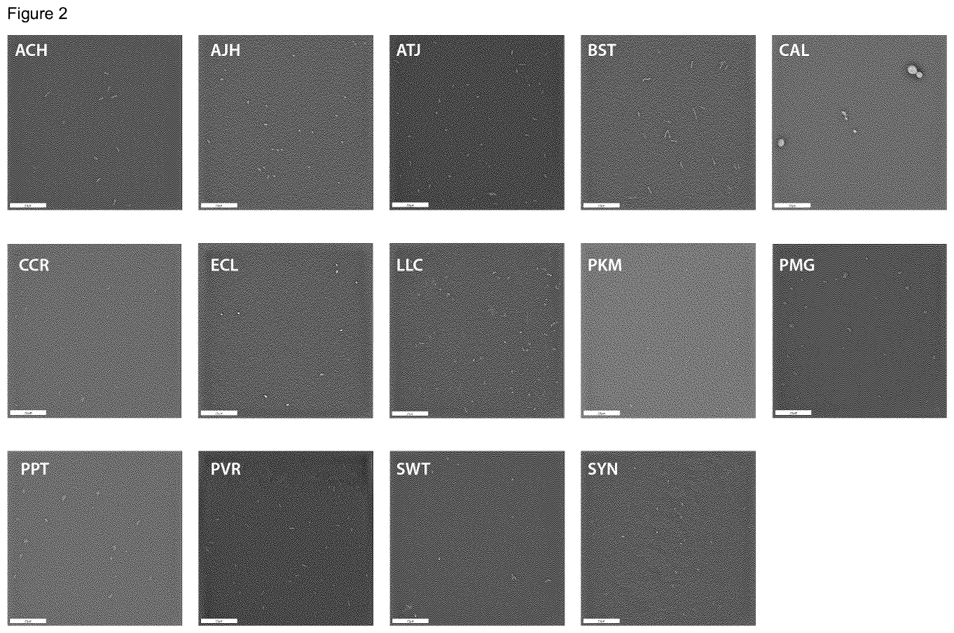

The 14 bacterial and one yeast species obtained from pure cultures and 8 differently sized beads listed in Table 1 were used for preparing the standards (see item “Data preprocessing”) for building ANN classifiers (see “Artificial neural network reconstruction”). Some microbial strains were split up into subpopulations as described in item “Data preprocessing”, and for E. coli, different samples from exponential growth (OD₆₀₀=0.5) or from stationary phase (OD₆₀₀=2) on two different culture media were included (Table 1). The choice of standards was motivated by (i) a priori cell type and size (e.g., rod, coccus) or bead size differences (FIG. 2), (ii) the potential presence of similar strains in the target freshwater microbial community, and (iii) the inclusion of multiple representatives from the same genus (e.g., Pseudomonas, Sphingomonas) or species (e.g., E. coli MG1655 and DH5α-λpir).

TABLE 1
Standards for building ANN classifiers

| | | | Percentage (Mean ± st dev)^{a} | | |
|---|---|---|---|---|---|
| Standard | | | | | Assigned |
| Abbreviation | Full name | Remark | Recall | Precision | in LW^{b} |
| B02 | Beads 0.2 μm | | 98.3 ± 0.1 | 99.0 ± 0.1 | 98.5 ± 0.5 |
| B05 | Beads 0.5 μm | | 99.4 ± 0.1 | 98.7 ± 0.1 | 99.3 ± 0.5 |
| B1 | Beads 1 μm | | 99.8 ± 0.1 | 99.6 ± 0.1 | 99.8 ± 0.3 |
| B10 | Beads 10 μm | | 98.8 ± 0.3 | 99.8 ± 0.1 | 99.1 ± 0.3 |
| B15 | Beads 15 μm | | 99.8 ± 0.0 | 98.9 ± 0.3 | 99.7 ± 0.2 |
| B2 | Beads 2 μm | | 99.4 ± 0.2 | 99.6 ± 0.2 | 99.3 ± 0.3 |
| B4 | Beads 4 μm | | 96.3 ± 0.3 | 97.8 ± 0.5 | 96.3 ± 0.5 |
| B6 | Beads 6 μm | | 98.1 ± 0.4 | 96.5 ± 0.3 | 97.6 ± 0.6 |
| AJH1 | Acinetobacter johnsonii | subpop 1 | 88.7 ± 0.6 | 79.2 ± 0.5 | 88.5 ± 1.7 |
| AJH2 | | subpop 2 | 90.9 ± 1.0 | 77.9 ± 0.8 | 90.7 ± 2.0 |
| ATJ1 | Acinetobacter | subpop 1 | 56.2 ± 2.1 | 47.0 ± 1.0 | 57.9 ± 0.9 |
| | tjernbergiae | | | | |
| ATJ2 | | subpop 2 | 58.8 ± 3.8 | 59.5 ± 2.7 | 59.1 ± 0.5 |
| ACH1 | Arthrob. | subpop 1 | 72.7 ± 1.1 | 56.8 ± 0.8 | 74.8 ± 0.7 |
| | chlorophenolicus | | | | |
| ACH2 | | subpop 2 | 63.4 ± 1.3 | 66.1 ± 1.9 | 63.5 ± 2.4 |
| ACH3 | | subpop 3 | 78.2 ± 0.9 | 70.6 ± 2.4 | 74.1 ± 3.2 |
| BST1 | Bacillus subtilis | subpop 1 | 97.8 ± 0.3 | 95.7 ± 4.3 | 92.9 ± 0.2 |
| BST2 | | subpop 2 | 80.8 ± 0.9 | 76.6 ± 1.1 | 81.2 ± 1.4 |
| CCR1 | Caulobacter crescentus | subpop 1 | 54.0 ± 2.0 | 62.0 ± 1.9 | 53.2 ± 0.1 |
| CCR2 | | subpop 2 | 79.5 ± 1.9 | 83.1 ± 1.2 | 78.3 ± 4.7 |
| CAL | Cryptococcus albidus | | 99.9 ± 0.0 | 99.8 ± 0.1 | 99.8 ± 2.0 |
| ECL_EXP3 | Escherichia coli | exponential | 88.2 ± 0.6 | 87.5 ± 1.1 | 87.8 ± 0.5 |
| | MG1655 | phase M9- | | | |
| | | CAA | | | |
| ECL_STAT_LB | | stationary | 89.3 ± 1.0 | 90.0 ± 0.7 | 88.7 ± 1.3 |
| | | phase LB | | | |
| ECL_STAT_MM | | stat phase | 97.4 ± 0.8 | 96.7 ± 0.8 | 97.7 ± 1.8 |
| | | M9-CAA | | | |
| ECL | Escherichia coli DH5α- | stationary | 73.0 ± 0.9 | 83.5 ± 1.1 | 72.6 ± 0.6 |
| | λpir | phase LB | | | |
| LLC | Lactococcus lactis | | 34.0 ± 3.3 | 49.9 ± 3.0 | 34.8 ± 1.8 |
| PKM1 | Pseudomonas | | 94.0 ± 0.8 | 87.7 ± 0.7 | 93.6 ± 1.1 |
| | knackmussii | | | | |
| PMG | Pseudomonas migulae | | 32.9 ± 2.8 | 39.5 ± 3.9 | 32.6 ± 3.1 |
| PPT | Pseudomonas putida | | 27.3 ± 4.0 | 38.2 ± 3.4 | 27.5 ± 3.5 |
| PVR1 | Pseudomonas veronii | subpop 1 | 73.9 ± 0.7 | 77.2 ± 1.9 | 74.3 ± 4.9 |
| PVR2 | | subpop 2 | 96.7 ± 0.7 | 96.7 ± 0.7 | 96.8 ± 0.7 |
| SWT | Sphingomonas wittichii | | 44.1 ± 1.5 | 52.7 ± 3.4 | 44.4 ± 1.5 |
| SYN | Sphingomonas | | 66.6 ± 1.2 | 55.6 ± 1.0 | 65.0 ± 2.2 |
| | yanoikuyae | | | | |

^{a}Calculated from five independently built ANN classifiers.
^{b}Mean percentage ± one SD of each individual standard (n = 5000 subsampled cells) in silico mixed to a background of a lake water microbial community (n = 5039), attributed to its own class.

Strains were grown aseptically and individually in liquid medium until stationary phase at the indicated conditions (Table 2). Culture samples were diluted in phosphate-buffered saline (PBS) to 10⁵ or 10⁶ cell ml⁻¹ and stained in 200 μl aliquots with 2 μl of diluted SYBR Green I solution (1:100 in dimethylsulfoxide; Molecular Probes) in the dark for 15-30 min at 20° C. for FCM analysis. Bead standards consisted of polystyrene size calibration beads with diameters of 0.2, 0.5, 1, 2, 4, 6, 10 and 15 μm (Invitrogen), provided in solutions with concentrations of 1×10⁶ (0.2 and 0.5 μm), 6×10⁷ (1 μm), 3×10⁷ (2 and 4 μm) and 2×10⁷ (6, 10 and 15 μm) beads ml⁻¹. Beads were stored and prepared for FCM analysis according to the manufacturer's guidelines (Invitrogen).

TABLE 2
Growth conditions of standard strains culture

| | | | Solid | | |
|---|---|---|---|---|---|
| | Strain | | culture | Liquid culture | |
| Strain | number | Abbreviation | medium | medium | Temperature |
| Acinetobacter | 5045 | AJH | Nutrient | Pseudomonas | 26° C. |
| johnsonii | | | agar | Minimal medium | |
| | | | | with 10 g l⁻¹ | |
| | | | | succinate | |
| Acinetobacter | 5044 | ATJ | Nutrient | Pseudomonas | 26° C. |
| tjernbergiae | | | agar | Minimal medium | |
| | | | | with 10 g l⁻¹ | |
| | | | | succinate | |
| Arthrobacter | 2840 | ACH | Growth | Arthrobacter | 26° C. |
| chlorophenolicus | | | Minimal | Minimal | |
| | | | medium | medium, yeast | |
| | | | | extract | |
| Bacillus subtilis | ATCC | BST | Blood | Tryptic soy broth | 26° C. |
| | 6633 | | | | |
| Caulobacter | 2577 | CCR | Peptone | Peptone yeast | 30° C. |
| crescentus | | | yeast | extract broth | |
| | | | extract | | |
| | | | agar | | |
| Cryptococcus | 2632 | CAL | Luria- | Luria-Bertani | 26° C. |
| albidus | | | Bertani | broth | |
| | | | Broth | | |
| Escherichia coli | 4498 | ECO | Luria- | Luria-Bertani | 37° C. |
| MG1655 | | | Bertani | broth, | |
| | | | Broth | M9-glucose, | |
| | | | | casamino acids | |
| Escherichia coli | 3044 | ECL | Luria- | Luria-Bertani | 37° C. |
| DH5α-λpir | | | Bertani | Broth | |
| | | | Broth | | |
| Lactococcus lactis | 1363 | LLC | M17 agar | GM17 | 26° C. |
| Pseudomonas | 78 | PKM | Nutrient | Pseudomonas | 26° C. |
| knackmussii | | | agar | Minimal medium | |
| B13 | | | | with 10 g l⁻¹ | |
| | | | | succinate | |
| Pseudomonas | 5046 | PMG | Nutrient | Pseudomonas | 26° C. |
| migulae | | | agar | Minimal medium | |
| | | | | with 10 g l⁻¹ | |
| | | | | succinate | |
| Pseudomonas | 1291 | PPU | Nutrient | Pseudomonas | 26° C. |
| putida | | | agar | Minimal medium | |
| | | | | with 10 g l⁻¹ | |
| | | | | succinate | |
| Pseudomonas | 3370 | PVE | Nutrient | Pseudomonas | 26° C. |
| veronii | | | agar | Minimal medium | |
| | | | | with 10 g l⁻¹ | |
| | | | | succinate | |
| Sphingomonas | 2633 | SWT | Nutrient | Sphingomonas | 30° C. |
| wittichii | | | agar | Minimal medium | |
| | | | | with 1 g l⁻¹ | |
| | | | | salicylate | |
| Sphingomonas | 1363 | SYN | Nutrient | Sphingomonas | 30° C. |
| yanoikuyae | | | agar | Minimal medium | |
| | | | | with 1 g l⁻¹ | |
| | | | | salicylate | |

Pseudomonas Minimal medium: per liter 1 g NH₄Cl, 3.49 g Na₂HPO₄·2H₂O, 2.77 g KH₂PO₄ at pH 6.8.

Arthrobacter Minimal medium: per liter 2.1 g K₂HPO₄, 0.4 g KH₂PO₄, 0.5 g NH₄NO₃, 0.2 g MgSO₄·7H₂O, 0.023 g CaCl₂·2H₂O, 2 ml FeCl₃·6H₂O solution (1 mg ml⁻¹), 5 g yeast extracts at pH 7.4.

Sphingomonas Minimal medium: per liter 2.44 g Na₂HPO₄, 1.52 g KH₂PO₄, 0.50 g (NH₄)₂SO₄, 0.2 g MgSO₄×7H₂O, 0.05 g CaCl₂×2H₂O, 10 ml trace metal solution (0.5 g I⁻¹ EDTA, 0.2 g I⁻¹ FeSO₄×7H₂O), 2 ml trace metal solution (per liter 0.1 g ZnSO₄×7H₂O, 0.03 g MnCl₂×4H₂O, 0.3 g H₃BO₃, 0.2 g CoCl2×6 H₂O, 0.01 g CuCl₂×2H₂O, 0.02 g NiCl₂×6H₂O, 0.03 g Na₂MoO₄×2H₂O) at pH 6.9.

Flow Cytometric Analysis

For FCM analysis, a total volume of 20 μl of stained sample was aspired at 14 μl min⁻¹ on a NovoCyte flow cytometer (ACEA Biosciences, Inc.) at a sample acquisition rate of (maximally) 35,000 events s⁻¹. Samples were analyzed in two technical replicates. The NovoCyte flow cytometer has accurate volumetric-based cell counting hardware and no calibration through addition of counting beads is necessary. The sheath flow rate was fixed at 6.5 ml min⁻¹, which corresponds to a core diameter of approximately 7.7 μm. The instrument threshold was set to 600 in the FITC-H channel (497 nm excitation and 520±30 nm acquisition to capture SYBR Green I fluorescence) and to 20 in the FSC-H channel for all samples in all experiments. Seven FCM parameters were recorded for every particle (FITC-Area, FITC-Height, FSC-Area, FSC-Height, SSC-Area, SSC-Height and Width). Data sets were exported as .csv files and imported for preprocessing and artificial neural network analysis in MatLab (vs. 2017a, details are provided in Example 9 (Supplementary Methods)).

Data Preprocessing

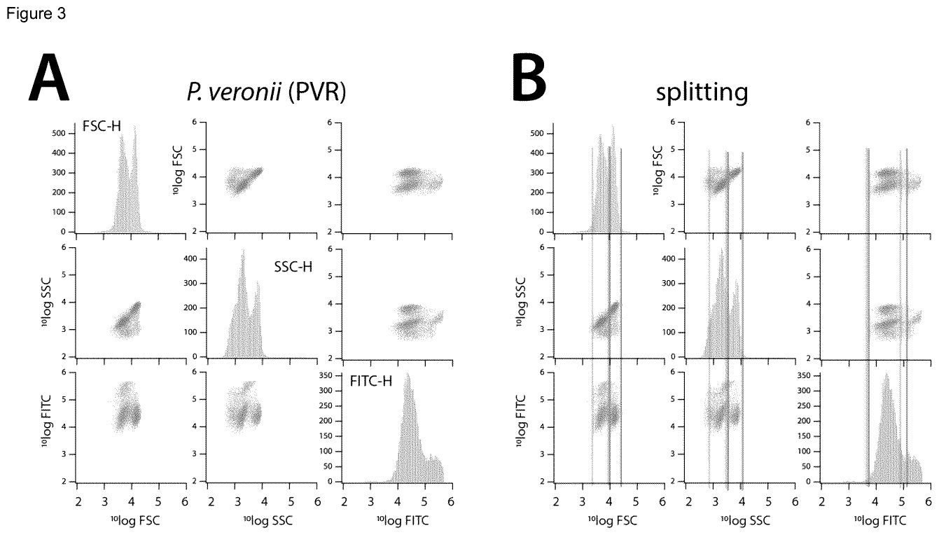

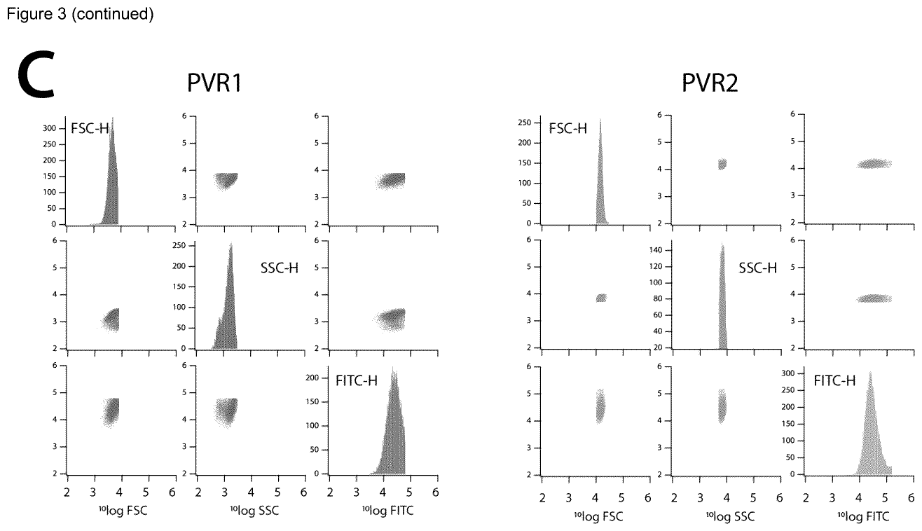

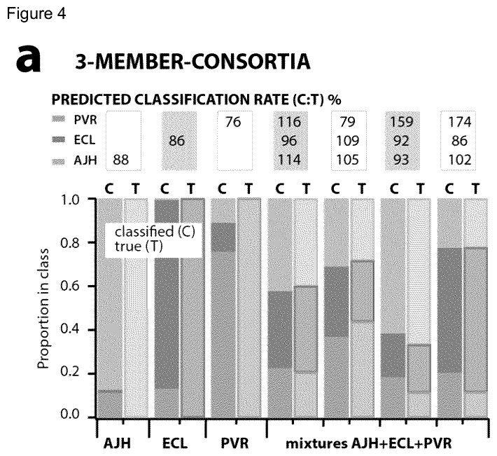

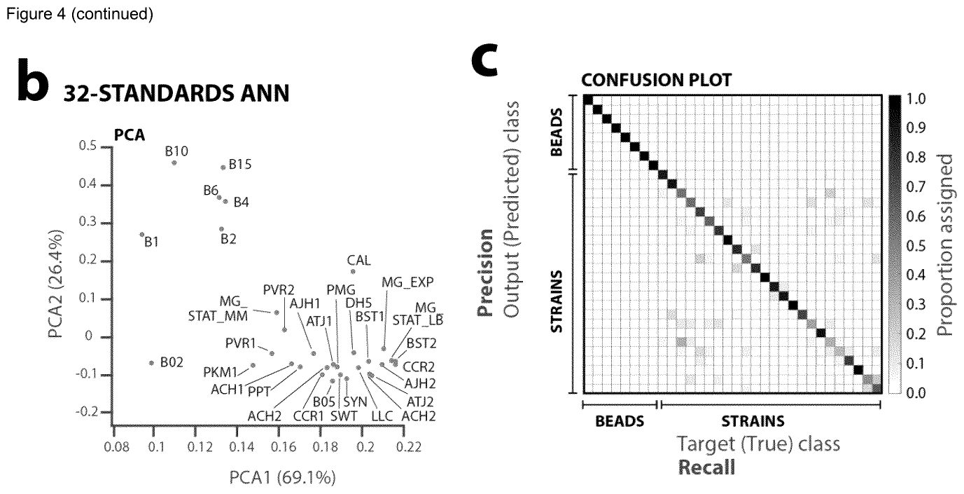

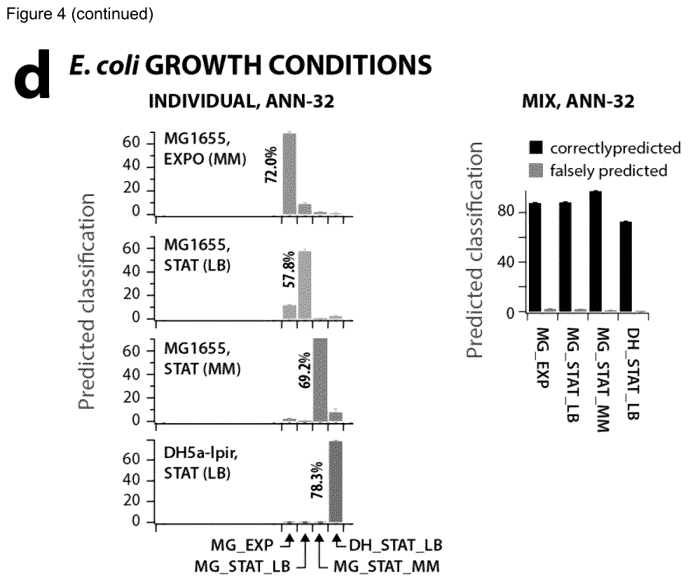

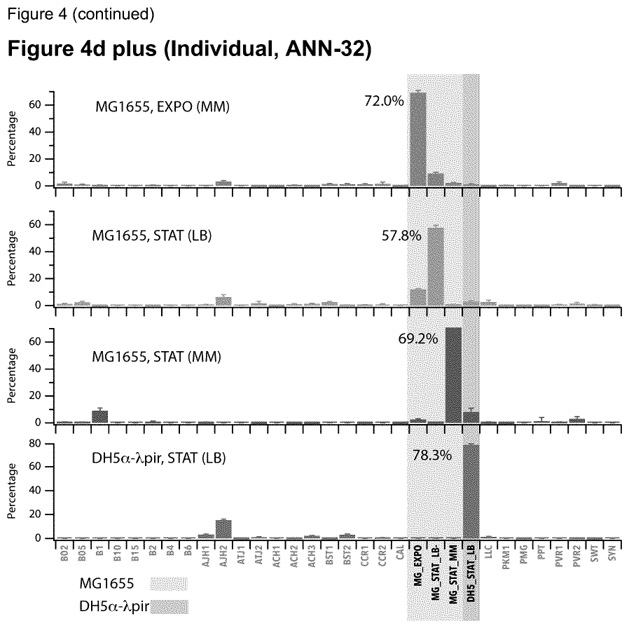

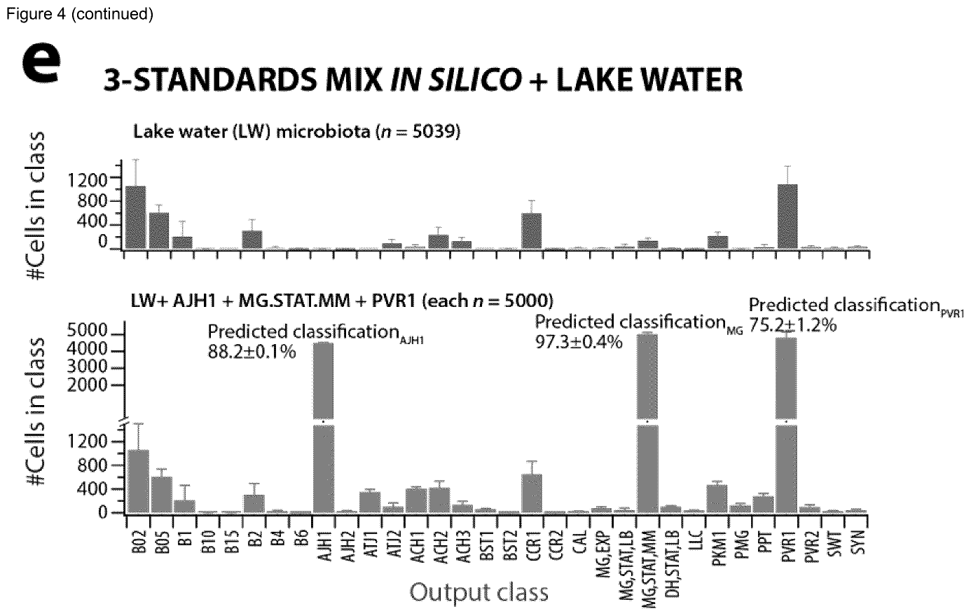

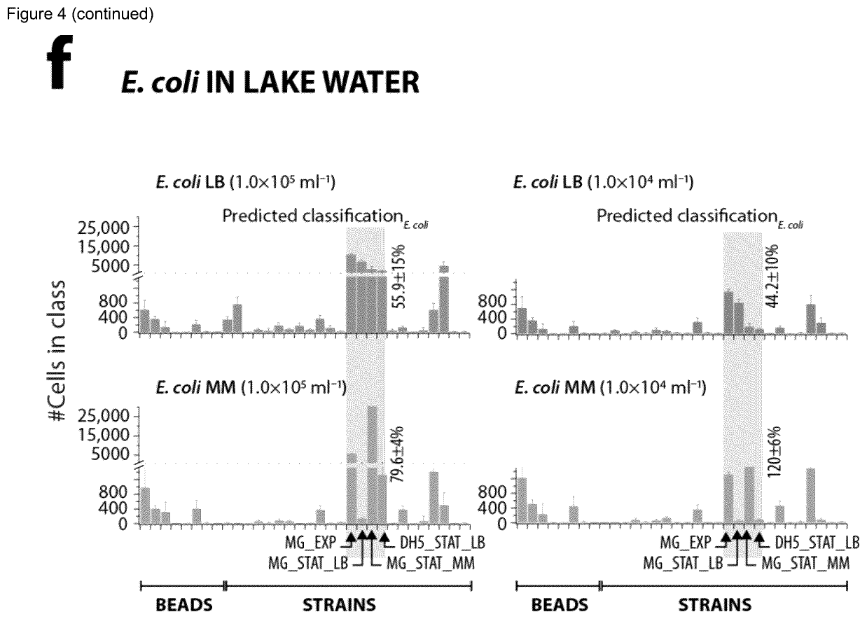

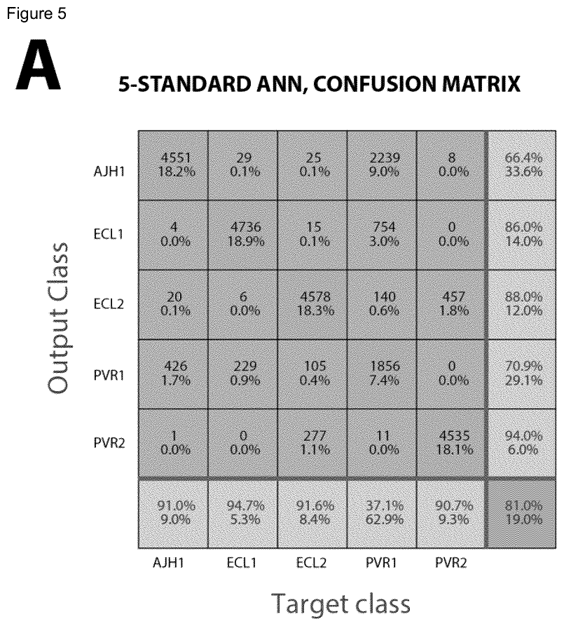

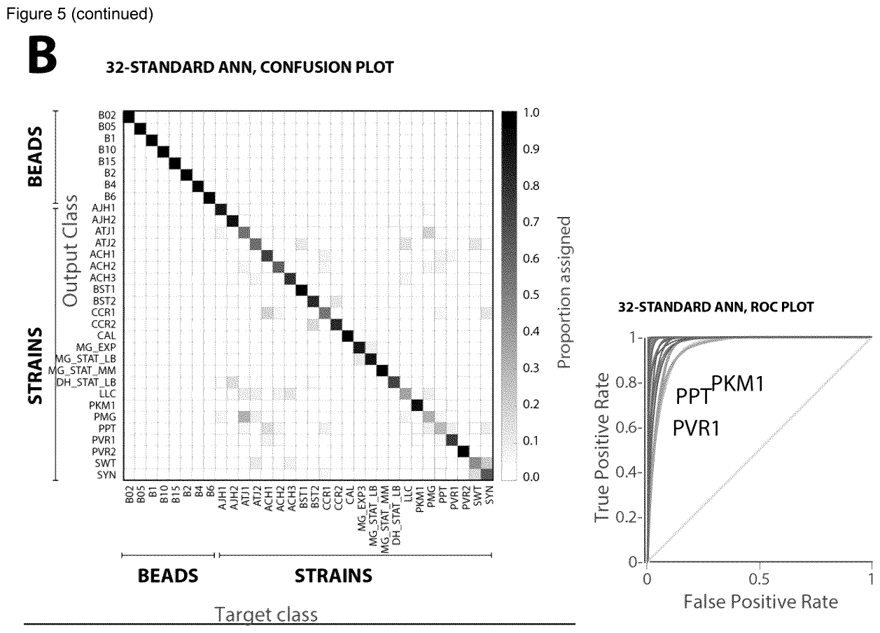

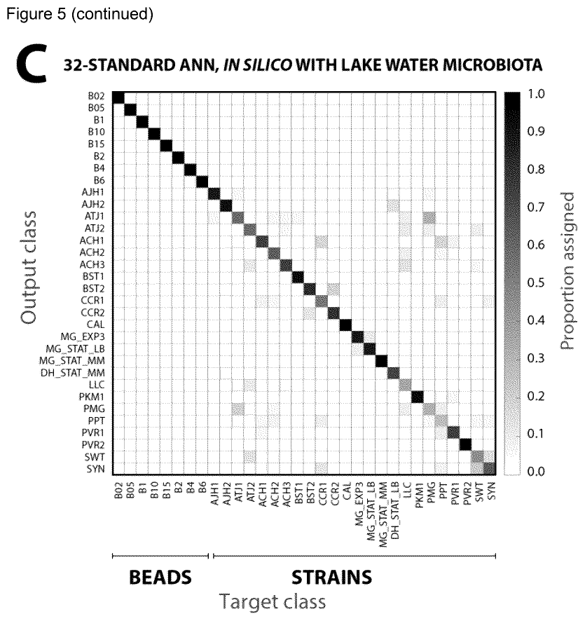

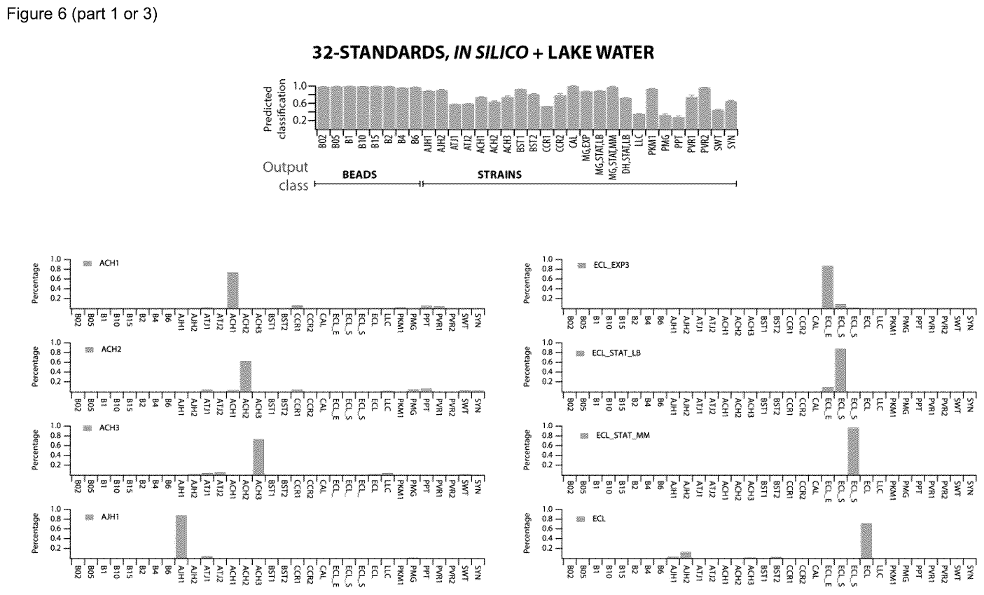

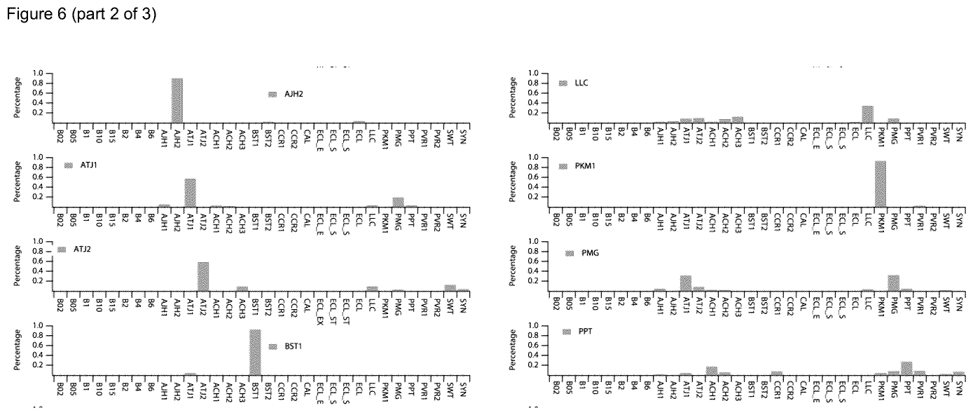

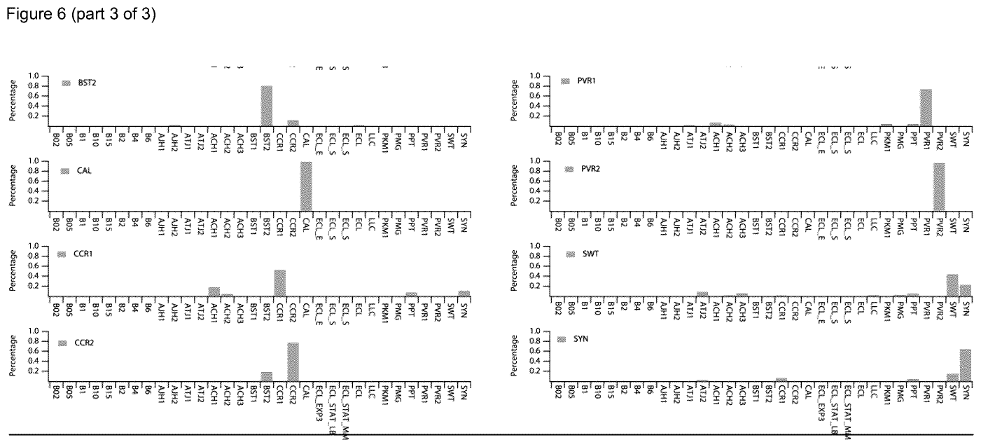

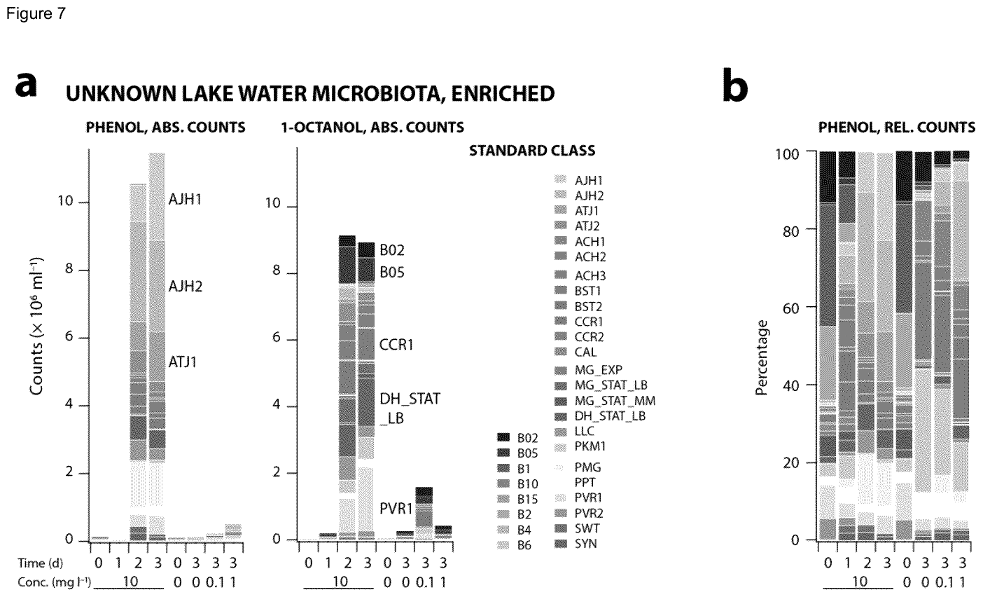

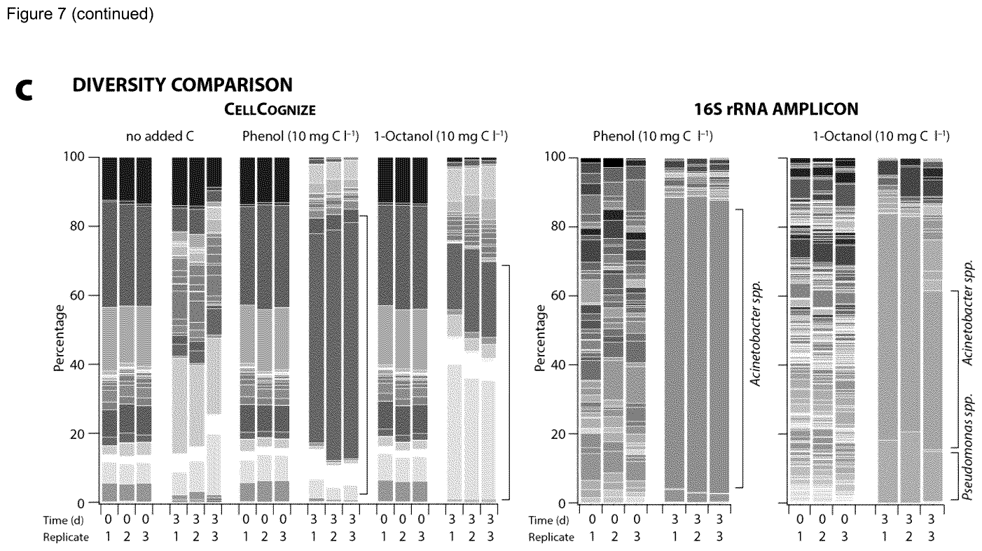

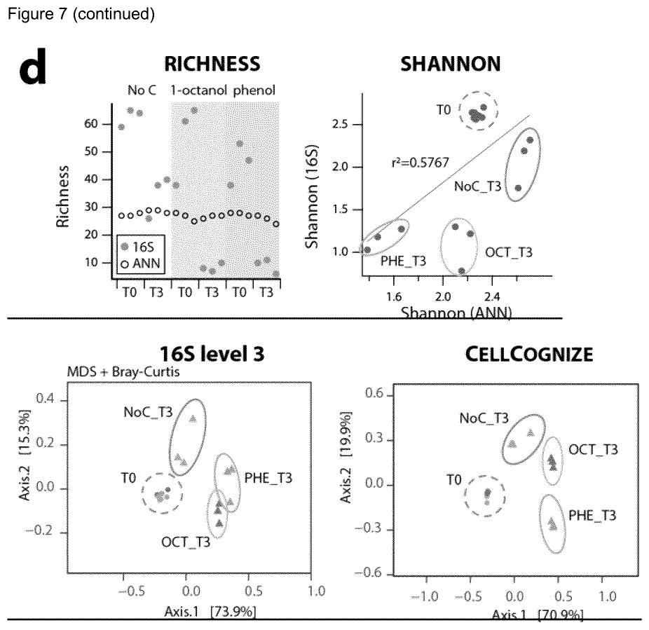

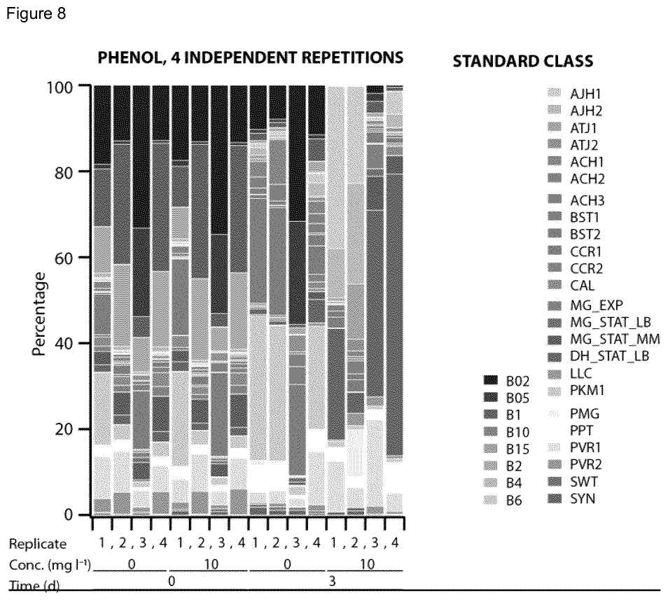

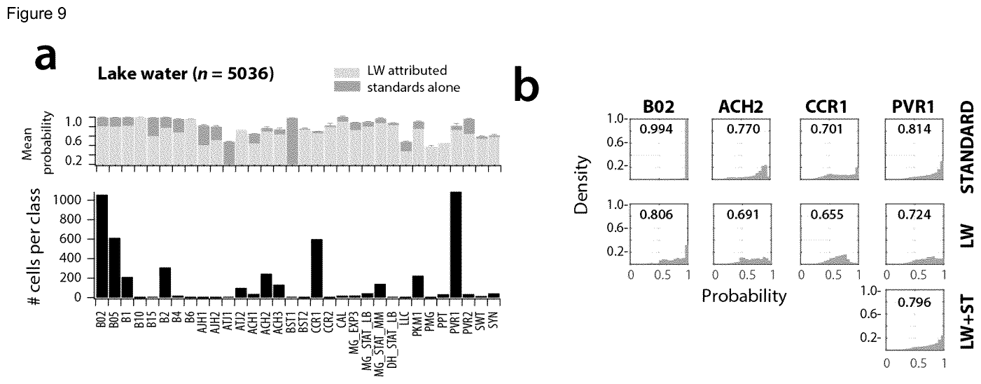

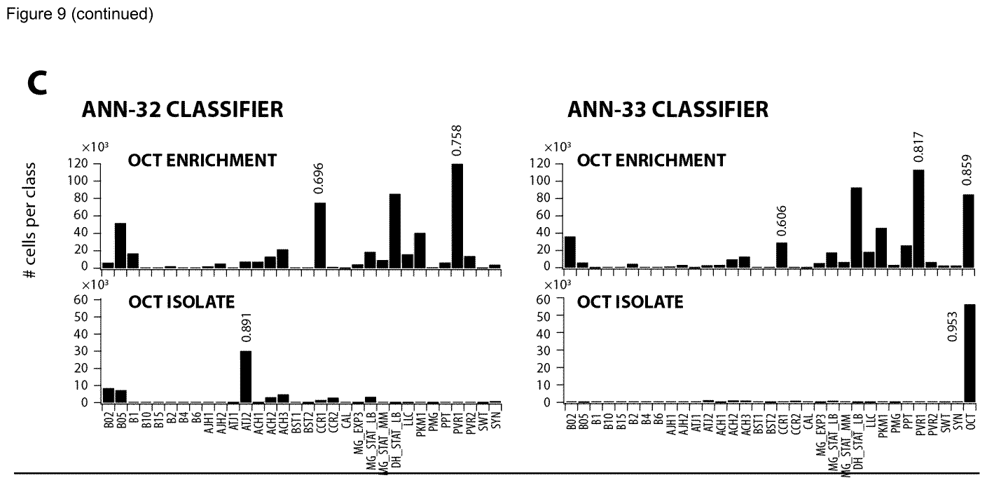

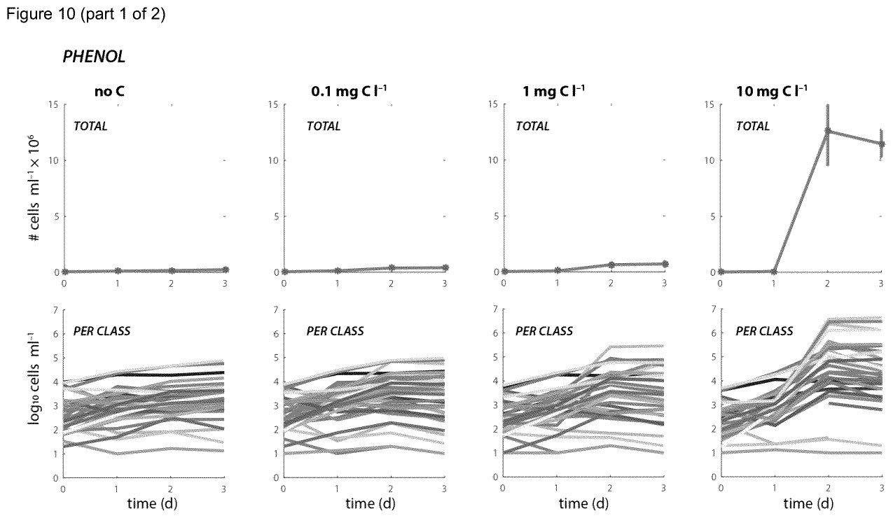

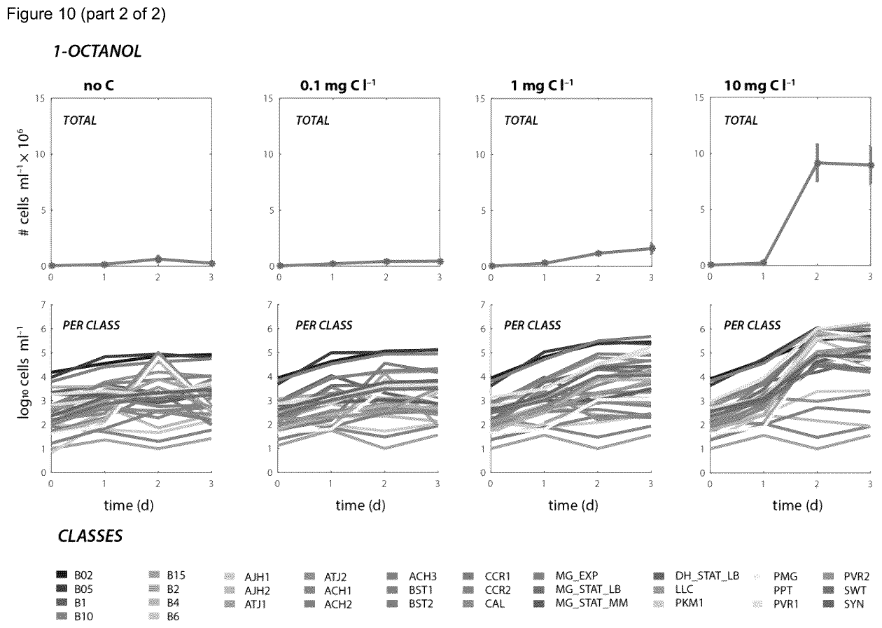

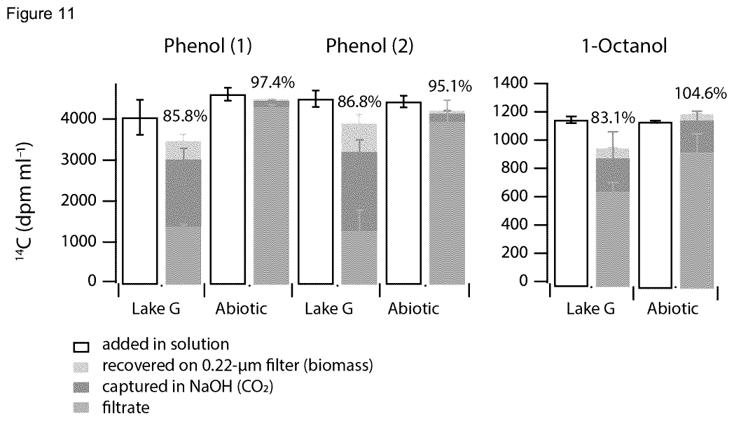

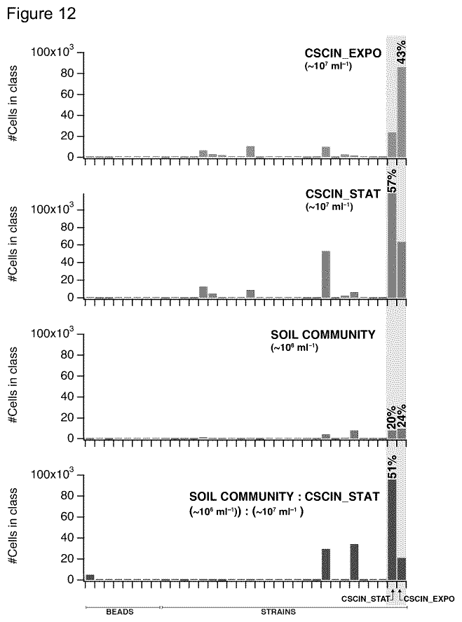

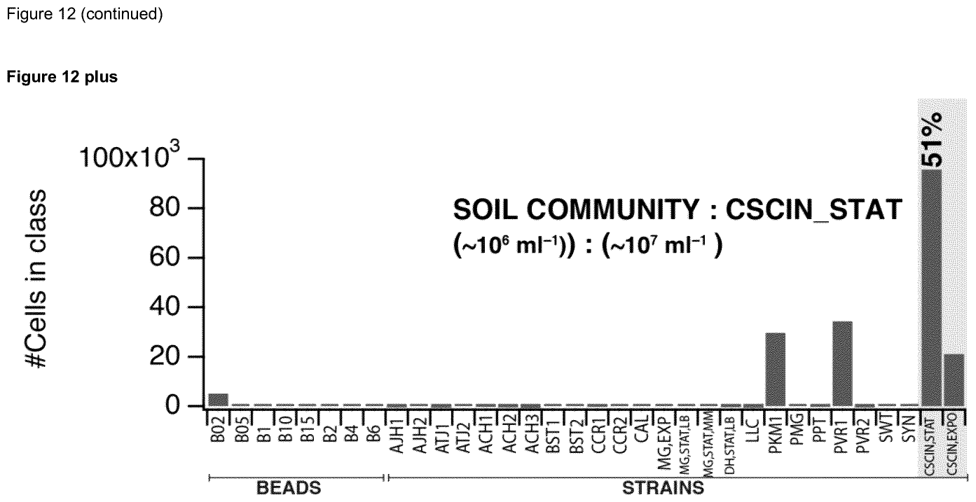

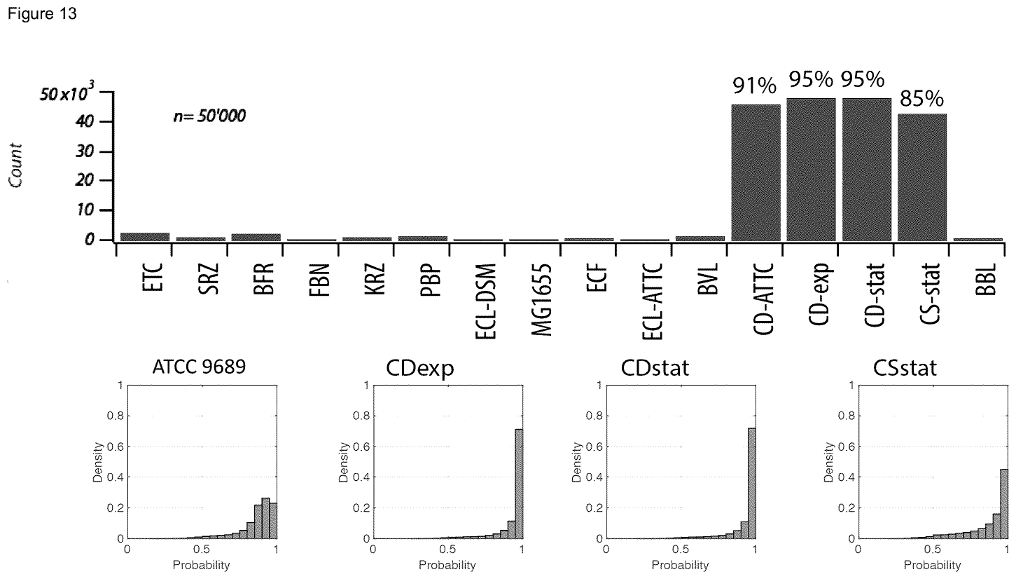

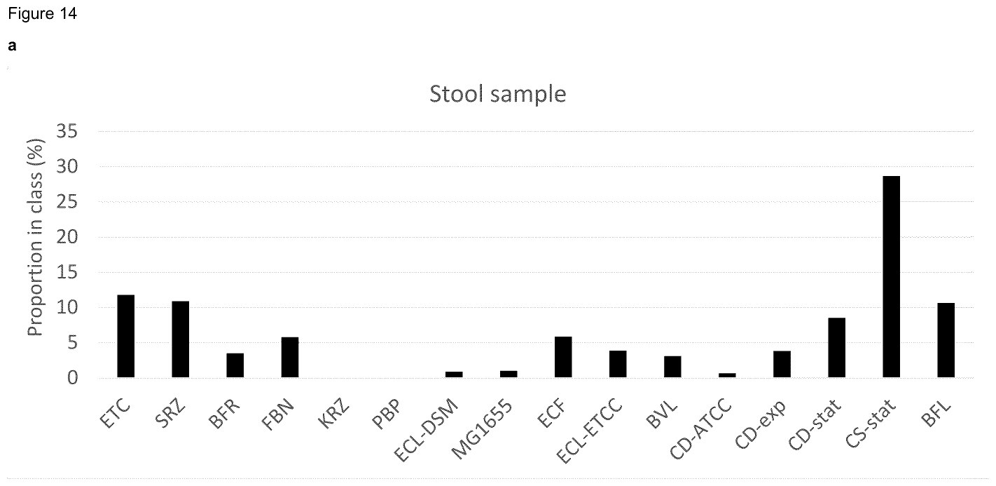

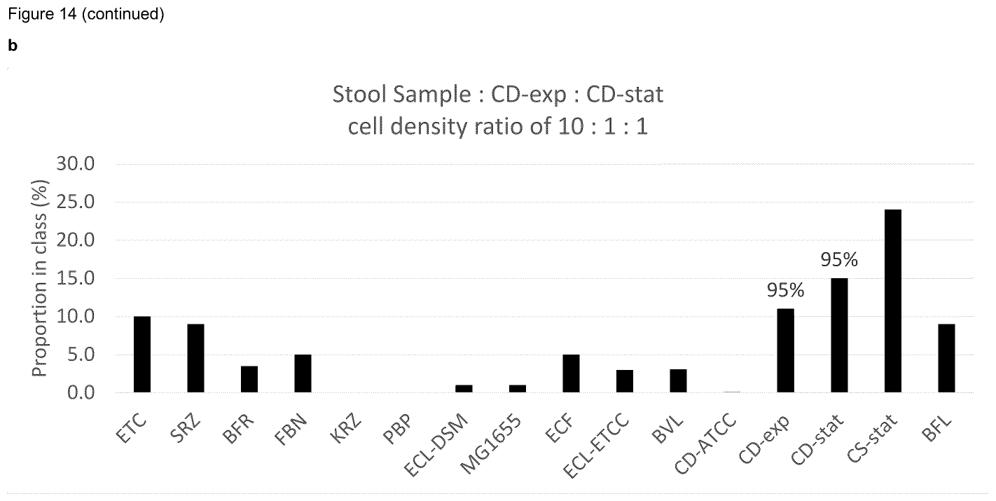

FCM data of each sample (15 microbes, 8 beads) were filtered for each of the 7 parameters between a fixed lower boundary (e.g. a value of 100) and an upper boundary (e.g a value of 10⁵-10⁷), and then ¹⁰ log-transformed. Filtered and log-transformed data for each of the samples were plotted in FITC-H, SSC-H and FSC-H (see, e.g., FIG. 3). The choice for one or more subpopulations is based on their visible signature in FSC-H vs SSC-H, FSC-H vs FITC-H, or SSC-H vs FITC-H 2D diagrams, and the proportion of cells that are actually encompassed by such subpopulation. The limit was set at 5% of the total data in the plot. Subpopulations containing at least 5% of all data were gated and separated within the filtered data sets by setting lower and upper log-transformed boundaries in each of the three-parameter dimensions (i.e., FITC-H, SSC-H and FSC-H). For some standards, this resulted in three subpopulations (e.g. see Table 1, ACH1, ACH2 and ACH3). Overall, this process resulted in a total of 32 standards: 8 bead and 24 strain data sets (see Table 1). For the preliminary experiment with three strains (5-class classifier), five standards (three strains, two of which had two subpopulations) were used.

The filtered and gated data sets of the standards (sample size (n)˜3×10⁵ to 1.5×10⁶ events per standard) were used as input for the development of ANN models. The datasets were randomly subsampled to 10,000 events using the datasample function (Matlab v. R2017a). The lower and upper boundary values imposed during the filtering process for each of the seven FCM parameters (“anchors”) were added as two data points per parameter to the first subsampled standard. This process of ‘anchoring’ was to fix the position of the datasets for the subsequent machine-learning ANN algorithm. Subsampled anchored datasets (of either 5 or 32 standards) were concatenated and used as input into the ANN model, during which they were further scaled (between −1 and 1—hence the added anchors) and randomly divided using Divider and (Matlab v. R2017a) into three blocks: a training set (50% of the data), a validation set (25%) and a testing set (25%) which were used as inputs for the development of the ANN model. Briefly, the training set is used for fitting the parameters for the classifiers. The validation set is used for tuning the parameters (e.g. weights) of the classifier. The test set is used to assess the performance of the tuned classifier. The overall performance of the classifier is evaluated as a confusion matrix and an ROC plot.

Artificial Neural Network Reconstruction

The ANN architecture consisted of a feedforward backpropagation algorithm with one input, one hidden and one output layer. The input layer contained 7 nodes (corresponding to the 7 FCM parameters), whereas the output layer contained 5 (for the preliminary three-strain experiment) or 32 nodes (one for each of the standard in the full set). Input nodes were connected to the hidden layer by the sigmoid function (Matlab v. 2017a), whereas the hidden layer nodes (20) were connected to the output by the softmax transfer function (Matlab v. 2017a). The ANN model was trained by applying the trainscg function to the input matrix (Matlab v. 2017a) in 1000 cycles of training, validation and test (performance goal=0, time=Inf, min grad=1 e−06, max fail=6). Performance of the ANN was evaluated by crossentropy. The outcome of the ANN model is a classifier, which is a function describing the correlations between input parameters and output classes which are 5 or 32 classes of the standard dataset. The process of subsampling, anchoring, pooling and training was repeated five times independently on the full (non-subsampled) datasets, in order to use more data, generating five slightly different functions called the ANN classifiers. The performance of the ANN classifiers was assessed on the basis of confusion matrices (Matlab v. 2017a), visualizing predicted versus actual events for the complete in silico mixed set of standards and on the basis of the ROC plot, (as shown in FIGS. 4 and 5, and Example 9 (Supplementary Methods)).

### Example 2. Differentiating and Categorizing Microbiota of Known Composition

To test the conceptual idea, a synthetic community consisting of the three bacterial species Escherichia coli (ECL), Pseudomonas veronii (PVR) and Acinetobacter johnsonii (AJH) was assembled for training and testing a five-class classifier: First, FCM signatures of individual SYBR Green I-stained cultures (cultured to stationary phase) were captured in seven channels, gated into five distinguishable classes (both ECL and PVR yielding two visible subpopulations in FCM) (see Example 1, FIG. 3, and Example 9 (Supplementary Methods)). Next, in silico merged FCM data sets were used to train the ANN model. The network correctly differentiated the five classes with an overall accuracy of 81% (FIG. 5). The generated ANN-5 classifier assigned 76-88% of cells in experimentally regrown pure cultures to their correct class (correct predicted classification or sensitivity). In addition, the predicted classification of cells in defined three-species mixtures was between 96-132% (averages of the four mixture sample values per species above the bar plots in FIG. 4a, Example 9 (Supplementary Methods)). The results show that the classifiers can be used to calculate relative abundances of in vitro grown synthetic microbial communities.

To test the approach for more complex communities of known composition, a set of 32 standards consisting of 8 polystyrene beads with different diameters, 14 bacterial strains, 6 of which having two and one with three distinguishable subpopulations, and one yeast culture (Table 1; see Example 1) was used. The choice of standards was motivated by (i) differences in shape and size of cell types and beads (FIG. 2), (ii) the potential presence of similar strains in the target microbial community (lake water), and (iii) having multiple representatives from the same family (e.g., Pseudomonas, Sphingomonas) or species (e.g., E. coli MG1655 and DH5α-λpir). FCM signatures of the 8 bead types, and of the individual 15 strains under defined growth conditions were collected, and clearly distinguishable cell type subpopulations were determined, which resulted in 32 standard classes in total (Table 1, FIG. 3; see Example 1). The 32 standards were distinct in principal component analysis (PCA), with two PCA components explaining >90% of the covariation (FIG. 4b, Example 9 (Supplementary Methods)). The bead standards covered a wider multidimensional space in PCA compared to the microbial cell standards, possibly due to their larger size differences and fluorescence intensities (FIG. 4b).

ANNs were trained with in silico merged individual multiparametric FCM data sets of all 32 standards (randomly subsampled to the same size, n=10,000 as described in Example 1; Example 9 (Supplementary Methods)). This process was repeated five times independently, resulting in five slightly different ANN-32 classifiers. When used to classify additional in silico merged FCM datasets of the standards (not those used for training sets), these classifiers achieved an overall accuracy of 79.2% (range 27.3-99.8% across the 32 standards, FIG. 4c, FIG. 5, Table 1 and Table 3), and with 80-99% true positive identification at <20% false discovery rate (ROC plot in FIG. 5, Example 9 (Supplementary Methods)). Many standards were very consistently differentiable (Table 1, Table 3, and FIGS. 4 and 5) and any confusion appeared to be not dependent on standards being taxonomically closely related. For example, several Pseudomonas strains were well distinguished (FIG. 5). Neither were intuitive cell shape differences an obvious differentiation criterion. For example, although the larger Bacillus subtilis rods (BST1) were well differentiated from all other rod-shaped bacteria (mostly Pseudomonas standards, Table 1), the curved cells of Caulobacter crescentus (FIG. 5, CCR1) were confused to some extent with the small rod-shaped Pseudomonas putida (PPT) and with the irregularly shaped cells of Arthrobacter chlorophenolicus (ACH, FIG. 5). These tests indicated that CellCognize is able to differentiate a set of 32 standards from each other based on their multiparametric FCM signatures, albeit with precision and recall that varied among the standards. The precision or recall values might be further improved by employing further FCM parameters and stainings.

Table 3 shows the output of the ANN-32 training, for five different classifiers, i.e. the attributed events from a combined FCM dataset of 10,000 subsampled standards. The numbers in the matrix refer to the results from one classifier run. Recall (sensitivity) and precision on the sides are shown for five classifiers, and the average. The average data are plotted as confusion plots in FIGS. 4c and 5b.

TABLE 3
Performance of a 32-class classifier on in silico test data
(part 1 of 4)

| | | Class | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| Class | 32 standards | B02 | B05 | B1 | B10 | B15 | B2 | B4 | B6 | AJH1 | AJH2 | ATJ1 | ATJ2 |
| 1 | B02 | 9840 | 26 | 0 | 1 | 1 | 3 | 8 | 1 | 0 | 0 | 0 | 0 |
| 2 | B05 | 110 | 9948 | 0 | 1 | 0 | 1 | 0 | 0 | 0 | 0 | 0 | 0 |
| 3 | B1 | 5 | 2 | 9976 | 4 | 1 | 25 | 4 | 0 | 0 | 0 | 0 | 0 |
| 4 | B10 | 0 | 0 | 0 | 9913 | 17 | 0 | 0 | 0 | 0 | 0 | 0 | 0 |
| 5 | B15 | 1 | 0 | 0 | 63 | 9974 | 0 | 0 | 0 | 0 | 0 | 0 | 0 |
| 6 | B2 | 9 | 1 | 23 | 0 | 4 | 9952 | 27 | 5 | 0 | 0 | 0 | 0 |
| 7 | B4 | 0 | 1 | 0 | 3 | 2 | 9 | 9642 | 152 | 0 | 0 | 0 | 0 |
| 8 | B6 | 0 | 0 | 0 | 9 | 1 | 0 | 314 | 9839 | 0 | 0 | 0 | 0 |
| 9 | AJH1 | 0 | 0 | 0 | 0 | 0 | 0 | 0 | 0 | 8808 | 8 | 609 | 7 |
| 10 | AJH2 | 0 | 0 | 0 | 0 | 0 | 0 | 0 | 0 | 83 | 9102 | 1 | 59 |
| 11 | ATJ1 | 0 | 0 | 0 | 0 | 0 | 0 | 0 | 0 | 381 | 0 | 5530 | 19 |
| 12 | ATJ2 | 0 | 0 | 0 | 0 | 0 | 0 | 0 | 0 | 0 | 115 | 74 | 5751 |
| 13 | ACH1 | 0 | 1 | 0 | 0 | 0 | 0 | 0 | 0 | 0 | 0 | 303 | 0 |
| 14 | ACH2 | 0 | 0 | 0 | 0 | 0 | 0 | 0 | 0 | 1 | 0 | 289 | 0 |
| 15 | ACH3 | 0 | 0 | 0 | 0 | 0 | 0 | 0 | 0 | 0 | 17 | 22 | 0 |
| 16 | BST1 | 0 | 0 | 0 | 0 | 0 | 0 | 0 | 0 | 123 | 54 | 0 | 1084 |
| 17 | BST2 | 0 | 1 | 0 | 0 | 0 | 0 | 0 | 0 | 0 | 269 | 0 | 0 |
| 18 | CCR1 | 0 | 0 | 0 | 0 | 0 | 0 | 0 | 0 | 0 | 0 | 59 | 2 |
| 19 | CCR2 | 1 | 18 | 1 | 1 | 0 | 0 | 0 | 3 | 0 | 6 | 0 | 0 |
| 20 | CAL | 0 | 0 | 0 | 2 | 0 | 2 | 3 | 0 | 0 | 0 | 0 | 0 |
| 21 | MG_EXP | 0 | 1 | 0 | 1 | 0 | 0 | 0 | 0 | 1 | 0 | 0 | 0 |
| 22 | MG_STAT_LB | 0 | 0 | 0 | 0 | 0 | 0 | 0 | 0 | 0 | 0 | 0 | 3 |
| 23 | MG_STAT_MM | 1 | 0 | 0 | 2 | 0 | 1 | 1 | 0 | 0 | 0 | 0 | 0 |
| 24 | DH | 0 | 0 | 0 | 0 | 0 | 1 | 0 | 0 | 148 | 319 | 8 | 16 |
| 25 | LLC | 0 | 0 | 0 | 0 | 0 | 0 | 0 | 0 | 9 | 95 | 456 | 1252 |
| 26 | PKM1 | 30 | 1 | 0 | 0 | 0 | 0 | 0 | 0 | 0 | 0 | 0 | 0 |
| 27 | PMG | 0 | 0 | 0 | 0 | 0 | 0 | 0 | 0 | 319 | 1 | 1923 | 230 |
| 28 | PPT | 0 | 0 | 0 | 0 | 0 | 0 | 1 | 0 | 68 | 0 | 431 | 0 |
| 29 | PVR1 | 3 | 0 | 0 | 0 | 0 | 0 | 0 | 0 | 57 | 0 | 65 | 0 |
| 30 | PVR2 | 0 | 0 | 0 | 0 | 0 | 0 | 0 | 0 | 0 | 2 | 0 | 0 |
| 31 | SWT | 0 | 0 | 0 | 0 | 0 | 0 | 0 | 0 | 2 | 12 | 84 | 1216 |
| 32 | SYN | 0 | 0 | 0 | 0 | 0 | 0 | 0 | 0 | 0 | 0 | 146 | 361 |
| | n (columns) | 10000 | 10000 | 10000 | 10000 | 10000 | 9994 | 10000 | 10000 | 10000 | 10000 | 10000 | 10000 |
| | Rep0 | 0.984 | 0.995 | 0.998 | 0.991 | 0.997 | 0.996 | 0.964 | 0.984 | 0.881 | 0.91 | 0.553 | 0.575 |
| Recall | Rep0 | 98.4 | 99.48 | 99.76 | 99.13 | 99.74 | 99.58 | 96.42 | 98.39 | 88.08 | 91.02 | 55.3 | 57.51 |
| | Rep1 | 98.2 | 99.4 | 99.9 | 98.5 | 99.8 | 99.1 | 96.1 | 97.7 | 88.2 | 92.3 | 57.1 | 61.6 |
| | Rep2 | 98.4 | 99.3 | 99.7 | 98.8 | 99.8 | 99.4 | 95.9 | 97.6 | 88.8 | 89.6 | 58.9 | 60.6 |
| | Rep3 | 98.3 | 99.5 | 99.8 | 99.1 | 99.7 | 99.4 | 96.5 | 98.4 | 88.6 | 90.9 | 53.3 | 52.7 |
| | Rep4 | 98.2 | 99.4 | 99.9 | 98.7 | 99.8 | 99.4 | 96.4 | 98.2 | 89.6 | 90.6 | 56.6 | 61.7 |
| | Average | 98.30 | 99.42 | 99.81 | 98.85 | 99.77 | 99.38 | 96.26 | 98.06 | 88.66 | 90.88 | 56.24 | 58.82 |
| | sd | 0.10 | 0.08 | 0.10 | 0.25 | 0.05 | 0.15 | 0.28 | 0.39 | 0.59 | 1.12 | 2.34 | 4.33 |

(part 2 of 4)

Class

| | | 13 | 14 | 15 | 16 | 17 | 18 | 19 | 20 | 21 | 22 |
|---|---|---|---|---|---|---|---|---|---|---|---|
| Class | 32 standards | ACH1 | ACH2 | ACH3 | BST1 | BST2 | CCR1 | CCR2 | CAL | ECL_EXP3 | ECL_STAT_LB |
| 1 | B02 | 0 | 0 | 0 | 0 | 0 | 0 | 0 | 0 | 0 | 0 |
| 2 | B05 | 0 | 3 | 8 | 0 | 0 | 0 | 0 | 0 | 0 | 0 |
| 3 | B1 | 0 | 0 | 0 | 0 | 0 | 0 | 0 | 0 | 0 | 0 |
| 4 | B10 | 0 | 0 | 0 | 0 | 0 | 0 | 0 | 0 | 0 | 0 |
| 5 | B15 | 0 | 0 | 0 | 0 | 0 | 0 | 0 | 0 | 0 | 0 |
| 6 | B2 | 0 | 0 | 0 | 0 | 0 | 0 | 0 | 2 | 0 | 0 |
| 7 | B4 | 0 | 0 | 0 | 0 | 0 | 0 | 0 | 0 | 0 | 0 |
| 8 | B6 | 0 | 0 | 0 | 0 | 0 | 0 | 0 | 0 | 0 | 0 |
| 9 | AJH1 | 50 | 98 | 5 | 125 | 0 | 0 | 0 | 0 | 0 | 0 |
| 10 | AJH2 | 0 | 0 | 288 | 60 | 191 | 0 | 3 | 0 | 0 | 9 |
| 11 | ATJ1 | 224 | 592 | 0 | 0 | 0 | 136 | 0 | 0 | 0 | 0 |
| 12 | ATJ2 | | 7 | 534 | 19 | 2 | 0 | 0 | 0 | 0 | 0 |
| 13 | ACH1 | 7336 | 374 | 0 | 0 | 0 | 1875 | 0 | 0 | 0 | 0 |
| 14 | ACH2 | 18 | 6240 | 0 | 0 | 0 | 486 | 0 | 0 | 0 | 0 |
| 15 | ACH3 | 0 | 109 | 7953 | 1 | 119 | 22 | 8 | 0 | 0 | 3 |
| 16 | BST1 | 0 | 0 | 2 | 9768 | 0 | 0 | 0 | 0 | 0 | 0 |
| 17 | BST2 | 0 | 0 | 41 | 6 | 8149 | 0 | 1698 | 8 | 22 | 22 |
| 18 | CCR1 | 728 | 476 | 2 | 0 | 0 | 5402 | 0 | 0 | 0 | 0 |
| 19 | CCR2 | 0 | 0 | 173 | 0 | 1163 | 0 | 8129 | 0 | 28 | 48 |
| 20 | CAL | 0 | 0 | 0 | 2 | 6 | 0 | 1 | 9986 | 4 | 0 |
| 21 | MG_EXP | 0 | 0 | 0 | 1 | 91 | 0 | 44 | 0 | 8843 | 987 |
| 22 | MG_STAT_LB | 0 | 2 | 11 | 0 | 10 | 0 | 70 | 0 | 879 | 8924 |
| 23 | MG_STAT_MM | 0 | 0 | 0 | 0 | 0 | 0 | 0 | 0 | 202 | 0 |
| 24 | DH | 0 | 40 | 156 | 7 | 207 | 0 | 25 | 4 | 0 | 6 |
| 25 | LLC | 102 | 278 | 548 | 4 | 7 | 40 | 3 | 0 | 0 | 0 |
| 26 | PKM1 | 265 | 0 | 0 | 0 | 0 | 28 | 0 | 0 | 0 | 0 |
| 27 | PMG | 49 | 525 | 41 | 0 | 0 | 56 | 0 | 0 | 0 | 0 |
| 28 | PPT | 730 | 664 | 0 | 0 | 0 | 570 | 0 | 0 | 0 | 0 |
| 29 | PVR1 | 497 | 6 | 0 | 0 | 0 | 103 | 0 | 0 | 0 | 0 |
| 30 | PVR2 | 1 | 49 | 2 | 7 | 55 | 0 | 19 | 0 | 22 | 1 |
| 31 | SWT | 0 | 262 | 158 | 0 | 0 | 122 | 0 | 0 | 0 | 0 |
| 32 | SYN | 0 | 275 | 78 | 0 | 0 | 1160 | 0 | 0 | 0 | 0 |
| | n (columns) | 10000 | 10000 | 10000 | 10000 | 10000 | 10000 | 10000 | 10000 | 10000 | 10000 |
| | Rep0 | 0.734 | 0.624 | 0.795 | 0.977 | 0.815 | 0.54 | 0.813 | 0.999 | 0.884 | 0.892 |
| Recall | Rep0 | 73.36 | 62.4 | 79.53 | 97.68 | 81.49 | 54.02 | 81.29 | 99.86 | 88.43 | 89.24 |
| | Rep1 | 74.1 | 64.1 | 78.4 | 97.4 | 79.4 | 55.4 | 78.4 | 99.9 | 88.6 | 88.1 |
| | Rep2 | 71.9 | 62.5 | 78.3 | 98.1 | 80.7 | 50.6 | 76.8 | 99.9 | 88.3 | 88.9 |
| | Rep3 | 72.8 | 62.6 | 77.8 | 97.7 | 81.4 | 55.1 | 81.3 | 99.9 | 88.3 | 90.8 |
| | Rep4 | 71.4 | 65.4 | 77.1 | 98 | 81.1 | 54.7 | 79.6 | 99.9 | 87.2 | 89.7 |
| | Average | 72.71 | 63.40 | 78.23 | 97.78 | 80.82 | 53.96 | 79.48 | 99.89 | 88.17 | 89.35 |
| | sd | 1.18 | 1.38 | 0.59 | 0.32 | 0.88 | 2.25 | 1.90 | 0.00 | 0.62 | 1.15 |

(part 3 of 4)

Class

| | | 23 | 24 | 25 | 26 | 27 | 28 | 29 | 30 | 31 | 32 |
|---|---|---|---|---|---|---|---|---|---|---|---|
| Class | 32 standards | ECL_STAT_MM | ECL | LLC | PKM1 | PMG | PPT | PVR1 | PVR2 | SWT | SYN |
| 1 | B02 | 0 | 0 | 0 | 56 | 0 | 0 | 8 | 0 | 0 | 0 |
| 2 | B05 | 0 | 0 | 0 | 0 | 0 | 0 | 0 | 0 | 0 | 0 |
| 3 | B1 | 0 | 0 | 0 | 0 | 0 | 0 | 1 | 0 | 0 | 0 |
| 4 | B10 | 0 | 0 | 0 | 0 | 0 | 0 | 0 | 0 | 0 | 0 |
| 5 | B15 | 0 | 0 | 0 | 0 | 0 | 0 | 0 | 0 | 0 | 0 |
| 6 | B2 | 1 | 0 | 0 | 0 | 0 | 0 | 0 | 0 | 0 | 0 |
| 7 | B4 | 0 | 0 | 0 | 0 | 0 | 0 | 0 | 0 | 0 | 0 |
| 8 | B6 | 0 | 0 | 0 | 0 | 0 | 0 | 0 | 0 | 0 | 0 |
| 9 | AJH1 | 0 | 313 | 276 | 0 | 502 | 206 | 113 | 0 | 24 | 0 |
| 10 | AJH2 | 0 | 1419 | 329 | 0 | 46 | 0 | 0 | 0 | 32 | 0 |
| 11 | ATJ1 | 0 | 23 | 1048 | 0 | 3151 | 482 | 169 | 0 | 46 | 26 |
| 12 | ATJ2 | 0 | 114 | 853 | 0 | 839 | 5 | 0 | 0 | 1003 | 258 |
| 13 | ACH1 | 0 | 0 | 241 | 130 | 264 | 1552 | 635 | 0 | 13 | 0 |
| 14 | ACH2 | 0 | 30 | 768 | 0 | 240 | 489 | 365 | 1 | 247 | 192 |
| 15 | ACH3 | 0 | 171 | 1243 | 0 | 92 | 17 | 0 | 13 | 703 | 154 |
| 16 | BST1 | 0 | 13 | 22 | 0 | 3 | 0 | 0 | 0 | 30 | 0 |
| 17 | BST2 | 0 | 327 | 0 | 0 | 0 | 0 | 0 | 58 | 0 | 0 |
| 18 | CCR1 | 0 | 0 | 10 | 97 | 72 | 740 | 136 | 0 | 224 | 608 |
| 19 | CCR2 | 0 | 63 | 0 | 0 | 0 | 0 | 0 | 97 | 0 | 0 |
| 20 | CAL | 0 | 0 | 0 | 0 | 0 | 0 | 0 | 0 | 0 | 0 |
| 21 | MG_EXP | 117 | 0 | 0 | 0 | 0 | 0 | 0 | 2 | 0 | 0 |
| 22 | MG_STAT_LB | 0 | 0 | 1 | 0 | 0 | 0 | 0 | 2 | 1 | 0 |
| 23 | MG_STAT_MM | 9705 | 0 | 0 | 0 | 0 | 0 | 0 | 26 | 0 | 0 |
| 24 | DH | 6 | 7268 | 135 | 0 | 29 | 29 | 0 | 102 | 6 | 0 |
| 25 | LLC | 0 | 182 | 3700 | 0 | 487 | 190 | 50 | 0 | 233 | 110 |
| 26 | PKM1 | 0 | 0 | 0 | 9283 | 0 | 404 | 463 | 0 | 0 | 0 |
| 27 | PMG | 0 | 22 | 902 | 0 | 3229 | 871 | 36 | 0 | 258 | 119 |
| 28 | PPT | 0 | 0 | 167 | 117 | 580 | 2960 | 515 | 0 | 428 | 378 |
| 29 | PVR1 | 0 | 0 | 154 | 317 | 35 | 857 | 7509 | 0 | 3 | 0 |
| 30 | PVR2 | 171 | 42 | 0 | 0 | 0 | 0 | 0 | 9699 | 0 | 0 |
| 31 | SWT | 0 | 13 | 114 | 0 | 233 | 335 | 0 | 0 | 4450 | 1630 |
| 32 | SYN | 0 | 0 | 37 | 0 | 198 | 863 | 0 | 0 | 2299 | 6525 |
| | n (columns) | 10000 | 10000 | 10000 | 10000 | 10000 | 10000 | 10000 | 10000 | 10000 | 10000 |
| | Rep0 | 0.971 | 0.727 | 0.37 | 0.928 | 0.323 | 0.296 | 0.751 | 0.97 | 0.445 | 0.653 |
| Recall | Rep0 | 97.05 | 72.68 | 37 | 92.83 | 32.29 | 29.6 | 75.09 | 96.99 | 44.5 | 65.25 |
| | Rep1 | 96.4 | 74.3 | 29.9 | 94.9 | 29.3 | 24.3 | 73.9 | 95.7 | 43.3 | 67.6 |
| | Rep2 | 98.6 | 73.4 | 35.1 | 94.2 | 31.4 | 30.6 | 73.5 | 97.5 | 46.5 | 66 |
| | Rep3 | 97.7 | 72.7 | 31.2 | 93.7 | 36.4 | 21.8 | 73.3 | 97 | 43 | 68 |
| | Rep4 | 97.1 | 72 | 36.9 | 94.5 | 35 | 30.4 | 73.7 | 96.4 | 43.1 | 66.2 |
| | Average | 97.37 | 73.02 | 34.02 | 94.03 | 32.88 | 27.34 | 73.90 | 96.72 | 44.08 | 66.61 |
| | sd | 0.93 | 0.98 | 3.27 | 0.51 | 3.26 | 4.42 | 0.26 | 0.78 | 1.69 | 1.00 |

(part 4 of 4)

| | | Class | | | | | | | |
|---|---|---|---|---|---|---|---|---|---|
| | | Precision (positive predictive value) | | | | | | | |
| Class | 32 standards | n (rows) | Rep0 | Rep1 | Rep2 | Rep3 | Rep4 | Average | sd |
| 1 | B02 | 9944 | 98.95 | 99.1 | 99.2 | 99 | 98.9 | 99.03 | 0.12 |
| 2 | B05 | 10071 | 98.78 | 98.7 | 98.6 | 98.7 | 98.5 | 98.66 | 0.11 |
| 3 | B1 | 10018 | 99.58 | 99.5 | 99.5 | 99.7 | 99.5 | 99.56 | 0.09 |
| 4 | B10 | 9930 | 99.83 | 99.8 | 99.8 | 99.6 | 99.8 | 99.77 | 0.09 |
| 5 | B15 | 10038 | 99.36 | 98.6 | 98.9 | 99.1 | 98.7 | 98.93 | 0.31 |
| 6 | B2 | 10024 | 99.28 | 99.7 | 99.5 | 99.6 | 99.7 | 99.56 | 0.17 |
| 7 | B4 | 9809 | 98.3 | 97.2 | 97.3 | 98.2 | 98.1 | 97.82 | 0.53 |
| 8 | B6 | 10163 | 96.81 | 96.3 | 96.1 | 96.7 | 96.6 | 96.50 | 0.29 |
| 9 | AJH1 | 11144 | 79.04 | 78.8 | 80 | 78.9 | 79.3 | 79.21 | 0.48 |
| 10 | AJH2 | 11622 | 78.32 | 78 | 78.8 | 77.8 | 76.7 | 77.92 | 0.78 |
| 11 | ATJ1 | 11827 | 46.76 | 46.2 | 46 | 47.5 | 48.3 | 46.95 | 0.95 |
| 12 | ATJ2 | 9574 | 60.07 | 59.8 | 61.9 | 54.9 | 60.6 | 59.45 | 2.67 |
| 13 | ACH1 | 12724 | 57.65 | 57.5 | 56.3 | 55.7 | 56.9 | 56.81 | 0.82 |
| 14 | ACH2 | 9366 | 66.62 | 64.1 | 68.9 | 66.3 | 64.7 | 66.12 | 1.88 |
| 15 | ACH3 | 10647 | 74.7 | 69.6 | 69.4 | 68.8 | 70.6 | 70.62 | 2.37 |
| 16 | BST1 | 11099 | 88.01 | 96.8 | 97.8 | 97.9 | 97.9 | 95.68 | 4.31 |
| 17 | BST2 | 10601 | 76.87 | 76.7 | 74.8 | 77.9 | 76.5 | 76.55 | 1.12 |
| 18 | CCR1 | 8556 | 63.14 | 61 | 61.9 | 59.5 | 64.5 | 62.01 | 1.92 |
| 19 | CCR2 | 9731 | 83.54 | 81.8 | 82.3 | 84.8 | 83.2 | 83.13 | 1.16 |
| 20 | CAL | 10006 | 99.8 | 99.8 | 99.9 | 99.9 | 99.7 | 99.82 | 0.08 |
| 21 | MG_EXP | 10088 | 87.66 | 86.1 | 87 | 89 | 87.7 | 87.49 | 1.06 |
| 22 | MG_STAT_LB | 9903 | 90.11 | 88.9 | 90.9 | 90.2 | 90.1 | 90.04 | 0.72 |
| 23 | MG_STAT_MM | 9938 | 97.66 | 96.4 | 96.9 | 96.9 | 95.6 | 96.69 | 0.76 |
| 24 | DH | 8512 | 85.39 | 83.1 | 82.7 | 83.3 | 83.1 | 83.52 | 1.07 |
| 25 | LLC | 7746 | 47.77 | 53.6 | 50 | 46.1 | 51.9 | 49.87 | 3.03 |
| 26 | PKM1 | 10474 | 88.63 | 87.1 | 88.3 | 87.4 | 87 | 87.69 | 0.74 |
| 27 | PMG | 8581 | 37.63 | 46.2 | 37.2 | 36.8 | 39.6 | 39.49 | 3.90 |
| 28 | PPT | 7609 | 38.9 | 43.5 | 36.1 | 34.7 | 38 | 38.24 | 3.36 |
| 29 | PVR1 | 9606 | 78.17 | 74.6 | 78.5 | 75.9 | 79 | 77.23 | 1.89 |
| 30 | PVR2 | 10070 | 96.32 | 96.1 | 97.7 | 97.2 | 96.4 | 96.74 | 0.68 |
| 31 | SWT | 8631 | 51.56 | 58 | 52.1 | 48.6 | 53.2 | 52.69 | 3.42 |
| 32 | SYN | 11942 | 54.64 | 54.8 | 56.9 | 55.4 | 56.4 | 55.63 | 0.99 |

### Example 3. Differentiation of Cell Physiology Among E. coli Strains

To determine the potential of the classifiers obtained by CellCognize to differentiate among closely related strains and different growth phases, the 32-standard set was used which included inter alia two E. coli strains (MG1655 and DH5α-λpir) grown to stationary phase on LB-medium, and MG1655 further sampled in exponential and stationary phase on M9-CAA medium. Strikingly, the 32-standard ANN classifiers correctly predicted the classification of 58-78% of the experimental datasets of each of the four E. coli cultures individually, and 70-90% of an in silico mixed FCM dataset (FIG. 4d, Example 9 (Supplementary Methods)). Among these four standards, it was possible to clearly differentiate cells according to growth phase (strain MG1655 at exponential phase on M9-CAA medium, MG_EXP vs. stationary phase on M9-CAA medium, MG_STAT_MM) and culture medium (strain MG1655 at stationary phase on LB medium, MG_STAT_LB vs. stationary phase on M9-CAA medium, MG_STAT_MM), and to distinguish between closely related strains even when sharing the same growth phase and culture medium (strain MG1655 at stationary phase on LB medium, MG_STAT_LB vs. strain DH5α-λpir at stationary phase on LB medium, DH5_STAT_LB, FIGS. 4c and d, and Table 3). This demonstrates that the CellCognize pipeline allows to determine cell physiological status and differentiate among closely related strains on the basis of FCM signatures.

### Example 4. Recognition of Known Standards within a Diverse Unknown Aqueous Microbial Community

To test the performance of CellCognize to recognize known strains within a complex microbiota, its ability to correctly predict the 32 standards within a background of unknown microbes was assessed. First, its performance was assessed in silico by merging a randomly subsampled FCM dataset with 5000 events (not those used for ANN training) from each of the individual strain and bead standards separately with the same number of unknown cells from a freshwater microbial community (FIG. 6, Example 9 (Supplementary Methods)). These merged datasets were classified independently using the five ANN-32 classifiers and the percentage of correctly predicted cells was calculated. The correct predicted classification of each in silico merged standard in the presence of the unknown freshwater microbial community (FIG. 6) was similar to that of the standards alone, showing that the presence of cells from unknown species does not hamper recognition of the standards (FIG. 5, Table 1). Then, FCM datasets of three standards (each subsampled to n=5000 cells) were simultaneously merged in silico with the lake water microbiota background (n=5039 cells) and the mixture was classified using the five ANN-32 classifiers. The three strain standards were correctly predicted at between 75.2 and 97.3%, demonstrating good recognition and differentiation (FIG. 4e, Example 9 (Supplementary Methods)).

The performance of CellCognize was further experimentally tested to distinguish known strains within a background of unknown freshwater microbes. For this, E. coli was chosen as an example, which was correctly classified to between 73-97% within the in silico merged data (Table 1). E. coli MG1655 was grown to stationary phase on either M9-CAA or LB medium and mixed with the freshwater microbial community at 1.0×10⁴ or 1.0×10⁵ cells ml⁻¹, which was analyzed by FCM after 1-2 h (FIG. 2f, Example 9 (Supplementary Methods)). The lake water community itself had few cells attributed to the E. coli classes (FIG. 4e top), and the E. coli classes increased upon experimentally adding E. coli MG1655 cells (FIG. 4f, grey shaded zones). Added E. coli cells were to a large extent classified to the category of their pre-culture signature (e.g., cells grown on M9-CAA classified to MG_EXP and MG_STAT_MM, FIG. 4f) Based upon the true abundance of E. coli cells, percentages of the predicted classification were 79.6-120% for M9-CAA, and 44.2-55.9% for LB-grown cells (FIG. 4f, Example 9 (Supplementary Methods)). These results indicated that CellCognize can identify and quantify specific target strains and their physiological state within complex microbiota mixtures.

### Example 5. Analysis of Diversity of Unknown Microbiota

CellCognize may be also applied to differentiate the diversity of unknown microbial communities in which none of the learned standards are necessarily present. This application may be useful as a rapid estimate of diversity to compare habitats, or changes in a microbiota between individuals or upon treatment. A diversity measure may be based on assigning class abundances with respect to the set of predefined standards, while realizing that this may be different from directly measuring microbial taxa diversity. To test the relevance of such an approach, community changes were analyzed after exposure to selective chemical compounds, which was quantified by CellCognize classification and 16S rRNA-gene amplicon sequencing diversity analysis. Specific biomass production was further measured using ¹⁴C-labeled substrate and compared to the estimates based on the summed biomass from predicted classifications, as conceptually outlined in FIGS. 1e and f.

In order to induce changes in the freshwater microbial community composition, lake water samples were amended with low concentrations of 1-octanol or phenol (0.1, 1 and 10 mg C I⁻¹). As expected, exposure to phenol or 1-octanol caused a rapid and profound change in the total community cell count, to an extent dependent on the added substrate and its concentration (FIG. 7a, abs. counts, FIG. 10). Classification using CellCognize revealed a clear shift in the community composition after only one day following amendment with 10 mg C I⁻¹ phenol (FIG. 7b rel. counts), culminating in growth and domination of cell types similar to the Acinetobacter standards (AJH1, AJH2, ATJ1, ATJ2) as well as Pseudomonas migulae (PMG) after two and three days, contributing 70% of the cells in the community (FIG. 7b, FIG. 10). This was noticeably different from the detected change over time in the un-amended controls, whereas similar enrichments to the Acinetobacter classes were seen after amendment with 0.1 and 1 mg C I⁻¹ phenol at day 3 (FIG. 7b, rel. counts). Independent replicates of phenol amendment to the Lake Geneva water microbial community in different months showed one dominating cell type in the enriched samples (FIG. 8). Amendment with 10 mg C I⁻¹ 1-octanol also caused a rapid increase in total community cell count in comparison to the un-amended controls (FIG. 7a, abs. counts, FIG. 10). In this case, however, enriched cell types were more diverse and comprised various classes, none of which exceeded 15% of the total community (FIG. 7a, 1-octanol).

To verify the performance of CellCognize in tracking community shifts (diversity changes), in a separate experiment both CellCognize and molecular diversity analysis using 16S rRNA gene amplicon sequencing for 10 mg C I⁻¹ phenol and 1-octanol amendments were analyzed in terms of phenotypic and taxonomic diversity, respectively (FIG. 7c). Both methods showed clear and strong enrichments in the substrate-amended lake water samples after three days, in a consistent manner across biological replicates (FIG. 7c, bracketed zones in stackplots). When diversity metrics are inferred from sequence read counts or flow cytometric data, Shannon indices were moderately correlated between taxonomic and phenotypic diversities, as determined by 16S rRNA sequencing and CellCognize, respectively (r²=0.5767, FIG. 7d). Both methods yielded similar clustering in terms of replicates, treatments and time effect (FIG. 7d, MDS plots, Adonis, p<0.001). Bray-Curtis distances of the datasets from CellCognize or 16S rRNA gene amplicon analysis were similar (procrustes goodness-of-fit=0.2144, Pearson-ranked correlation coefficient=0.8981, p=0.0000). This shows that underlying diversity measures based on classes or taxa, can be captured by both methods.

To further assess the value of CellCognize quantification of cell type diversity in unknown communities, biomass yields of the lake water microbial community upon phenol or 1-octanol amendment were calculated (FIG. 7a, abs. counts, FIG. 10), using estimated respective standard per particle biomasses (Table 5). These estimates were compared to independently measured biomass yields from triplicate assays for ¹⁴C labeled substrate incorporation (FIG. 11). Biomass yields were in the same order of magnitude (Table 4). This showed that the class enrichments deduced by CellCognize translate into reasonable biomass predictions even in unknown communities, which may support the conclusion that the enriched bacterial cell types are similar to the attributed standard classes. Note that CellCognize covers various cell size classes (ranging between 0.2 μm and 15 μm) and can thus calculate biomass distributions in microbial communities and changes thereof even when larger cells or cell clumps are present.

TABLE 4
Comparative biomass yield estimates of Lake Geneva microbial
community after 3 days incubation with phenol or 1-octanol
as sole carbon sources at varying concentrations.

| | Concen- | ¹⁴C based | CellCognize | |
|---|---|---|---|---|
| | tration | biomass | based biomass | |
| Substrate | (mg/l) | yield (g/g)^{a} | yield (g/g)^{a, b} | t -test |
| Phenol^{c} | 0.1 | 0.135 ± 0.027 | 0.350 ± 0.15 | p = 0.0709 |
| | 1.0 | 0.151 ± 0.052 | 0.057 ± 0.010 | p = 0.0370 |
| | 10 | 0.166 ± 0.042 | 0.118 ± 0.017 | p = 0.1393 |
| 1- | 0.1 | 0.469 ± 0.168 | 0.367 ± 0.117 | p = 0.4341 |
| Octanol^{d} | | | | |
| | 1.0 | 0.396 ± 0.024 | 0.148 ± 0.038 | p = 0.0007 |
| | 10 | 0.233 ± 0.028 | 0.100 ± 0.024 | p = 0.0033 |

^{a}Mean ± standard deviation
^{b}Calculation based on the estimated mean carbon mass per cell as shown in Table 5.
^{c}Three independently carried out experiments with three biological replicates each and Lake Geneva water sampled at different occasions.
^{d}Single experiment with biological triplicates.

### Example 6. Similarity Assessment of Unknown Microbiota and Predefined CellCognize Classes

Given the large observed taxonomic diversity in the freshwater communities (FIG. 7c, 16S rRNA amplicon), the assignment of unknown microbiota into the predefined standard classes in CellCognize was further analyzed. The probabilities of class assignments for the standards themselves and for the unknown assigned microbiota were analyzed in greater depth. Furthermore, one isolate from the lake water substrate enrichments was purified and the class assignments with the ANN-32 classifier and with a newly trained classifier that included that isolate were compared.

In the CellCognize results described above (e.g, FIG. 4e, 7a, Example 9 (Supplementary Methods)), each cell was assigned to the class that yielded the highest probability of cell assignment. Although this procedure correctly assigns cells to their most likely class, their probability score could still be lower than the mean score for cells from the standard itself. To illustrate this, the mean probabilities per assigned class for the attributed cells from the lake water community was calculated (FIG. 9a, light grey bars, Example 9 (Supplementary Methods)). For most of the 32 classes, these mean assignment probabilities were lower than those of the pure standards themselves (FIG. 9a, dark grey bars). For four relatively abundant attributed classes in the lake water community (B02, ACH2, CCR1 and PVR1) the probability distributions were computed, which in all cases showed probabilities shifted to lower values compared to those of the pure standards (FIG. 9b, Example 9 (Supplementary Methods)). These probability distributions may be used to calculate a classification similarity score of assignment. For example, the mean probability of assignment of predicted classification of cells in lake water to class B02 was 0.806, but that of the true standard B02 was 0.994, giving an overall average classification similarity to this class of 81%. A ratio of this sort could form the basis of a similarity score between cells in an unknown microbiota and members of the standard set. Given that, except for the bead standards (e.g., B02), most strain standards have wider probability distributions (e.g., FIG. 9b), one could also consider a further form of thresholding or binning on the probability distributions to describe similarities of unknown cells to the standard categories. Importantly, this showed that the approach is versatile, so that cells in unknown microbiota can be attributed to standard classes, but their similarity to those classes can also be further analyzed.

To illustrate this effect of similarities further, the probability distributions and classification similarity scores in the freshwater community enrichments were further analyzed and compared those of a strain that was isolated from the enrichment on 1-octanol (FIG. 9c, Example 9 (Supplementary Methods)). 16S rRNA gene sequencing confirmed the isolate as a Pseudomonas sp. The FCM signature of this pure culture was predominantly assigned by the 32-standard ANN classifiers to ATJ2 (0.891 mean probability of predicted classification, FIG. 9c, OCT isolate). With a new ANN classifier that was trained with a standard set that included the isolate itself in addition to the previous 32 (ANN-33 classifier), however, the cells were exclusively attributed to their own class (0.953 mean probability of predicted classification, FIG. 9c). The classification similarity score of the isolate to the attributed class in the ANN-32 classifier (ATJ2, FIG. 9c) was thus 0.891/0.953=93%. The new 33-standard ANN classifier confirmed this isolate to account for 15.8% of cells in the enrichment, which corresponds to the 19.5% of 16S rRNA amplicon sequences attributed to Pseudomonas (FIG. 7c).

Collectively, these experiments thus demonstrate that CellCognize can discriminate compositional shifts remarkably well even in an unknown microbial community, despite the relatively low number of classes used here for the CellCognize pipeline (32 classes), and that mean probabilities of predicted classification (assignment probabilities) or probability distributions can be further used to quantify similarities of cell attribution to the used classes.

### Example 7. Experimental Details of the Analysis of Diversity of Unknown Microbiota and Similarity Assessments Shown in Examples 5 and 6

Phenol/Octanol Treatment of Freshwater Microbial Community and ¹⁴C-Based Biomass Analysis

In order to evaluate the ANN classification of an unknown community, Lake Geneva water microbial community was incubated with either phenol or 1-octanol, or without any such treatment, for three days. Microorganisms were collected from 10 L Lake Geneva water by filtration (0.2-40 μm pore size) taken in November 2018, and resuspended in 100 ml artificial lake water (ALW) in acid-treated closed 500-ml glass Schott flasks to obtain starting cell concentrations of 10⁵ cells ml⁻¹. Uniformly ¹⁴C-labeled phenol or 1-C ¹⁴C-labeled 1-octanol (ANAVA Trading SA) were dosed at 1000-5000 dpm ml⁻¹ in a mixture with unlabeled compound of the same type, to obtain total carbon concentrations of 0.1, 1 or 10 mg C I⁻¹. Incubations with unlabeled phenol were further repeated three times independently with Lake Geneva microbial communities sampled in October and November 2017, and January 2019. Unamended inoculated ALW served as control for background growth, whereas amended but non-inoculated ALW served as abiotic controls. Triplicate flasks were prepared per assay, and incubated at 21° C. in the dark with 150 rpm rotary shaking. Aliquots of 1 ml were taken immediately after spiking the substrate (T0), and then daily by syringes with needles without opening the caps, for cell staining with SYBR Green I and FCM analysis. FCM data were exported, filtered and anchored as described in Example 1, and used as input for ANN classification using the five ANN-32 classifiers.

A further 12 ml were sampled from each flask at day 3 (T3) for ¹⁴C-analysis by needle and syringe without opening the caps. A subsample of 0.1 ml was taken to measure the radioactivity in aqueous solution. A 5-ml aliquot was filtered through 0.2-μm-pore size membrane filter to collect cell biomass, and a comparison subsample (0.1 ml) was taken from the filtrate. At day 3, the remaining solution after sampling (85 ml) was acidified to pH 3, CO₂ was purged from the liquid by air stripping during 1 h, and the solution was collected into three vials each containing 5 ml of 1 M NaOH. Vials were pooled and 0.5 ml was sampled. Aqueous samples or filtered cells were mixed in 5 ml liquid scintillation cocktail (Perkin Elmer) to measure the amount of ¹⁴C-CPM (counts per min) via scintillation counting, which was converted to DPM (disintegrations per min) by multiplying by a factor of 1/0.94. Mass balance values are reported in FIG. 11.

Community Diversity Analysis by 16S rRNA Gene Amplicon Sequencing.

Lake Geneva water prokaryotic species diversity was determined by 16S rRNA gene amplicon sequencing. Samples from the enrichment experiment carried out with phenol and 1-octanol at 10 mg/l (phenol replicate 4; 1-octanol replicate 2) as described above were collected immediately after addition of the substrate (phenol/1-octanol) (TO) and three days after incubation at room temperature in the dark (T3). Sample volumes were adjusted to have similar cell densities at TO and T3. Cells were collected on 0.2-μm membrane filters (PES, Sartorius) and stored in FastDNA Spin kit solution for soil (MPBio) at −80° C. until analysis. DNA was extracted according to the recommendations of the FastDNA Spin kit for soil (MPBio), and the V3-V4 hypervariable region of the 16S rRNA gene was amplified using the 341f/785r primer set with appropriate Illumina adapters and barcodes. PCR conditions, amplifications and library preparations were done as recommended in the Illumina Amplicon sequencing protocol (https://support.illumina.com/documents/documentation/chemistry_documentation/16 s/16s-metagenomic-library-prep-guide-15044223-b.pdf). Equal amounts of amplified DNA from each sample were pooled and sequenced bidirectionally on the Illumina MiSeq platform at the University of Lausanne. Raw 16S rRNA gene amplicon sequences were quality filtered, concatenated, verified for absence of potential chimera, dereplicated and mapped to known bacterial species using QIIME2 at 99% similarity to the SILVA taxonomic reference gene database on a UNIX platform (Bolyen (2018), PeerJ Preprints 6, e27295v27292).

Pure Culture Isolation.

Phenol- and 1-octanol-grown communities at day 3 (T3) were plated on MicroDish® platforms placed on silicagel disks with 10 mg/l of the corresponding substrate and incubated for three days at 21° C. Microcolonies were picked and transferred to glass vials with ALW and the same phenol or 1-octanol concentration for further propagation. One such isolate (named OCT in further analyses) was able to grow both with phenol and 1-octanol at 10 mg C I⁻¹ and was used for CellCognize classification as described above. On the basis of its amplified and sequenced gene for 16S rRNA, this isolate had 99.5% nucleotide identity with the gene for 16S rRNA of Pseudomonas azotoformans. FCM data of a pure stained culture of the OCT-isolate grown on ALW with 1-octanol for three days was included with the previous 32 standards to train a separate ANN-classifier (ANN-33), which was used to analyze the enrichment cultures.

Estimation of Microbial Community Carbon Biomass Based on Cell Type Classification with CellCognize-Based Classifiers.

For the estimation of carbon biomass using CellCognize classifiers, the mean number of classified events for each of the standard classes was first multiplied with the average carbon-mass per cell of the corresponding standard (estimated as described below; Table 5). Then the carbon biomasses of all standard classes were summed up to obtain the total carbon biomass of the community at a certain time point. Upper and lower boundaries were calculated in the same way, but by taking the mean plus or minus the measured standard cell carbon biomass, respectively. Estimates of community biomass were compared with values obtained from ¹⁴C-substrate incorporation.

For estimating the average carbon mass of a cell of each standard, cell volumes of each strain and bead standard individually in solution with a density of 10⁷ particles or cells per ml were measured by using a 3D cell explorer microscope (Nanolive). A 60× objective (λ=520 nm), light intensity (0.2 mW mm⁻²) was used for imaging with a resolution of Δxy=200 nm; Δz=400 nm and a field of view of 85×85×30 μm. At least five randomly selected fields were examined. Nanolive's STEWE software with the Image J plugin was deployed to segment particles on images and to calculate the average biovolume per cell per standard (FIG. 2). The average standard carbon mass was then calculated from the corresponding volume using the allometric formula as proposed by Loferer-Krossbacher (1998), Appl Environ Microbiol 64, 688-694: m_{b}=435*V^{0.86}, where V represents the measured average volume (μm³) and m_{b} the calculated (dry weight) biomass (fg). This value was divided by two to obtain the carbon mass per cell (the carbon mass is assumed to be 50% of the total biomass), which was then compared to the ¹⁴C-substrate incorporation.

TABLE 5
Estimated biovolumes and carbon dry weights
of the strain and bead standards

| | | | Biovolume | Biomass (fg |
|---|---|---|---|---|
| Standard | | Abbreviation | (μm³) | C) |
| Acinetobacter johnsonii | | ATJ | 0.32 ± 0.06 | 82 ± 13 |
| Acinetobacter tjernbergiae | | ATJ | 0.38 ± 0.04 | 95 ± 9 |
| Arthrobacter | | ACH | 0.13 ± 0.05 | 38 ± 12 |
| chlorophenolicus | | | | |
| Bacillus subtilis | | BST | 0.49 ± 0.28 | 118 ± 56 |
| Caulobacter crescentus | | CCR | 0.53 ± 0.09 | 126 ± 18 |
| Cryptococcus albidus | | CAL | 5.89 ± 0.05 | 999 ± 7 |
| Escherichia coli | | ECL | 0.37 ± 0.05 | 92 ± 11 |
| Lactococcus lactis | | LLC | 0.4 ± 0.05 | 99 ± 11 |
| Pseudomonas knackmussii | | PKM | 0.23 ± 0.05 | 61 ± 11 |
| Pseudomonas migulae | | PMG | 0.39 ± 0.08 | 97 ± 17 |
| Pseudomonas putida | | PPU | 0.3 ± 0.06 | 77 ± 13 |
| Pseudomonas veronii | | PVE | 0.76 ± 0.23 | 172 ± 44 |
| Sphingomonas wittichii | | SWT | 0.3 ± 0.16 | 77 ± 34 |
| Sphingomonas yanoikuyae | | SYN | 0.24 ± 0.03 | 64 ± 7 |
| 0.2 | μm bead | B02 | 0.12 ± 0.04 | 35 ± 10 |
| 0.5 | μm bead | B05 | 0.46 ± 0.31 | 112 ± 62 |
| 1 | μm bead | B1 | 0.60 ± 0.40 | 140 ± 77 |
| 2 | μm bead | B2 | 2.0 ± 1.0 | 395 ± 165 |
| 4 | μm bead | B4 | 3.0 ± 1.0 | 559 ± 157 |
| 6 | μm bead | B6 | 7.0 ± 1.0 | 1159 ± 141 |
| 10 | μm bead | B10 | 21 ± 5.0 | 2982 ± 601 |
| 15 | μm bead | B15 | 53 ± 2.0 | 6612 ± 214 |

### Example 8. Predicted Classification of C. scindens in a Diverse Background of Soil Bacteria

In order to show that CellCognize can be further developed for any target strain from other microbiota, FCM signatures of pure Clostridium scindens cultures stained with SYBR Green I at exponential growth (EXPO) or stationary phase (STAT) were captured (i.e. 7 FCM parameters). These signatures were combined with the signatures of the previously used 32 standard classes as described in Example 1 to produce as described in Example 1 a new CellCognize-based classifier with 34 classes.

C. scindens (Cs) cells from the stationary phase was then experimentally mixed in vitro with a background of 21 different soil bacteria (selected from Microbacterium sp. PAMC 28756, Mucilaginibacter pineti, Curtobacterium pusillum, Variovorax paradoxus, Flavobacterium pectinovorum DSM 6368, Cellulomonas xylanilytica, Tardiphaga sp. vice352, Devosia riboflavina, Mesorhizobium amorphae CCNWGS0123, Burkholderia sp. OLGA172, Pseudomonas koreensis strain D26 or Pseudomonas fluorescens, Luteibacter rhizovicinus DSM 16549 strain, Chitinophaga pinensis DSM 2588, Lysobacter capsici strain KNU-14, Pseudomonas sp. CFSAN084952, Rhodococcus fascians D188, Caulobacter sp. Ji-3-8, Cohnella sp. HS21, Rahnella sp. Y9602, Phenylobacterium zucineum HLK1, Bradyrhizobium betae strain PL7HG1) at approximately 10:1 ratio of cell numbers (total C. scindens vs. total soil bacteria). Both pure and mixed cultures were classified by the 34-standard classifier (FIG. 12). Even with only 7-FCM parameters, the FCM profiles of Cs cultures were distinguishable from the soil bacteria and the ANN classifier correctly predicted the regrown C. scindens physiology with 57% for EXPO and 43% for STAT cells. FIG. 12 bottom panel further shows that Cs STAT cells were in majority correctly predicted (51%) amidst a mixture of diverse soil bacterial cells.

### Example 9. Supplementary Methods

Relevant files can be found on: Zenodo.org; DOI: 10.5281/zenodo.3822094

Section 1. Data Pretreatment

1.1 Filtering of FCM Data

% path: Files_for_Zenodo/FCM_files
load(‘final_file_merged_2019.mat’);
This file has the combined FCM data of the 22 used standards (8 beads, 14
microbial pure cultures) as in Table 5. Order of the data is:
Merged
22
1=B02
2=B05
3=B1
4=B10
5=B15
6=B2
7=B4
8=B6
9=AJH
10=ATJ
11=ACH
12=BST
13=CCR
14=CAL
15=ECL
16=LLC
17=PKM
18=PMG
19=PPT
20=PVR
21=SWT
22=SYN
Filter the files to within the lower and upper boundary thresholds, for each of the
seven FCM channels. Order of the FCM channels in the files is:
Column 1= FSC-H
Column 2= SSC-H
Column 3= FITC-H
Column 4= FSC-A
Column 5= SSC-A
Column 6= FITC-A
Column 7= Width
Define the min and maxdata values for the filtering.
mindata1=100;
maxdata1=4000000;
mindata2=100;
maxdata2=4000000;
mindata3=100;
maxdata3=500000;
mindata4=100;
maxdata4=2000000;
mindata5=100;
maxdata5=2000000;
mindata6=100;
maxdata6=1000000;
mindata7=10;
maxdata7=2000;
for i=1:22 final_files1=final_files{i};
final_files1_filtered=final_files1(final_files1(:,1)<maxdata1,:);
final_files1_filtered=final_files1_filtered(final_files1_filtered(:,1)>mindata1,:);
final_files1_filtered=final_files1_filtered(final_files1_filtered(:,2)<maxdata2,:);
final_files1_filtered=final_files1_filtered(final_files1_filtered(:,2)>mindata2,:);
final_files1_filtered=final_files1_filtered(final_files1_filtered(:,3)<maxdata3,:);
final_files1_filtered=final_files1_filtered(final_files1_filtered(:,3)>mindata3,:);
final_files1_filtered=final_files1_filtered(final_files1_filtered(:,4)<maxdata4,:);
final_files1_filtered=final_files1_filtered(final_files1_filtered(:,4)>mindata4,:);
final_files1_filtered=final_files1_filtered(final_files1_filtered(:,5)<maxdata5,:);
final_files1_filtered=final_files1_filtered(final_files1_filtered(:,5)>mindata5,:);
final_files1_filtered=final_files1_filtered(final_files1_filtered(:,6)<maxdata6,:);
final_files1_filtered=final_files1_filtered(final_files1_filtered(:,6)>mindata6,:);
final_files1_filtered=final_files1_filtered(final_files1_filtered(:,7)<maxdata7,:);
final_files1_filtered=final_files1_filtered(final_files1_filtered(:,7)>mindata7,:);
Do the log10-transformation for each column specifically.
scales1=log10(final_files1_filtered(:,1));
scales2=log10(final_files1_filtered(:,2));
scales3=log10(final_files1_filtered(:,3));
scales4=log10(final_files1_filtered(:,4));
scales5=log10(final_files1_filtered(:,5));
scales6=log10(final_files1_filtered(:,6));
scales7=log10(final_files1_filtered(:,7));
Regroup the columns back into one file.
scales=horzcat(scales1,scales2,scales3,scales4,scales5,scales6, scales7);
standard{i}=scales;
end;

1.2 Gating

Gate the different standards to either individual or multiple subpopulations, depending on the 2D plot aspect of FCS-H vs SSC-H vs FITC-H (example in FIG. 3). Bead standards do not require further gating.

%Rename the bead standards
B02=standard{1};
B05=standard{2};
B1=standard{3};
B10=standard{4};
B15=standard{5};
B2=standard{6};
B4=standard{7};
B6=standard{8};
%gating AJH1, example
S9=((standard{9}(:,1)>3.8) & (standard{9}(:,1)<4.8) & (standard{9}(:,2)>2.5)&
(standard{9}(:,2)< 3.3) & (standard{9}(:,3)>4.5) & (standard{9}(:,3)<5));
S9=repelem(S9,1,7);
AJH1=standard{9}(S9);
AJH1=reshape(AJH1,[ ],7);
%gating AJH2
S9=((standard{9}(:,1)>3.8) & (standard{9}(:,1)<4.8) & (standard{9}(:,2)>3.2)&
(standard{9}(:,2)< 4.0) & (standard{9}(:,3)>5) & (standard{9}(:,3)<5.5));
S9=repelem(S9,1,7);
AJH2=standard{9}(S9);
AJH2=reshape(AJH2,[ ],7);
%gate all others, as desired. Complete gated output file, seebelow.
Add the four separate E. coli standards from exponential and stationary phase,
and grown on different media (see Section 3.5)
%path:
/Files_for_Zenodo/FCM_files
load(′ALL_ECOLI_LOG.mat′);
%has log-transformed data
% gate the Ecoli files, as desired, for example ECL_EXP1
S1=((standard{1}(:,1)>3.0) & (standard{1}(:,1)<4.0) & (standard{1}(:,2)>3.0)&
(standard{1}(:,2)< 3.6) & (standard{1}(:,3)>3.2) & (standard{1}(:,3)<4.4));
S1=repelem(S1,1,7);
ECL_EXP1=standard{1}(S1);
ECL_EXP1=reshape(ECL_EXP1,[ ],7);
% repeat for all, if necessary
The ECL subpopulations 1 and 2 in exponential growth conditions are not further
included, because their relative abundance was below 5%.
Now combine the filtered gated standard files into one. This is the 32-standard
input file for the ANN model.
filtered_standards={B02,B05,B1,B10,B15,B2,B4,B6,AJH1,AJH2,ATJ1,ATJ2,ACH1,ACH2,ACH3,BST1,
BST2,
CCR1,CCR2,CAL,ECL_EXP3,ECL_STAT_LB,ECL_STAT_MM,ECL,LLC,PKM1,PMG,PPT,PVR1
,PVR2,SWT,SYN};
%file saved as ‘filtered_standards_32.mat’

Section 2. Artificial Neural Network Reconstruction.

2.1 Subsampling and Anchoring

Data were first randomly subsampled to same number of events. File array name from previous scaling was ‘filtered_standards’.

%path
/Files_for_Zenodo/FCM_files load
‘filtered_standards_32.mat’
standard_normz=[ ];
sample_size=20000;
for i=1:length(filtered_standards)
standard_normz{i,1}=datasample(filtered_standards{1,i},sample_size,1);
end;
standard_normz=standard_normz’;
%alternatively: subsample to n = 5000. This file is saved as
‘standard_normz_restricted_32.mat’ for section 3.7
Add the line with the anchors for proper and consistent scaling throughout all data
sets.
anchors=[2,2,2,2,2,2,1;6.6,6.6,5.7,6.3,6.3,6.0,3.3];
standard_normz{1}=vertcat(anchors,standard_normz{1});

2.2 ANN Selection, Training and Validation

Continue ANN with subsampled data set (standard_normz); here 20000 events per standard.

file_length_final=cellfun(@length, standard_normz);
file_size=file_length_final;
file_length_final=[1 file_length_final];
file_length_final=cumsum(file_length_final);
input=vertcat(standard_normz{:});
output=zeros(length(input),length(standard_normz)); for
i=1:length(file_length_final)−1
output(file_length_final(i):file_length_final(i+1)−1,i)=1; end
input=input’;
output=output’;
x = input; t
= output;
Choose a Training Function
trainFon = ‘trainscg’; % Scaled conjugate gradient backpropagation.
Create a Pattern Recognition Network
hiddenLayerSize = 20;
net = patternnet(hiddenLayerSize);
Setup Division of Data for Training, Validation, Testing
net.divideFon = ‘dividerand’; % Divide data randomly
net.divideMode = ‘sample’; % Divide up every sample
net.divideParam.trainRatio = 50/100;
net.divideParam.valRatio = 25/100;
net.divideParam.testRatio = 25/100;
Choose a Performance Function
For a list of all performance functions type: help nnperformance
net.performFcn = ‘crossentropy’; % Cross-Entropy
Choose Plot Functions
net.plotFons = {‘plotperform’,‘plottrainstate’,‘ploterrhist’, ...
‘plotconfusion’, ‘plotroc’};
Train the Network
[net,tr] = train(net,x,t);
Test the Network
y = net(x);
e = gsubtract(t,y);
performance = perform(net,t,y); tind = vec2ind(t);
yind = vec2ind(y);
percentErrors = sum(tind ~= yind)/numel(tind);
Recalculate Training, Validation and Test Performance
trainTargets = t .* tr.trainMask{1};
valTargets = t .* tr.valMask{1};
testTargets = t .* tr.testMask{1};
trainPerformance = perform(net,trainTargets,y)
valPerformance = perform(net,valTargets,y)
testPerformance = perform(net,testTargets,y)
figure, plotconfusion(t,y)
genFunction(net,‘GIVE_FILE_NAME’);
The section 2.1 and 2.2 process was repeated five times starting from the random
subsampling, to generate five independent NN-classifier functions.
Example classifier
/Files_for_Zenodo/NN_file_example/NNfunction_wide_anchor_normz_filtered_26
0619.m

Section 3. CeliCognize Testing of Standard-Mixed Communities.

In a first proof-of-concept experiment, we cultured E. coli MG1655, P. veronii and A. johnsonii individually to stationary phase, diluted cultures 1:1000 in PBS, and measured cells by FCM after staining with Sybr Green I either individually, or in different mixtures of all three strains combined. Individual and mixture data sets were analyzed with CellCognize using a set of five replicate ANN-5 classifiers, comparing expected added cell numbers of each of the three strains with their assigned class attributions from the ANN-5 classifiers.

3.1 Preparing a Limited ANN with Five Standards Only.

% data import. Read filtered, log-transformed and gated E. coli, P. veronii and A.
johnsonii data files. This has five datasets
%path: /Files_for_Zenodo/FCM_files/MIX_experiment_ACL_AJH_PVR/
filtered_standards_AJH_ECL_PVE.mat
filtered_standards={AJH1,ECL1,ECL2,PVR1,PVR2};

Continue training, validating and testing ANN-5 with subsampled data set; here 5000 events per sample; as in sections 2.1 and 2.2

Example Output Classifier File Saved as

/Files_for_Zenodo/NN_file_example/NNfunction_wide_anchor_normz_filtered_tri mix_310819.m

3.2 Analyze the synthetic community mixtures.

%Read in and treat data files of either cultures alone, or in combinations. Same folder:
/Files_for_Zenodo/FCM_files/MIX_experiment_ACL_AJH_PVR
%as example: combination of 30/10/10 ECL/AJH/PVE
LWECO1=readtable(‘Specimen2_A6_EAP30-10-10-1.csv’);
LWECO1=table2array(LWECO1);
LWECO2=readtable(‘Specimen2_B6_EAP30-10-10-2.csv’);
LWECO2=table2array(LWECO2);
LWECO3=readtable(‘Specimen2_C6_EAP30-10-10-3.csv’);
LWECO3=table2array(LWECO3);
LWECO4=readtable(‘Specimen2_D6_EAP30-10-10-4.csv’);
LWECO4=table2array(LWECO4);
community_combined=vertcat(LWECO1,LWECO2,LWECO3,LWECO4);
%has 8 columns, remove column 8 community_combined(:,8)=[ ];
%filtering and log-transformation as in section 1.1
%regroup the columns back into one file
input_community=horzcat(scales1,scales2,scales3,scales4,scales5,scales6,scales7);
%add anchor line
anchors=[2,2,2,2,2,2,1;6.6,6.6,5.7,6.3,6.3,6.0,3.3];
input_community=vertcat(anchors,input_community);
%transpose numeric array to be conform to NN input input_community=input_community’;
%run NN functions without thresholding
% vec2ind means that the index of the row is find where the value of 1 occurs. In this table it is
the value that is rounded up to 1!
%make a table with the classes (1-5), a ‘0’ (for the non-classified) - and one extra (33) that works
as an anchor to fill the list properly.
classes=(0:6); empty_class=[6;0];
%NN function (1) output_restricted_anchor1=
NNfunction_wide_anchor_normz_filtered_trimix_310819(input_community); %available in
example
output_restricted_anchor_final1=vec2ind(output_restricted_anchor1);
membership_restricted1 =
histc(output_restricted_anchor_final1,unique(output_restricted_anchor_final1));
classes_restricted1=unique(output_restricted_anchor_final1); final_community1=
[classes_restricted1;membership_restricted1];
%now add the empty class to the final community finalComm1=[final_community1,empty_class];
%apply a logical function to find corresponding values in the list with all categories in the file
‘classes’
[lic,loc]=ismember(classes,finalComm1(1,:));
results1(2,lic)=finalComm1(2,loc(lic));
results1(1,:)=classes;
%produce final summary community and save as .csv. Modify the path if necessary.
final_results=vertcat(results1);
T=array2table(final_results’,‘VariableNames’,{‘Class1’,‘Count1’});
%write results to table, as example:
writetable(T,‘FILE_NAME.csv’);

3.3. Analysis of FIG. 4a.

Four replicates of each strain individually diluted were measured on FCM and this datafile was then analyzed by the ANN-5 classifier. Output categories were summed and the proportion of the correct classification prediction was calculated. For example, the percent correct classification of pure E. coli by the ANN-5 was 86% (=ECL1+ECL2 in Table 3.3.1).

TABLE 3.3.1
Example output and recovery calculation from the ANN-5
classifier for the pure culture E. coli data set.

| | | | Mean Class | |
|---|---|---|---|---|
| ANN5_Class | | | Assignment | Percent |
| attribution | Class | Count in class | Probability | Recovery |
| 1 | AJH | 419 | 0.369205176 | 0.01 |
| 2 | ECL1 | 10531 | 0.750591042 | 0.23 |
| 3 | ECL2 | 28760 | 0.82239543 | 0.63 |
| 4 | PVR1 | 2289 | 0.329680958 | 0.05 |
| 5 | PVR2 | 3559 | 0.395254884 | 0.08 |
| sum | | 45558 | | |

Four different mixtures were prepared of the three strain suspensions. These were again measured on four individual replicates, which were combined and classified with the ANN-5 classifier. These attributions were then compared to the actual expected cell numbers measured from the individual strains multiplied by the dilution factors.

TABLE 3.3.2
Actual and expected cell attributions in synthetic mixtures of three strains.

| | Percent | Percent | Percent | Percent | | Percent | |
|---|---|---|---|---|---|---|---|
| | of total | of total | of total | of total | Percent | of total | Percent |
| Class | AJH alone | ECL alone | PVR alone | EAP10-10-10 | expected | EAP10-10-30 | expected |
| AJH | 87.67% | 0.92% | 11.31% | 42.56% | 113.7 | 31.37% | 104.5 |
| ECL1 | 0.20% | 23.12% | 3.50% | 9.29% | 95.7^{a} | 8.63% | 109.0^{a} |
| ECL2 | 1.13% | 63.13% | 9.77% | 25.87% | | 23.47% | |
| PVR1 | 10.51% | 5.02% | 9.68% | 9.49% | 116.1^{a} | 11.99% | 79.2^{a} |
| PVR2 | 0.48% | 7.81% | 65.74% | 12.79% | | 24.53% | |
| #cells | 46446 | 45558 | 23793 | 124026 | | 154725 | |
| mixture | 10 μl AJH | 10 μl ECL | 10 μl PVR | 10 μl ECL | | 10 μl ECL | |
| | in 1 ml | in 1 ml | in 1 ml | 10 μl AJH | | 10 μl AJH | |
| | | | | 10 μl PVR | | 30 μl PVR | |
| | | | | in 1 ml | | in 1 ml | |

| | Percent | | Percent of | |
|---|---|---|---|---|
| | of total | Percent | total | Percent |
| Class | EAP10-30-10 | expected | EAP30-10-10 | expected |
| AJH | 61.91% | 92.7 | 22.82% | 101.6 |
| ECL1 | 5.32% | 91.7^{a} | 15.39% | 86.5^{a} |
| ECL2 | 14.70% | | 41.74% | |
| PVR1 | 11.03% | 158.5^{a} | 8.90% | 174.4^{a} |
| PVR2 | 7.04% | | 11.16% | |
| #cells | 231478 | | 226426 | |
| mixture | 10 μl ECL | | 30 μl ECL | |
| | 30 μl AJH | | 10 μl AJH | |
| | 10 μl PVR | | 10 μl PVR | |
| | in 1 ml | | in 1 ml | |

^{a}ECL = ECL1 + ECL2, PVR = PVR1 + PVR2

3.4 PCA Analysis of FIG. 4b.

For PCA analysis, we used the filtered and gated data set of the 32 standards and their subpopulations (from section 1.2 above). This was transformed into a single matrix, with columns being the different standards, and rows being the concatenated 7 flow cytometry variables (subsampled for n=20,000), one underneath each other (FSC-H, SSC-H, FITC-H, FSC-A, SSC-A, FITC-A and width).

%take the file standard_normz from section 1.2
% remove the anchoring lines in cell 1 standard_normz{1}(1:2,:)=[ ];
for i=1:32;
strain=vertcat(standard_normz{i}(:,1),standard_normz{i}(:,2),standard_normz{i}(:,3),standard_{—}
normz{i}(:,4), standard_normz{i}(:,5),standard_normz{i}(:,6),standard_normz{i}(:,7));
if i==1; strainm=strain; strain=[ ];
else strainm=horzcat(strainm,strain); strain=[ ];
end
end;
%strainm is now a 140 000 x 32 double
%doing regular PCA
[coeff,score,latent,tsquared,explained,mu]=pca(strainm);
fig=scatter(coeff(:, 1),coeff(:,2));
%save output file ‘GIVE_NAME.pdf’
Explained:
First dimension: 69.1327
Second dimension: 26.3605
Third dimension: 1.5639

3.5 Analysis of FIG. 4d.

In order to evaluate whether CellCognize could distinguish different cell physiologies, we classified FCM datasets of all four E. coli standards (representing different strains, culture media, and cell growth phases) individually (randomly subsampled to n=20,000 cells) or as an in silico mixture with n=5000 cells of each, using the five ANN-32 classifiers.

Individual Class Assignments:

E. coli MG1655 was cultured independently on LB or M9-CAA medium to exponential phase (OD=0.5) and to stationary phase (OD=2). Cultures were diluted in artificial lake water at 10⁻⁴, 10⁻⁵, and 10⁻⁶, stained and individually measured in two technical replicates on FCM. Data were extracted, filtered, log-transformed and anchored as described above, and analyzed with the five ANN-32 classifiers for standard class attributions.

Filtering, gating and log-transforming the datasets:
% Prepare Eco DH5a standard (ECL), filtering, log-transformation and
gating as in Sections 1.1 and 1.2
%final file has four Ecoli standards
% 1 = exponential phase MM, for MG1655
% 2 = Stationary phase LB, for MG1655
% 3 = Stationary phase MM, for MG1655
% 4 = Stationary phase LB, for DH5alpha
ECL_ALL={ECL_EXP,ECL_STAT_LB,ECL_STAT_MM,ECL};
% file saved as ALL_ECOLI_LOG.mat

3.6 Run ANN-32 Classifications

%for each of the four individual datasets load(‘ALL_ECOLI_LOG.mat’)
input_community=ECL_ALL{4};
%add anchor line anchors=[2,2,2,2,2,2,1;6.6,6.6,5.7,6.3,6.3,6.0,3.3];
input_community=vertcat(anchors,input_community);
%transpose numeric array to be conform to NN input input_community=input_community’;
% vec2ind means that the index of the row is find where the value of 1 occurs. In this table it is
the value that is rounded up to 1!
% change path to the folder with the NN functions are in/NN_file_example
%make a table with the classes (1-32), a ‘0’ (for the non-classified) - and one extra (33) that
works as an anchor to fill the list properly (...)
classes=(0:33); empty_class=[33;0];
%NN function (1)
output_restricted_anchor1= NNfunction_wide_anchor_normz_filtered_260619(input_community);
output_restricted_anchor_final1=vec2ind(output_restricted_anchor1);
membership_restricted1 =
histc(output_restricted_anchor_final1,unique(output_restricted_anchor_final1));
classes_restricted1=unique(output_restricted_anchor_final1); final_community1=
[classes_restricted1;membership_restricted1];
%now add the empty class to the final community finalComm1=[final_community1,empty_class];
%apply a logical function to find corresponding values in the list with all categories in the file
‘classes’
[lic,loc]=ismember(classes,finalComm1(1,:));
results1(2,lic)=finalComm1(2,loc(lic));
results1(1,:)=classes;
% run more NN functions as desired or available
%produce a final summary community and save as .csv.
final_results=vertcat(results1);
T=array2table(final_results’,‘VariableNames’,{‘Class1’,‘Count1’});
%write results to table. writetable(T,‘output.csv’);

3.7 In-Silico Mixture of Four E. coli Strains with Lake Water Background.

%%%Lake water FCM files load(‘lakewaterlinear.mat’)
% is combined file of Specimen1_E1 to Specimen1_E4 in the samefolder
%has 7 columns
%do the filtering and log-transformations as in section 1.1
%regroup the columns back into one file
input_community=horzcat(scales1,scales2,scales3,scales4,scales5,scales6,scales7);
%% change path. Retrieve the four E. coli filtered and gated standards.
load(‘standard_normz_restricted_32.mat’)
%This file has the filtered and gated, subsampled n = 5000 standard sets. Without that file, take
the one that is the output of section 2.1.
MG_EXP3=standard_normz{21};
MG_STAT_LB=standard_normz{22};
MG_STAT_MM=standard_normz{23};
DH=standard_normz{24};
anchors=[2,2,2,2,2,2,1;6.6,6.6,5.7,6.3,6.3,6.0,3.3];
input_community=vertcat(anchors,MG_EXP3,MG_STAT_LB,MG_STAT_MM,DH,input_community);
input_community=input_community’;
% change to path with example NN functions /NN_file_example
%make a table with the classes (1-32), a ‘0’ (for the non-classified) - and one extra (33) that
works as an anchor to fill the list properly (...)
classes=(0:33); empty_class=[33;0];
%NN function (1)
output_restricted_anchor1= NNfunction_wide_anchor_normz_filtered_260619(input_community);
max_probability=max(output_restricted_anchor1);
output_restricted_anchor_final1=vec2ind(output_restricted_anchor1);
membership_restricted1 =
histc(output_restricted_anchor_final1,unique(output_restricted_anchor_final1));
classes_restricted1=unique(output_restricted_anchor_final1); final_community1=
[classes_restricted1;membership_restricted1];
%now add the empty class to the final community finalComm1=[final_community1,empty_class];
%apply a logical function to find corresponding values in the list with all categories in the file
‘classes’
[lic,loc]=ismember(classes,finalComm1(1,:)); results1(2,lic)=finalComm1(2,loc(lic));
results1(1,:)=classes;
for i=1:25038;
A=output_restricted_anchor1(:,i); C=max_probability(:,i);
A(A<C)=0;
output_restricted_anchor1(:,i)=A;
end
prop_MG_EXP3_1=numel(nonzeros(output_restricted_anchor1(21,(2:5002))));
prop_MG_STAT_LB_1=numel(nonzeros(output_restricted_anchor1(22,(5003:10003))));
prop_MG_STAT_MM_1=numel(nonzeros(output_restricted_anchor1(23,(10003:15003))));
prop_DH_1=numel(nonzeros(output_restricted_anchor1(24,(15003:20003))));
prop1=[prop_MG_EXP3_1,prop_MG_STAT_LB_1,prop_MG_STAT_MM_1,prop_DH_1];
% run more NN functions as desired o as available
%produce final summary community and save as .csv.
final_results=vertcat(results1);
T=array2table(final_results’,‘VariableNames’,{‘Class1’,‘Count1’});
final_proportions=vertcat(prop1);
writetable(T,‘OUTPUT.csv’);

Calculate the mean assigned proportions to the E. coli classes (in the table T) and compare to the mean of the true (known) values of their final proportions.

3.8 Analysis of FIG. 4e: Class Attribution of Aquatic Microbial Community.

An aquatic microbial community from Lake Geneva was recovered from 2 L of lake water, sampled at 1 m depth at a site close to the shore in Saint-Sulpice (46.517□N, 6.579□E), and used as an unknown background microbial community. Debris was removed by filtering the lake water through a nylon cell strainer with 40-μm pore size (Falcon, USA). Bacterial cells were then collected from the filtrate using a 0.2-μm pore size polyethersulfone membrane filter (Sartorius, Switzerland). The filter with the cells was resuspended during 2 h in artificial lake water mineral medium (ALW; containing, per L, 36.4 mg CaCl₂·2H₂O, 0.25 mg FeCl₃·6H₂O, 112.5 mg MgSO₄·7H₂O, 43.5 mg K₂HPO₄, 17 mg KH₂PO₄, 33.4 mg Na₂HPO₄·2H₂O, and 25 mg NH₄NO₃). Cell density in the ALW microbial suspension was then quantified and diluted to 10′ cells per ml. The diluted samples were stained with SYBR

Green I for 30 min in the dark, and then measured in FCM, in three biological replicates, each with two technical replicates. FCM data were exported as .csv format, merged, filtered between lower and upper boundaries, and log-transformed for each of the seven FCM parameters as described above. The same two (low and high) anchor values per FCM parameter were then added to the dataset to ensure its proper ‘positioning’ during the ANN classifier computation. The lake water microbial community data were analyzed alone (n=5039 cells), and also after being merged in silico with each of the 32 standards individually, randomly subsampled (n=5000) for that purpose.

Datasets were then classified using each of the five ANN-32 classifiers, in order to attribute all events to the predefined standard classes. In a further test, randomly subsampled FCM datasets (n=5000) of three standards each (AJH1, MG_STAT_MM and PVR1) were merged in silico with the lake water community (n=5039 cells) and reclassified using the ANN-32 classifiers. The recovery rate was calculated as the ratio of the number of cells from the standard attributed to its own class and the in silico added number. The mean probability and probability distribution of attribution were calculated for those particles assigned to each class (for example, in FIG. 9b).

%read in Lakewater data sets load(‘lakewaterlinear.mat’)
%do the filtering and log transformation as in section 1.1
%regroup the columns back into one file
input_community=horzcat(scales1,scales2,scales3,scales4,scales5,scales6,scales7);
% add anchor line anchors=[2,2,2,2,2,2,1;6.6,6.6,5.7,6.3,6.3,6.0,3.3];
input_community=vertcat(anchors,input_community);
%transpose numeric array to be conform to NN input input_community=input_community’;

Follow the ANN-32 classification as in section 3.6 to produce an output table with the class assignments. Calculate mean and standard deviation as in FIG. 4a, top panel.

3.9 In Silico Mixing Three Standards into Lake Water and Back-Tracing. FIG. 4e Lower Panel.

%%%
load(‘lakewaterlinear.mat’)
%has 7 columns
%do the filtering and log transformation as in Section 1.1
%regroup the columns back into one file
input_community=horzcat(scales1,scales2,scales3,scales4,scales5,scales6,scales7);
%%Load the files of the filtered, gated, log-transformed and subsampled pure culture standards.
%%
load(‘standard_normz_restricted_32.mat’)
% from section 2.1; this has a set of subsampled n = 5000 individual standards
AJH1=standard_normz{9};
ECL=standard_normz{23}; PVR1=standard_normz{29};
%add anchors and mix with lakewater community into a single file
anchors=[2,2,2,2,2,2,1;6.6,6.6,5.7,6.3,6.3,6.0,3.3];
input_community=vertcat(anchors,AJH1,ECL,PVR1,input_community);
input_community=input_community’;
% NN example function in /NN_file_example
%make a table with the classes (1-32), a ‘0’ (for the non-classified) - and one extra (33) that
works as an anchor to fill the list properly (...)
classes=(0:33); empty_class=[33;0];
%NN function (1)
output_restricted_anchor1= NNfunction_wide_anchor_normz_filtered_260619(input_community);
max_probability=max(output_restricted_anchor1);
output_restricted_anchor_final1=vec2ind(output_restricted_anchor1);
membership_restricted1 =
histc(output_restricted_anchor_final1,unique(output_restricted_anchor_final1));
classes_restricted1=unique(output_restricted_anchor_final1); final_community1=
[classes_restricted1;membership_restricted1];
%now add the empty class to the final community finalComm1=[final_community1,empty_class];
%apply a logical function to find corresponding values in the list with all categories in the file
‘classes’
[lic,loc]=ismember(classes,finalComm1(1,:)); results1(2,lic)=finalComm1(2,loc(lic));
results1(1,:)=classes;
for i=1:20038;
A=output_restricted_anchor1(:,i); C=max_probability(:,i);
A(A<C)=0;
output_restricted_anchor1(:,i)=A;
end
prop_AJH_1=numel(nonzeros(output_restricted_anchor1(9,(2:5002))));
prop_ECL_1=numel(nonzeros(output_restricted_anchor1(23,(5003:10003))));
prop_PVR_1=numel(nonzeros(output_restricted_anchor1(29,(10003:15003))));
prop1=[prop_AJH_1,prop_ECL_1,prop_PVR_1];
% run more NN functions as desired or as available
% produce final summary community and save as .csv.
final_results=vertcat(results1);
T=array2table(final_results’,‘VariableNames’,{‘Class1’,‘Count1’});
final_proportions=vertcat(prop1);
writetable(T,‘OUTPUT.csv’);

Recovery rates were calculated as the mean percentage of each standard attributed to its own class versus the true added numbers.

3.10 FIG. 4f Analysis.

The performance of ANN-32 classifiers was further evaluated by mixing stationary phase-grown E. coli into the filtered lake water microbial community samples. E. coli MG1655 was cultured either on LB or on M9-CAA. Cells were counted in stationary phase samples, diluted in artificial lake water, and added as 1.0×10⁴ or 1.0×10⁵ cells ml⁻¹ to the lake water community. Mixtures were stained and measured on FCM for comparison with lake water microbial community samples alone.

%read in individual FCM files of Ecoli in LW, all dilutions 10e−4, 10e−5, 10e−6;
both media LB and MM separately.
%path:Ecoli_Lakewater/Lake_water_mixed_Ecoli/LB_medium
%Clean and filter data sets to properly count all events. Example:
LWECO1=readtable(‘100000cells.csv’);
LWECO1=table2array(LWECO1);
LWECO2=readtable(‘100000cells(1).csv’);
LWECO2=table2array(LWECO2);
community_combined=vertcat(LWECO1,LWECO2);
%remove 8th columns community_combined(:,8)=[ ];
%do the filtering and log transformation as in section 1.1
%regroup the columns back into one file
input_community=horzcat(scales1,scales2,scales3,scales4,scales5,scales6,scales7);
%%number of elements in this file = 5885
%% repeat for all files
%%Classify all datasets per condition, grouped across replicates, using the ANN-32
classifier as in Section 3.6 above.

Calculate percent recovery as the classified number of cells to the appropriate category divided by the expected number of added cells.

TABLE 3.10.1
Recovery calculation of regrown E. coli mixed with lake water, classified using ANN-32.

| | | | | | | | | | #cells | | | |
|---|---|---|---|---|---|---|---|---|---|---|---|---|
| | | | | volume | total | | # cells | #cells | in ECL | vol | expected | |
| | | | | per | volume | #cells | in | in ECL- | per ml | added | #cells | % |
| | dilu- | | nr | analysis | per | per | class | class | minus | of ECL | per ml | recov- |
| Sample | tion | #cells | files | (ml) | analysis | ml | ECL | per ml | LW bg | (ml) | added | ery |
| LW background | | 5036 | 4 | 0.02 | 0.08 | 62950 | 204 | 2550 | | | | |
| ECL M9_CAA | 10⁻⁴ | 14750 | 1 | 0.02 | 0.02 | 737500 | | | | | | |
| | 10⁻³ | 118852 | 1 | 0.02 | 0.02 | 5942600 | | | | | | |
| | 10⁻² | 860521 | 1 | 0.02 | 0.02 | 43026050 | | | | | | |
| ECL_LB | 10⁻⁴ | 5308 | 1 | 0.02 | 0.02 | 265400 | | | | | | |
| | 10⁻³ | 39415 | 1 | 0.02 | 0.02 | 1970750 | | | | | | |
| | 10⁻² | 389269 | 1 | 0.02 | 0.02 | 19463450 | | | | | | |
| LWECO_LB1e-4 | | 3431 | 2 | 0.02 | 0.04 | 85775 | 337 | 8425 | 5875 | 0.05 | 13270 | 0.44 |
| LWECO_LB1e-5 | | 5887 | 2 | 0.02 | 0.04 | 147175 | 2305 | 57625 | 55075 | 0.05 | 98538 | 0.56 |
| LWECO_LB1e-6 | | 30870 | 2 | 0.02 | 0.04 | 771750 | 21781 | 544525 | 541975 | 0.05 | 973173 | 0.56 |
| LWECO_MM1e-4 | | 6080 | 2 | 0.02 | 0.04 | 152000 | 708 | 17700 | 15150 | 0.017 | 12538 | 1.21 |
| LWECO_MM1e-5 | | 8596 | 2 | 0.02 | 0.04 | 214900 | 3320 | 83000 | 80450 | 0.017 | 101024 | 0.80 |
| LWECO_MM1e-6 | | 43062 | 2 | 0.02 | 0.04 | 1076550 | 37772 | 944300 | 941750 | 0.017 | 731443 | 1.29 |

Section 4. Lake Water Microbial Community Enrichment

4.1 Analysis of FIG. 7c

open relevant files
%paths: /PHE_OCT_enrichments
%filter and log-transform as in section 1.1. Add anchors.
%classify with ANN-32 as in section 3.6
%take the mean and standard deviation. Plot in stack plot either as
absolute counts per ml or as relative counts normalized to the total number
of counted cells per sample as in panel b

CellCognize part on the left. See above for procedure on the relevant comparison files. 16S rRNA gene amplicon sequenced diversity on same samples on the right.

Section 5. Analysis of Similarity Scores Using CellCognize.

5.1 Calculate Mean Probabilities of Standards in their Class Attribution

Calculate mean probabilities of the attribution of standards to their own class. Use a subsampled (n=5000) dataset of all filtered and gated 32 standards. For each of the individual standards in that file, add the anchors, and classify using one of the classifier functions. Calculate the mean probabilities of attribution to the correct class across all rows, but only if they are above 0.1. Plot the mean probabilities as orange bar plot in FIG. 9a top panel.

%% calculate mean probabilities of the attribution of standards tothemselves.
%%
load(‘standard_normz_restricted_32.mat’) anchors=[2,2,2,2,2,2,1;6.6,6.6,5.7,6.3,6.3,6.0,3.3];
mean_probs=[ ]
for k=1:32
input_community=vertcat(anchors,standard_normz{k}); input_community=input_community’;
%when taking mean probabilities
output_restricted_anchor1= NNfunction_wide_anchor_normz_filtered_260619(input_community);
max_probability=max(output_restricted_anchor1);
output_restricted_anchor_final1=vec2ind(output_restricted_anchor1);
%take mean across all rows individually, only if they are bigger than 0.1 (can change this
number) and place in a new column
mean_h=zeros(32,1);
for i=1:32 h=output_restricted_anchor1(i,:); hl=h>0.1;
he=h(hl); mean_he=mean(he); mean_h(i)=mean_he;
end mean_probs{k}=mean_h;
end
m=[mean_probs{1} mean_probs{2} mean_probs{3} mean_probs{4} mean_probs{5}
mean_probs{6} mean_probs{7} mean_probs{8} mean_probs{9} mean_probs{10}
mean_probs{11} mean_probs{12} mean_probs{13} mean_probs{14} mean_probs{15}
mean_probs{16} mean_probs{17} mean_probs{18} mean_probs{19} mean_probs{20}
mean_probs{21} mean_probs{22} mean_probs{23} mean_probs{24} mean_probs{25}
mean_probs{26} mean_probs{27} mean_probs{28} mean_probs{29} mean_probs{30}
mean_probs{31} mean_probs{32}];
m_red=[m(1,1);m(2,2);m(3,3);m(4,4);m(5,5);m(6,6);m(7,7);m(8,8);m(9,9);m(10,10);m(11,11);m(12
,
12);m(13,13);m(14,14);m(15,15);m(16,16);m(17,17);m(18,18);m(19,19);m(20,20);m(21,21);m(22,
22)
;m(23,23);m(24,24);m(25,25);m(26,26);m(27,27);m(28,28);m(29,29);m(30,30);m(31,31);m(32,32)]
,
%%save as excel

5.2 Calculate Mean Probability Per Assigned Class in Lakewater.

Grey values in FIG. 9a top panel. Lower part of FIG. 9a is the assigned class attribution from the lakewater samples using the ANN-32 classifier.

%change path load(‘lakewaterlinear.mat’)
%has 7 columns
%do the filtering and log transformation as in section 1.1
%regroup the columns back into one file
input_community=horzcat(scales1,scales2,scales3,scales4,scales5,scales6,scales7);
anchors=[2,2,2,2,2,2,1;6.6,6.6,5.7,6.3,6.3,6.0,3.3];
input_community=vertcat(anchors,input_community);
%transpose numeric array to be conform to NN input input_community=input_community’;
%run NN function
%NN example in /NN_file_example
output_restricted_anchor1= NNfunction_wide_anchor_normz_filtered_260619(input_community);
max_probability=max(output_restricted_anchor1);
output_restricted_anchor_final1=vec2ind(output_restricted_anchor1);
%%retain maximum per assigned cell for i=1:5038;
A=output_restricted_anchor1(:,i);
C=max_probability(:,i); A(A<C)=0;
output_restricted_anchor1(:,i)=A;
end
%%take means for all classes for k=1:32
mean_class(k)=mean(nonzeros(output_restricted_anchor1(k,:))); mean_class=mean_class’;
end
%%save values of mean_class

5.3 Analysis of FIG. 9b. Probability Distributions

In FIG. 9b, the distribution of the assigned probability values per ‘event’ per selected class was plotted.

This is done here either for the community from lake water only, or from the lake water community data in silico mixed with data sets coming from the standards, or from the standards themselves. Reported means within panels are the simple mean of the retained values in the histograms.

%%%PART 2%%%
%%plot relevant attributed classes in the standard dataset above, forexample
%%class 1=B02
A=output_restricted_anchor1(1,:); B=A>0;
A=A(B);
FigH=figure; height=100; width=100; x0=10; y0=10;
p(1)=histogram(A,‘Normalization’,‘probability’); p(1).BinWidth=0.05;
set(gca,‘fontsize’,6) xlim([0,1]);
ylim([0,1]); set(gcf,‘position’,[x0,y0,width,height]); xlabel(‘Probability’, ‘FontSize’,6) ylabel(‘Density’,
‘FontSize’,6)
grid on filename=sprintf(‘GIVE_NAME%.4d.pdf’,1); title(filename);
saveas(FigH, filename,‘pdf’);
%%class 29=PVR
A=output_restricted_anchor1(29,:); B=A>0;
A=A(B);
FigH=figure; height=100; width=100;
x0=10; y0=10;
p(1)=histogram(A,‘Normalization’,‘probability’); p(1).BinWidth=0.05;
set(gca,‘fontsize’,6) xlim([0,1]);
ylim([0,1]); set(gcf,‘position’,[x0,y0,width,height]); xlabel(‘Probability’, ‘FontSize’,6) ylabel(‘Density’,
‘FontSize’,6)
grid on filename=sprintf(‘GIVE_NAME%.4d.pdf’,29); title(filename);
saveas(FigH, filename,‘pdf’);
%%CCR1 = 18
A=output_restricted_anchor1(18,:); B=A>0;
A=A(B);
FigH=figure; height=100; width=100; x0=10; y0=10;
p(1)=histogram(A,‘Normalization’,‘probability’); p(1).BinWidth=0.05;
set(gca,‘fontsize’,6) xlim([0,1]);
ylim([0,1]); set(gcf,‘position’,[x0,y0,width,height]); xlabel(‘Probability’, ‘FontSize’,6) ylabel(‘Density’,
‘FontSize’,6)
grid on filename=sprintf(‘GIVE_NAME%4d.pdf’,18); title(filename);
saveas(FigH, filename,‘pdf’);
%%14=ACH2
A=output_restricted_anchor1(14,:); B=A>0;
A=A(B);
FigH=figure; height=100; width=100; x0=10; y0=10;
p(1)=histogram(A, ‘Normalization’,‘probability’); p(1).BinWidth=0.05;
set(gca,‘fontsize’,6) xlim([0,1]);
ylim([0,1]); set(gcf,‘position’,[x0,y0, width,height]); xlabel(‘Probability’, ‘FontSize’,6) ylabel(‘Density’,
‘FontSize’,6)
grid on filename=sprintf(‘GIVE_NAME%.4d.pdf’,14); title(filename);
saveas(FigH, filename,‘pdf’);
%% repeat for any class or sample, or in silico analyzed mixture, as desired. For in silico mixing,
follow, for example, section 3.7 or 3.9

5.4 Analysis of FIG. 9c. Mean Class Attribution and Similarity Scores in the 1-Octanol Enriched Lake Water Community, Using the ANN-32 Classifiers.

Mean class attribution (absolute cell numbers) of the lake water enriched community on 1-octanol (n=536,783 cells), and of the pure culture isolate (OCT, n=63,824 cells) derived from this enrichment grown on 1-octanol, both after three days of incubation, for one of the ANN-32 classifiers and for a new classifier that was trained 759 using a dataset that in addition included FCM data from the OCT isolate itself (ANN-33). Numbers on the bars indicate the mean probability of class attribution.

Panels on the left part, analysis using the ANN-32 classifier.

% go to PHE_OCT_enrichments/PHE3_OCT1/T3/
LWECO1=readtable(′Specimen1_A6_10 C Octanol 1.csv′); LWECO1=table2array(LWECO1);
LWECO2=readtable(′Specimen1_B6_10 C Octanol 2.csv′); LWECO2=table2array(LWECO2);
LWECO3=readtable(′Specimen1_C6_10 C Octanol 3.csv′); LWECO3=table2array(LWECO3);
community_combined=vertcat(LWECO1,LWECO2,LWECO3);
%this has the concatenated OCT files from FCM, but not filtered norlog-transformed
%remove 8th columns
community_combined(:,8)=[ ];
%do the filtering and log transformation as in section 1.1
%regroup the columns back into one file
input_community=horzcat(scales1,scales2,scales3,scales4,scales5,scales6,scales7);
%add anchors
anchors=[2,2,2,2,2,2,1;6.6,6.6,5.7,6.3,6.3,6.0,3.3];
input_community=vertcat(anchors,input_community);
input_community=input_community′;
%%classify with the ANN32-standard classifier
%NN example in /NN_file_example
output_restricted_anchor1= NNfunction_wide_anchor_normz_filtered_260619(input_community);
max_probability=max(output_restricted_anchor1);
output_restricted_anchor_final1=vec2ind(output_restricted_anchor1);
%%calculate class attribution
classes=(0:33); empty_class=[33;0];
membership_restricted1 =
histc(output_restricted_anchor_final1,unique(output_restricted_anchor_final1));
classes_restricted1=unique(output_restricted_anchor_final1); final_community1=
[classes_restricted1;membership_restricted1];
finalComm1=[final_community1,empty_class];
%apply a logical function to find corresponding values in the list with all categories in the file
′classes′
[lic,loc]=ismember(classes,finalComm1(1,:)); results1(2,lic)=finalComm1(2,loc(lic));
results1(1,:)=classes;
results=results1′;
%% save results (is class attribution)
%%retain maximum probability per assigned cell/’event’
for i=1:536783;
A=output_restricted_anchor1(:,i); C=max_probability(:,i);
A(A<C)=0;
output_restricted_anchor1(:,i)=A;
end
%%%%take means for all classes
for k=1:32
mean_class(k)=mean(nonzeros(output_restricted_anchor1(k,:)));
mean_class=mean_class′;
end
% save values of mean_class
Repeat the analysis, but now for the FCM data of the OCT isolate
% go to PHE_OCT_enrichments/OCT_PHE_isolates/T3/
LWECO1=readtable(′Specimen7_B1_OCT2,O.csv′);
LWECO1=table2array(LWECO1);
LWECO2=readtable(′Specimen7_C1_OCT3,O.csv′);
LWECO2=table2array(LWECO2);
LWECO3=readtable(′Specimen7_D1_OCT4,O.csv′);
LWECO3=table2array(LWECO3);
community_combined=vertcat(LWECO1,LWECO2,LWECO3);
%Then continue as for the above in section 1.1 and 5.4

5.5 Mean Class Attribution and Similarity Scores Using an ANN-33 Classifier

Analysis for the right part of the FIG. 9c. First produce a classifier that includes the OCT-isolate itself

load(‘filtered_standards_32.mat’)
%prepare OCT4 standard
OCT4=readtable(‘Specimen7_D1_OCT4,O.csv’);
OCT3=readtable(‘Specimen7_C1_OCT3,O.csv’);
OCT2=readtable(‘Specimen7_B1_OCT2,O.csv’);
community_combined=vertcat(OCT4,OCT3,OCT2);
%remove 8th column community_combined(:, 8)=[ ];
community_combined=table2array(community_combined);
%filtering and log transformation as in section 1.1
%regroup the columns back into one file
input_community=horzcat(scales1,scales2,scales3,scales4,scales5,scales6,scales7);
%rename to OCT OCT=input_community;
%add OCT to filtered standards, making a 33 standard set.
filtered_standards={B02,B05,B1,B10,B15,B2,B4,B6,AJH1,AJH2,ATJ1,ATJ2,ACH1,ACH2,ACH3,BST1,
BST2,
CCR1,CCR2,CAL,ECL_EXP3,ECL_STAT_LB,ECL_STAT_MM,ECL,LLC,PKM1,PMG,PPT,PVR1
,PVR2,SWT,SYN,OCT};
%then continue as in section 2.1 and 2.2 to traing, validate and test the ANN classifier.
Repeat the analysis from above of the OCT enrichment and the OCT isolate using
the new ANN33 classifier. FIG. 9c right part.
%%continue with the same data sets as above in section 5.4
%%classify using ANN33-standard classifier, produced in section 5.5, first part above.
Example NN file in /NN_file_example
output_restricted_anchor1=
NNfunction_wide_anchor_normz_filtered_OCT_170819(input_community);
max_probability=max(output_restricted_anchor1);
output_restricted_anchor_final1=vec2ind(output_restricted_anchor1);
%%recalculate class attribution
classes=(0:34); empty_class=[34;0];
membership_restricted1 =
histc(output_restricted_anchor_final1,unique(output_restricted_anchor_final1));
classes_restricted1=unique(output_restricted_anchor_final1); final_community1=
[classes_restricted1;membership_restricted1];
finalComm1=[final_community1,empty_class];
%apply a logical function to find corresponding values in the list with all categories in the file
‘classes’
[lic,loc]=ismember(classes,finalComm1(1,:)); results1(2,lic)=finalComm1(2,loc(lic));
results1(1,:)=classes;
results=results1’;
%% save values of results
%%retain maximum probability per assigned cell for i=1:536783;
A=output_restricted_anchor1(:,i);
C=max_probability(:,i); A(A<C)=0;
output_restricted_anchor1(:,i)=A;
end
%%%%take means for all classes for k=1:33
mean_class(k)=mean(nonzeros(output_restricted_anchor1(k,:))); mean_class=mean_class’;
end
%%%%% save values of mean_class
%plot probability histogram of relevant class 33 OCT A=output_restricted_anchor1(33,:);
B=A>0;
A=A(B);
FigH=figure; height=100; width=100; x0=10; y0=10;
p(1)=histogram(A,‘Normalization’,‘probability’); p(1).BinWidth=0.05;
set(gca,‘fontsize’,6) xlim([0,1]);
ylim([0,1]); set(gcf,‘position’,[x0,y0,width,height]); xlabel(‘Probability’, ‘FontSize’,6) ylabel(‘Density’,
‘FontSize’,6)
grid on filename=sprintf(‘GIVE_NAME%.4d.pdf’,33); title(filename);
saveas(FigH, filename,‘pdf’);
% repeat the above for the OCT isolate data itself.

### Example 10. Classification of Gut Microbial Strains with Artificial Network or Random Forest Based Classifiers

To test whether CellCognize can be further developed for any microbiota with higher overall accuracy, FCM signatures of gut microbiota representative cultures stained with different cell markers (DNA staining, i.e. SYBR Green I, cell membrane staining, i.e. FM4-64 and cell wall polysaccharide staining, i.e. WGA-Alexa Fluor 555) were employed. These signatures were combined to develop a new classifier for human gut microbiota experiments (ANN-29).

### Preparation of Strains

Strains were grown aseptically and individually in liquid medium until stationary phase (or also exponential phase for Clostridioides difficile DH-196 strain) at the indicated conditions (Table 6). Culture samples were fixed with 4% PFA for 30 min. Then, cells were washed two times with PBS at 3200 g for 10 min. The cells were resuspended in phosphate-buffered saline (PBS) to OD700 nm 0.1 and stained in 200 μl aliquots with 2 μl of diluted SYBR Green I solution (1:100 in dimethylsulfoxide; Molecular Probes), and final concentration of 1 μg ml-1 of FM4-64 (in dimethylsulfoxide; Molecular Probes) and Wheat germ agglutinin (WGA) Alexa Fluor 555 (in distilled water) in the dark for 15-30 min at 20° C. for FCM analysis.

FCM Analysis

For FCM analysis, a total cell numbers of 200,000 was counted at 10 μl min-1 on a CytoFlex flow cytometer (Beckman Coulter Life Sciences) at a sample acquisition rate of (maximally) 30,000 events s−1. The instrument threshold was set to 450 in the FITC-H channel (497 nm excitation and 520±30 nm acquisition to capture SYBR Green I fluorescence) and to 750 in the SSC-H channel for all samples in all experiments. Eleven FCM parameters were recorded for every particle (FL1-Area, FL1-Height, FL3-Area, FL3-Height, FL4-Area, FL4-Height, FSC-Area, FSC-Height, SSC-Area, SSC-Height and FSC-Width). Data sets were exported as .csv files and imported for preprocessing and artificial neural network analysis in MatLab (vs. 2019a).

Data Preprocessing

FCM data of each sample (16 bacterial strains) were filtered for each of the 11 parameters between a fixed lower boundary (e.g. a value of 100) and an upper boundary (e.g a value of 107), and then 10 log-transformed. The optimal number of subpopulations was determined based on unsupervised clustering based on k-means algorithm using evalcluster function. For some strains, this resulted in two subpopulations (see Table 6). Overall, this process resulted in a total of 29 classes.

Rest of the data pre-processing and ANN construction was similar as explained above in Example 1.

For Random Forest algorithm, the same dataset was used by deploying ranger function in R studio (Version 1.3.959) with 10,000 trees.

Table 6 shows the output of the ANN-29 training testing and validation steps on a combined FCM dataset of 25,000 subsampled cells from all strains, i.e. precision and recall.

TABLE 6
Bacterial strains and their subgroups (defined by unsupervised
clustering based on k-means algorithm) for building ANN and Random
Forest classifiers, and the performance of the classifiers.

| | | | | | | Random Forest | |
|---|---|---|---|---|---|---|---|
| | | | | ANN classifier | | classifier | |
| | Growth | Strain | | Precision | Recall | Precision | Recall |
| Strain | conditions | ID | | (%) | (%) | (%) | (%) |
| Stenotrophomonas | Aerobic, | DSMZ | Subpop | 90 | 90 | 85 | 79 |
| rhizophila | LB, 30° C. | 14405 | 1 | | | | |
| Stenotrophomonas | Aerobic, | DSMZ | Subpop | 94 | 94 | 91 | 90 |
| rhizophila | LB, 30° C. | 14405 | 2 | | | | |
| (SRZ) | | | | | | | |
| Escherichia coli | Aerobic, | DSMZ | Subpop | 83 | 87 | 92 | 93 |
| | LB, 30° C. | 4230 | 1 | | | | |
| Escherichia coli | Aerobic, | DSMZ | Subpop | 94 | 97 | 97 | 96 |
| | LB, 30° C. | 4230 | 2 | | | | |
| Escherichia coli | Aerobic, | MG1655 | Subpop | 97 | 99 | 85 | 86 |
| | LB, 37° C. | | 1 | | | | |
| Escherichia coli | Aerobic, | MG1655 | Subpop | 92 | 94 | 88 | 88 |
| | LB, 37° C. | | 2 | | | | |
| Escherichia coli | Anaerobic, | ATTC | Subpop | 75 | 72 | 93 | 92 |
| | GAM, | 700926 | 1 | | | | |
| | 37° C. | | | | | | |
| Escherichia coli | Anaerobic, | ATTC | Subpop | 93 | 96 | 96 | 98 |
| (ECL) | GAM, | 700926 | 2 | | | | |
| | 37° C. | | | | | | |
| Fusobacterium | Anaerobic, | ATTC | Subpop | 90 | 90 | 98 | 98 |
| nucleatum | GAM, | 25586 | 1 | | | | |
| | 37° C. | | | | | | |
| Fusobacterium | Anaerobic, | ATTC | Subpop | | | | |
| nucleatum | GAM, | 25586 | 2 | 95 | 98 | 98 | 95 |
| (FBN) | 37° C. | | | | | | |
| Enterobacter | Anaerobic, | ATTC | Subpop | 77 | 69 | 90 | 91 |
| cloacae | GAM, | 13047 | 1 | | | | |
| | 37° C. | | | | | | |
| Enterobacter | Anaerobic, | ATTC | Subpop | 86 | 84 | 97 | 99 |
| cloacae | GAM, | 13047 | 2 | | | | |
| (ETC) | 37° C. | | | | | | |
| Bacteriodes fragilis | Anaerobic, | ATTC | Subpop | 75 | 71 | 98 | 99 |
| | GAM, | 25285 | 1 | | | | |
| | 37° C. | | | | | | |
| Bacteriodes fragilis | Anaerobic, | ATTC | Subpop | 84 | 84 | 96 | 96 |
| (BFR) | GAM, | 25285 | 2 | | | | |
| | 37° C. | | | | | | |
| Bacteroides | Anaerobic, | ATTC | Subpop | 80 | 84 | 90 | 96 |
| vulgatus | GAM, | 8432 | 1 | | | | |
| | 37° C. | | | | | | |
| Bacteroides | Anaerobic, | ATTC | Subpop | | | | |
| vulgatus | GAM, | 8432 | 2 | 73 | 73 | 88 | 89 |
| (BVL) | 37° C. | | | | | | |
| Kocuria rhizophila | Anaerobic, | DSMZ | | 96 | 97 | 83 | 82 |
| (KRZ) | GAM, | 348 | | | | | |
| | 37° C. | | | | | | |
| Paenibacillus | Anaerobic, | DSMZ | | 94 | 93 | 96 | 99 |
| polymyxa | GAM, | 36 | | | | | |
| (PBP) | 37° C. | | | | | | |
| Enterococcus | Anaerobic, | ATTC | Subpop | 85 | 90 | 89 | 92 |
| faecalis | GAM, | 700802 | 1 | | | | |
| | 37° C. | | | | | | |
| Enterococcus | Anaerobic, | ATTC | Subpop | 83 | 84 | 83 | 78 |
| faecalis | GAM, | 700802 | 2 | | | | |
| (ECF) | 37° C. | | | | | | |
| Clostridioides | Anaerobic, | ATTC | Subpop | 95 | 98 | 96 | 99 |
| difficile | GAM, | 9689 | 1 | | | | |
| | 37° C. | | | | | | |
| Clostridioides | Anaerobic, | ATTC | Subpop | 92 | 90 | 96 | 95 |
| difficile | GAM, | 9689 | 2 | | | | |
| (CD-ATTC) | 37° C. | | | | | | |
| Clostridioides | Anaerobic, | DH 196 | | 95 | 96 | 97 | 97 |
| difficile | GAM, | | | | | | |
| (CD-exp) | 37° C. | | | | | | |
| Clostridioides | Anaerobic, | DH 196 | Subpop | 96 | 96 | 98 | 97 |
| difficile | GAM, | | 1 | | | | |
| | 37° C. | | | | | | |
| Clostridioides | Anaerobic, | DH 196 | Subpop | 97 | 98 | 97 | 99 |
| difficile | GAM, | | 2 | | | | |
| (CD-stat) | 37° C. | | | | | | |
| Clostridium | Anaerobic, | ATTC | Subpop | 84 | 82 | 89 | 88 |
| scindens | GAM, | 35704 | 1 | | | | |
| | 37° C. | | | | | | |
| Clostridium | Anaerobic, | ATTC | Subpop | 91 | 92 | 94 | 95 |
| scindens | GAM, | 35704 | 2 | | | | |
| (CS-stat) | 37° C. | | | | | | |
| Bifidobacterium | Anaerobic, | Inflora | Subpop | 92 | 90 | 94 | 93 |
| longum | GAM, | drug | 1 | | | | |
| | 37° C. | isolate | | | | | |
| Bifidobacterium | Anaerobic, | Inflora | Subpop | 88 | 86 | 92 | 91 |
| longum | GAM, | drug | 2 | | | | |
| (BFL) | 37° C. | isolate | | | | | |

The new classifier obtained by CellCognize (ANN-29) was used to differentiate among closely related strains (mostly human gut microbiota representatives) and different growth phases of Clostridioides difficile (C. diff) DH-196. The 29-ANN classifier yielded about 90%, i.e. 87%, overall accuracy (Table 6). It also correctly predicted in silico mixed each of the four Clostridia cultures grown individually in an independent experimental set-up (85-95% correct class attribution of in silico mixture shown in FIG. 13, a similar approach as in FIG. 4d for E. coli strains). Among these four standards, it was possible to clearly differentiate cells according to growth phase (strain DH-96 at exponential phase vs. stationary phase), and to distinguish between closely related strains or niche competitors such as Clostridium scindens and Clostridioides difficile (FIG. 13). This demonstrates that the CellCognize pipeline allows to determine cell physiological status and differentiate among closely related strains on the basis of FCM signatures even at higher accuracy when more than one cell marker is used (compared to FIG. 4d).

### Example 11. Classification of Clostridioides Difficile in a Microbiome Background from a Stool Sample

The classifier obtained by CellCognize (ANN-29) in Example 10 was employed to test the performance of CellCognize for the recognition of pathogens within a complex gut microbiome. The inventors assessed the ability of this classifier to correctly predict the classification of a target pathogen, which was added in silico into microbial background data obtained from a stool sample. For this purpose, the inventors chose C. difficile—DH-96 at its exponential and stationary phases. The pure cultures of C. difficile—DH-96 at its exponential and stationary phases, and the stool sample were individually stained and measured with flow cytometry as described in Example 10. The inventors first assessed the stool sample (n=500,000 cells) by deploying ANN-29 classifier and it was observed that the cells were predominantly assigned to C. scindens and B. longum classes (FIG. 14a). Next, FCM data of the stool sample (n=500,000 cells) were in silico mixed with randomly subsampled CD-exp (n=50,000 cells) and CD-stat (n=50,000 cells), and subsequently analyzed using the ANN-29 classifier. The classification of these two C. difficile subpopulations was correctly predicted as 95% within the diverse microbial background of the stool sample.

1. A computer-implemented method for generating a classifier for at least one target microbe, wherein said target microbe is a microbial species or strain or a subpopulation thereof, and wherein said method comprises the steps of
(a) obtaining a training data set, wherein said training data set comprises data of a plurality of objects, wherein said plurality of objects comprises cells of said at least one target microbe, and wherein said data comprises for each of said objects
(i) a label which identifies the type of the object, and
(ii) an input vector which comprises a plurality of cytometric parameters of said object,
(b) analyzing said training data set with a supervised machine learning algorithm, and
(c) obtaining said classifier as output from said supervised machine learning algorithm.

2. A computer-implemented method for quantifying the abundance of at least one target microbe in a sample, wherein said target microbe is a microbial species or strain or a subpopulation thereof, and wherein said method comprises the steps of
(a) generating a classifier for at least one target microbe by performing the method of claim 1,
(b) obtaining data of a plurality of objects from said sample, wherein said data comprises for each of said objects a vector comprising a plurality of cytometric parameters, and
(c) determining the number of objects in the sample that correspond to a certain target microbe by applying said classifier to the sample data.

3. The method of claim 1, wherein the cytometric parameters of an object have been determined by flow cytometry.

4. The method of claim 1, wherein the supervised machine learning algorithm comprises an artificial neural network and/or a random forest.

5. The method of claim 1, wherein the target microbe is a prokaryote and/or a bacterium.

6. (canceled)

7. The method of claim 2, wherein the abundance of at least one of at least two related target microbes in a sample is determined, wherein the at least two related target microbes are
(I) at least two microbial species or strains of the same family,
(II) at least two microbial strains of the same species, and/or
(III) at least two subpopulations of the same microbial species or strain, wherein
(i) the subpopulations are populations of a microbial species or strain that are obtained from different sources, locations and/or cultures,
(ii) the subpopulations are detected and/or isolated by analyzing, gating, clustering, and/or purifying cell populations of a microbial species or strain, and/or
(iii) one of the two subpopulations is in the exponential phase, and the other one in the stationary phase.

8. (canceled)

9. The method of claim 1, wherein the data of at least one cytometric parameter are pre-processed, and wherein said pre-processing comprises the steps of
(a) determining a lower and an upper boundary of said cytometric parameter,
(b) adding the lower and upper boundaries of said cytometric parameter as two data points to the data of said cytometric parameter, and
(c) assigning to the lower boundary a minimum value and assigning to the upper boundary a maximum value, thereby scaling the data.

10. (canceled)

11. The method of claim 4, wherein the artificial neural network is a feedforward neural network comprising one or two hidden layers and/or analyzing the training data set with the artificial neural network comprises backpropagation.

12-14. (canceled)

15. The method of claim 1, wherein the target microbes comprise
(I) at least one, 2 or 10 microbes selected from the group consisting of: Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof;
(II) at least one or two microbes selected from the group consisting of: Stenotrophomonas rhizophila, Kocuria rhizophila, and Paenibacillus polymyxa, and any subpopulation thereof; and/or
(III) at least one, 2 or 10 microbes selected from the group consisting of the following (i) and/or (ii):
(i) Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof, preferably at least Clostridioides difficile, Clostridium scindens, Escherichia coli, Klebsiella sp., and/or Salmonella sp., and any subpopulation thereof;
(ii) Bacteroides fragilis, Bacteroides vulgatus, Bifidobacterium adolescentis, Clostridioides difficile, Enterococcus faecalis, Lactobacillus plantarum, Enterobacter cloacae, Escherichia coli, Helicobacter pylori, Salmonella enterica subsp. Entérica, Yersinia enterocolitica, Fusobacterium nucleatum, Bifidobacterium longum, and any subpopulation thereof.

16-21. (canceled)

22. The method of claim 2, wherein the sample is from a body of water, food, a biotope, an agricultural field, a water system, a place under hygienic control, a multicellular organism, an animal, or a human.

23. (canceled)

24. The method of claim 22, wherein the sample from the animal or human is a stool sample, a vaginal smear or discharge, a blood sample, a lung sputum or a skin swab.

25. A method for diagnosing a microbial disease in a subject, wherein said method comprises the steps of
(a) quantifying the abundance of at least one target microbe in a sample from said subject according to the method of claim 2, wherein said at least one target microbe is associated with and/or causes said disease,
(b) comparing the abundance of said at least one target microbe in said sample to the expected abundance of said at least one target microbe in a respective sample of a subject who does not suffer from said microbial disease, and
(c) indicating that said subject has said microbial disease if the abundance of said at least one target microbe in said sample is greater than expected.

26. The method of claim 25, wherein (i) the microbial disease is Clostridioides difficile infection and the at least one target microbe which is associated with and/or causes said disease, is Clostridioides difficile;
or (ii) the microbial disease is vaginal dysbiosis and the at least one target microbe which is associated with and/or causes said disease is Gardnerella spp. and the samples are vaginal smears.

27. A computer-implemented method for analyzing the microbial composition in a sample, wherein said method comprises
(a) generating a classifier for at least one target microbe by performing the method of claim 1,
(b) obtaining data of a plurality of objects from said sample, wherein said data comprises for each of said objects a vector comprising a plurality of cytometric parameters, and
(c) assigning the objects in the sample to the labels by applying said classifier to the sample data, thereby determining the microbial composition and/or diversity of the microbial composition in said sample.

28-30. (canceled)

31. The method of claim 27, wherein the microbial composition is analyzed in a series of samples, wherein said samples have been obtained at different time-points from a similar location, thereby quantifying the change of the microbial composition over time in said location.

32. (canceled)

33. The method of claim 31, wherein said method further comprises a step of determining the carbon biomass of the microbial composition, wherein quantifying the carbon biomass comprises the steps of
(a) determining the average carbon masses of the labels comprised in the classifier, and
(b) multiplying the number of objects which have been assigned to a certain label with the average carbon mass of said certain label.

34. A kit comprising a set of pure microbial cultures or stocks thereof, wherein said set comprises at least 2, 10, 15 or 50 target microbes selected from a group consisting of at least one of the following (i) to (iv):
(i) Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof;
(ii) Stenotrophomonas rhizophila, Kocuria rhizophila, and Paenibacillus polymyxa, and any subpopulation thereof;
(iii) Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof, preferably at least Clostridioides difficile, Clostridium scindens, Escherichia coli, Klebsiella sp., and/or Salmonella sp., and any subpopulation thereof;
(iv) Bacteroides fragilis, Bacteroides vulgatus, Bifidobacterium adolescentis, Clostridioides difficile, Enterococcus faecalis, Lactobacillus plantarum, Enterobacter cloacae, Escherichia coli, Helicobacter pylori, Salmonella enterica subsp. Entérica, Yersinia enterocolitica, Fusobacterium nucleatum, Bifidobacterium longum, and any subpopulation thereof.

35. (canceled)

36. A computer-readable storage medium containing data of a plurality of cells of a plurality of target microbes for generating a classifier for at least one target microbe, wherein said data comprise for each cell of said target microbes
(a) a label which identifies the type of the cell, and
(b) an input vector which comprises a plurality of cytometric parameters of said cell,
wherein said parameters have been determined by flow cytometry;
and wherein said target microbes comprise at least 2, 10, 15 or 50 target microbes selected from a group consisting of at least one of the following (i) to (iv):
(i) Acinetobacter johnsonii, Acinetobacter tjernbergiae, Arthrobacter chlorophenolicus, Bacillus subtilis, Caulobacter crescentus, Cryptococcus albidus, Escherichia coli, Escherichia coli MG1655, Escherichia coli DH5a, Lactococcus lactis, Pseudomonas knackmussii, Pseudomonas migulae, Pseudomonas putida, Pseudomonas veronii, Sphingomonas wittichii, Sphingomonas yanoikuyae, and any subpopulation thereof;
(ii) Stenotrophomonas rhizophila, Kocuria rhizophila, and Paenibacillus polymyxa, and any subpopulation thereof;
(iii) Bacteroides cellulosilyticus, Bacteroides caccae, Parabacteroides distasonis, Ruminococcus torques, Clostridium scindens, Collinsella aerofaciens, Bacteroides thetaiotaomicron, Bacteroides vulgatus, Bacteroides ovatus, Bacteroides uniformis, Eumicrobe rectale, Clostridium spiroforme, Faecalimicrobe prausnitzii, Ruminococcus obeum, Dorea longicatena, Clostridioides difficile, Escherichia coli, Klebsiella sp., Salmonella sp., and any subpopulation thereof;
(iv) Bacteroides fragilis, Bacteroides vulgatus, Bifidobacterium adolescentis, Clostridioides difficile, Enterococcus faecalis, Lactobacillus plantarum, Enterobacter cloacae, Escherichia coli, Helicobacter pylori, Salmonella enterica subsp. Entérica, Yersinia enterocolitica, Fusobacterium nucleatum, Bifidobacterium longum, and any subpopulation thereof.

37. A data processing device comprising means for carrying out the computer-implemented method of claim 1.

38. A computer program comprising instructions which, when the program is executed by a computer, cause the computer to carry out the computer-implemented method of claim 1.

39. A computer-readable storage medium comprising instructions which, when executed by a computer, cause the computer to carry out the computer-implemented method of claim 1.

40. A method comprising the computer-implemented method of claim 1, wherein said method further comprises a step of determining with flow cytometry the values of the plurality of cytometric parameters, wherein the objects are stained with at least one dye before flow cytometry analysis.

41. The method of claim 40, wherein said at least one dye comprises a fluorescent dye that is a fluorescent stain for DNA, membrane, cell wall polysaccharide, dead cells, or metabolism.

42. The method of claim 15, wherein the target microbes comprise at least Clostridioides difficile and/or Clostridium scindens.
